(19) United States
(12) Patent Application Publication
(10) Pub. No.: US 2003/0232635 A1
(43) Pub. Date: Dec. 18, 2003

(54) Crossword puzzle playing apparatus and crossword puzzle playing program storage medium

(75) Inventor: Sensuke Yanagishita, Inagi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/338,666

(22) Filed: Jan. 9, 2003

(30) Foreign Application Priority Data
Jun. 12, 2002 (JP) 2002-170928

(51) Int. Cl. G06F 17/00

(52) U.S. Cl. 463/9

(57) ABSTRACT

The present invention improves operability of a crossword puzzle playing apparatus implemented by a device such as a personal computer in which answers are entered in cells arranged vertically and horizontally in accordance with an operation performed by a player. An answer entry matrix and clue list areas are displayed on a display screen. When the player places a mouse cursor on any one of the clues in clue list area, an answer entry range that corresponds to that clue is highlighted. When the player places the cursor on an answer entry cell, the clue corresponding to that cell is highlighted.

### BACKGROUND OF THE INVENTION

1. Field of the Invention

The present invention relates to a crossword puzzle playing apparatus in which answers are entered in accordance with operations performed by a player. The present invention also relates to a crossword puzzle playing program storage medium storing a crossword puzzle playing program executed on the computer to cause the computer to function as such a crossword puzzle playing apparatus.

2. Description of the Related Art

When playing a crossword puzzle by using a personal computer (hereinafter sometimes abbreviated to PC), a player prints out the puzzle using a printer and then plays the puzzle or inputs answers in answer cells on a display screen through a keyboard with reference to a list of clues to vertical and horizontal answers, which is also displayed on the display screen.

If the PC is connected to an Internet and a link to a Web page on the Internet is provided on a vertical or horizontal clue, a player can access and refer to the Web page to find the answer to the clue (puzzle), which he or she would not be able to find by him/herself. However, players are apt to forget the information thus obtained over time. Some players store links to (the Internet address of) Web pages in case they forget information obtained from the Web pages.

In any case, the players have to search the answer entry matrix for cells in which an answer to a down or across clue is to be placed. Conversely, the players have to search the list of clues for a down or across clue corresponding to particular cells in the answer entry matrix.

A user who uses an on-line PC to obtain information in a Web page on the Internet that is associated with a clue has to store the link to (Internet address of) the Web page manually if he or she wants to save time and effort to search for the clue to refer to that page later.

Japanese Patent Laid-Open No. 2000-3241 has proposed a method in which a plurality of display panels are related with one another in a multilevel hierarchy of directories and a display panel selected from among them in response to an instruction from a player is displayed in a color corresponding to a level to which that panel belongs. This method allows the player to know the level of the displayed panel. However, crossword puzzles typically have nothing to do with any hierarchical structure and it counts for nothing to apply the technology to crossword puzzles in order to improve their operability.

Japanese Patent Laid-Open No. 11-175628 has proposed a system that provides information corresponding to a clue in a dialog displayed on a cyberspace. However, the system also cannot be applied to crossword puzzles.

Japanese Patent Laid-Open No. 8-266712 has proposed a method in which a display panel consisting of diagrams and text is displayed. When a diagram is specified, identification data contained in the diagram is read out and the text is searched for the same identification data and the found data is highlighted. This method allows a user to find matching identification data in a diagram and text but cannot be used to improve the operability of crossword puzzles.

Japanese Patent Laid-Open No. 8-272772 has proposed a method in which information on links to answer alternatives is provided in a questionnaire. When the questionnaire is edited by copying or moving questions in it, the answer alternatives are dynamically edited in conjunction with the editing. This method again has nothing to do the operability of crossword puzzles.

### SUMMARY OF THE INVENTION

An object of the present invention is to provide a crossword puzzle playing apparatus and a crossword puzzle playing program storage medium on which a crossword puzzle playing program is stored, for providing improved operability in playing crossword puzzles.

A first crossword puzzle playing apparatus according to the present invention that attains the above object is a crossword puzzle playing apparatus in which answers are to be entered in accordance with an operation performed by a player, comprising: a display section displaying on a display screen an answer entry matrix in which the answerers are to be entered and a clue list area in which clues to the answers to be entered in the answer entry matrix are displayed; a point specifying section specifying a point on the display screen according to an operation performed by the player; and an answer entering section entering the answers in the answer entry matrix in accordance with an operation performed by the player; wherein the display section, in response to specification of a clue from among the clues in the clue list area by the point specifying section, highlights an answer entry range corresponding to the clue specified by the point specifying section.

The highlighting may be performed by any of various types of means such as those for drawing a box of a distinctive color (for example, red) around an answer entry range, changing the color of the answer entry range, changing periodically the color or shape of an answer entry range, or blinking the answer entry range. This applies to “highlighting” as used in any of the embodiments of the present invention, which will be described later.

The specifying a clue is not limited to the point specifying section described above. For example, a clue may be specified by placing the mouse cursor on the area in which the clue is displayed, or it may be specified by placing the mouse cursor and clicking on it, or by selecting it using the mouse or keyboard and depressing the enter key of the keyboard. This applies to cases where any of clues or other items on the display screen is specified in any of the embodiments of the present invention.

According to a first crossword puzzle playing apparatus of the present invention, an answer entry range corresponding to a clue specified by the player is highlighted, thereby allowing the player to readily know where to enter an answer to that clue.

The display section of the first crossword puzzle playing apparatus preferably displays said answer entry matrix on said display screen in a scrollable manner and, if an answer entry range corresponding to a clue specified by said point specifying section from among the clues in said clue list area is not displayed on said display screen, scrolls said answer entry matrix to display and highlight said answer entry range on said display screen in response to specification of said clue.

If an answer entry range to which the player wants to enter an answer is not displayed on the display screen, the answer entry range is brought into the display screen and highlighted by indicating his or her intention to select a clue corresponding that answer entry range. Thus, the player can readily know the answer entry range corresponding to the clue.

A second crossword puzzle playing apparatus according to the present invention that attains the above-described object is a crossword puzzle playing apparatus in which answers are to be entered in accordance with an operation by a player, comprising: a display section displaying on a display screen an answer entry matrix in which the answers are to be entered and a clue list area in which clues to the answers to be entered in the answer matrix are displayed, the clue list area being scrollable; and an answer entering section entering the answers in the answer entry matrix in accordance with an operation performed by a player; wherein the display section highlights in the answer entry matrix an answer entry range corresponding to a clue displayed at a predetermined position in the clue list area.

Because the clue list area in the second crossword puzzle playing apparatus of the present invention is displayed in a scrollable manner and the answer entry range that corresponds to a clue brought to a predetermined position (the top of the list, for example) through scrolling is highlighted, the player can readily know the answer entry range corresponding to that particular clue.

In the second crossword puzzle playing apparatus, the display section displays on the display screen the clue list area and the answer entry matrix in a scrollable manner and, if an answer entry range corresponding to a clue which is brought to the predetermined position (the top of the list, for example) in the clue list area in response to scrolling of the clue list area is not displayed on the display screen, scrolls the answer entry matrix to display and highlight the answer entry range.

Even if an intended answer entry range is not displayed on the display screen, the answer entry range corresponding to the clue displayed in a predetermined position (the top of the list, for example) by scrolling is displayed and highlighted on the display screen. Thus, the player can readily know the answer entry range corresponding to the clue brought to that position through the scrolling.

A third crossword puzzle playing apparatus of the present invention that attains the above-described object is a crossword puzzle playing apparatus in which answers are to be entered in accordance with an operation performed by a player, comprising: a display section displaying on a display screen an answer entry matrix in which the answers are to be entered and a clue list area in which clues to the answers to be entered in the answer entry matrix are displayed, the answer entry matrix being scrollable; a clue specifying section specifying a clue from among the clues in the clue list area in accordance with an operation performed by the player; and an answer entering section entering an answer in the answer entry matrix in accordance with an operation performed by the player; wherein the display section, in response to specification of a clue in the clue list area by the clue specifying section, scrolls the answer entry matrix to display an answer entry range corresponding to the clue specified by the clue specifying section if the answer entry range is not displayed in the answer entry matrix on the display screen.

The clue specifying section is not limited to specific specifying means. For example, a pointing device such as a mouse that can specify a point on the display screen may be used to specify a desired clue. Alternatively, the clues in the clue list area may be scrollable and a desired clue may be specified by scrolling the list to bring the clue to a predetermined position (the top of the list, for example).

In the third crossword puzzle playing apparatus of the present invention, if an answer entry range is not displayed on the display screen, the answer entry range can be brought into the display screen by specifying the clue corresponding to the answer entry range to scroll the display screen. Thus, the answer entry range corresponding to the clue can be displayed without manually scrolling the screen to find the answer entry range.

A fourth crossword puzzle playing apparatus of the present invention that attains the above-described object is a crossword puzzle playing apparatus in which answers are to be entered in accordance with an operation performed by a player, comprising: a display section displaying on a display screen an answer entry matrix in which the answers are to be entered and a clue list area in which clues to the answers to be entered in the answer entry matrix are displayed; a point specifying section specifying a point on the display screen in accordance to an operation performed by the player; and an answer entering section entering an answer in the answer entry matrix in accordance with an operation performed by the player; wherein the display section, in response to specification of an answer entry range in the answer entry matrix by the point specifying section, highlights a clue among the clues displayed in the clue list area that corresponds to the answer entry range specified by the point specifying section.

In the fourth crossword puzzle playing apparatus of the present invention, when the player indicates his or her intention to select an answer entry range, the clue that corresponds to the selected answer entry range is highlighted. Thus, the player can readily know the clue to the answer to be entered in the answer entry range.

In the fourth crossword puzzle playing apparatus, the display section preferably displays the clue list area on the display screen in a scrollable manner and, if a clue corresponding to an answer entry range specified by the point specifying section from among the answer entry ranges in the answer entry matrix is not displayed in the clue list area on the display screen, scrolls the clue list area to display and highlight the clue on the display screen in response to specification of the answer entry range.

Even if a clue to an answer to be entered in an answer range has not been displayed on the display screen, the player can readily know the clue to the answer entry range by indicating his or her intention to select the answer entry range to display and highlight the clue.

A fifth crossword puzzle playing apparatus of the present invention that attains the above-described object is a crossword puzzle playing apparatus in which answers are to be entered in accordance with an operation performed by a player, comprising: a display section displaying on a display screen an answer entry matrix in which the answers are to be entered, a clue list area in which clues to the answers to be entered in the answer entry matrix are displayed, and a keyword display field in which a keyword is displayed, the keyword being formed by arranging in a certain order the same characters that are entered in a number of certain entry cells of the cells making up the answer entry matrix; and an answer entering section entering an answer in the answer entry matrix in accordance with an operation performed by the player; wherein the display section, in response to entry of a character in any of the certain entry cells in the answer entry matrix, displays the same character as the character at a place in the keyword display field, the place corresponding to the entry cell in which the character is entered.

In the fifth crossword puzzle playing apparatus described above, a keyword to be derived from answers entered in the answer entry matrix is displayed on the keyword display field simply by entering the answers in the matrix, saving the player from having to search for the keyword characters in the answer entry matrix.

In the fifth crossword puzzle playing apparatus, the display section may display the answer entry matrix and the clue list area prior to displaying the keyword display field and display the keyword display field the first time a character is entered in any of the certain entry cells in the answer entry matrix.

The keyword display field is hidden when unnecessary and displayed when necessary, thereby attracting attention to the keyword display field and interest in the crossword puzzle.

A sixth crossword puzzle playing apparatus of the present invention is a crossword puzzle playing apparatus in which answers are to be entered in accordance with an operation performed by a player, comprising: a display section displaying on a display screen an answer entry matrix in which the answers are to be entered and a clue list area in which clues to the answers to be entered in the answer entry matrix are displayed; and an answer entering section entering an answer in the answer entry matrix in accordance with an operation performed by the player; wherein the display section, in response to entry of an answer in an answer entry range in the answer entry matrix, displays an indication that a clue in the clue list area that corresponds to the answer entry range in which the answer is entered is answered.

In the sixth crossword puzzle playing apparatus, when an answer to a clue is entered, an indication is displayed that the clue has been answered. Thus, the player can readily find the clue corresponding to the next answer entry range into which the player wants to enter an answer.

The indication of an answered clue is not limited to a specific form. For example, it may be a deletion line displayed over the clue or a checkmark appearing in a checkbox associated with the clue. It may be an “Answered” mark appearing in a field associated with the clue. It may be any changed display mode that shows the clue has been answered.

A seventh crossword puzzle playing apparatus of the present invention is a crossword puzzle playing apparatus in which answers are to be entered in accordance with an operation performed by a player, comprising: a display section displaying on a display screen an answer entry matrix in which the answers are entered, a clue list area in which clues to the answers to be entered in the answer entry matrix are displayed, and a predetermined uncompleted answer entry range indication button; a button specifying section specifying the uncompleted answer entry range indication button in accordance with an operation performed by the player; and an answer entering section entering an answer in the answer entry matrix in accordance with an operation performed by the player; wherein the display section, in response to specification of the uncompleted answer entry range indication button by the button specifying section, highlights an unanswered entry range in the answer entry matrix.

In the seventh crossword puzzle playing apparatus of the present invention, uncompleted answer entry ranges are highlighted when the uncompleted answer entry range indication button is depressed, so that the player can readily know how many answer entry ranges are uncompleted.

An eighth crossword puzzle playing apparatus of the present invention is a crossword puzzle playing apparatus in which answers are to be entered in accordance with an operation performed by a player, comprising: a display section displaying on a display screen an answer entry matrix in which the answers are to be entered and a clue list area in which clues to the answers to be entered in the answer entry matrix are displayed, the order in which the clues are listed in the clue list area being changeable; and an answer entering section entering an answer in the answer entry matrix in accordance with an operation performed by the player; wherein the display section, in response to entry of an answer in an answer entry range in the answer entry matrix, changes a display mode of the clue list area to a mode in which a clue corresponding to the answer entry range in which the answer is entered is moved to a predetermined position.

In the eighth crossword puzzle playing apparatus, answered clues are moved to a predetermined position (for example the bottom of the clue list (clue array), not displayed in the clue list area) to reorganize the list so that clues are divided into answered and unanswered clues. Thus, the player can readily know the unanswered clues.

A ninth crossword puzzle playing apparatus in which answers are entered in accordance with an operation performed by a player, comprising: a display section displaying on a display screen an answer entry matrix in which the answers are to be entered and a clue list area in which clues to the answers to be entered in the answer entry matrix are displayed, the clue list area being scrollable; and an answer entering section entering an answer in the answer entry matrix in accordance with an operation performed by the player; wherein the display section, in response to entry of an answer in an answer entry range in the answer entry matrix, scrolls the clue list area to display at a predetermined position a clue corresponding to an unentered answer if a clue corresponding to the answer entry range in which the answer is entered is displayed at the predetermined position in the clue list area.

In the ninth crossword puzzle playing apparatus of the present invention, the clue list area is scrolled to bring unanswered clues to a predetermined position (for example the top of the list). Thus, the player can readily know the unanswered clues.

A tenth crossword puzzle playing apparatus of the present invention is a crossword puzzle playing apparatus connected to a network in which answers are entered in accordance with an operation performed by a player, comprising: a display section displaying on a display screen an answer entry matrix in which the answers are to be entered and a clue list area in which clues to the answers to be entered in the answer entry matrix are displayed, the clues including a clue being linked to Web pages; a point specifying section specifying a point on the display screen in accordance with an operation performed by the player; an answer entering section entering an answer in the answer entry matrix in accordance with an operation performed by the player; and a Web accessing section responsive to specification by the point specifying section of a clue in the clue list area that is linked to a Web page for accessing the Web page to which the clue is linked; wherein the display section displays on the display screen the Web page accessed by the Web accessing section in addition to the answer entry matrix and the clue list area; and the crossword puzzle playing apparatus further comprises a reference link information recording section associating and recording information about the link to the Web page accessed by the Web accessing section with the clue linked to the Web page and/or an answer corresponding to the clue.

In the tenth crossword puzzle playing apparatus, information obtained by referring to Web pages to which clues are linked is stored. Thus, the player can review the information later.

The reference link information recording section in the tenth crossword puzzle playing apparatus may associate and record said information about the link with said clue and/or said answer in a certain Web page.

The information may be stored in the crossword puzzle playing apparatus or may be recorded in a certain Web page.

A crossword puzzle playing program storage medium that attains the above-described object of the present invention stores a crossword puzzle playing program that is executed on a computer and causes the computer to operate as a crossword puzzle playing apparatus in which answers are entered in accordance with an operation performed by a player. The crossword puzzle playing program stored on the crossword puzzle playing program storage medium includes a first through tenth crossword puzzle playing programs that cause the computer to operate as the first through tenth crossword puzzle playing apparatus, respectively.

For example, a first crossword puzzle playing program storage medium of the present invention is a crossword puzzle playing program storage medium storing a crossword puzzle playing program executed in a computer to cause the computer to operate as a crossword puzzle playing apparatus in which answers are to be entered in accordance with an operation performed by the player, the program causing the computer to operate as the crossword puzzle playing apparatus comprising: a display section displaying on a display screen an answer entry matrix in which the answerers are to be entered and a clue list area in which clues to the answers to be entered in the answer entry matrix are displayed; and an answer entering section entering the answers in the answer entry matrix in accordance with an operation performed by the player; wherein the display section, in response to specification of a clue from among the clues in the clue list area, highlights an answer entry range corresponding to the specified clue.

Similar description is applied to the second through tenth crossword puzzle playing program storage media therefore description of them will be omitted here.

### BRIEF DESCRIPTION OF THE DRAWINGS

FIG. 1 schematically shows a configuration of a server-client system including one embodiment of a crossword puzzle playing apparatus according to the present invention;

FIG. 2 shows a hardware configuration of a personal computer shown in FIG. 1;

FIG. 3 shows a schematic configuration diagram of an embodiment of a first crossword puzzle playing program storage medium;

FIG. 4 shows a block diagram of an embodiment of a first crossword puzzle playing apparatus;

FIG. 5 shows a schematic configuration diagram of an embodiment of a second crossword puzzle playing program storage medium;

FIG. 6 shows a block diagram of an embodiment of a second crossword puzzle playing apparatus;

FIG. 7 shows a schematic configuration diagram of an embodiment of a third crossword puzzle playing program storage medium;

FIG. 8 shows a block diagram of an embodiment of a third crossword puzzle playing apparatus;

FIG. 9 shows a schematic configuration diagram of an embodiment of a fourth crossword puzzle playing program storage medium;

FIG. 10 shows a block diagram of an embodiment of a fourth crossword puzzle playing apparatus;

FIG. 11 shows a schematic configuration diagram of an embodiment of a fifth crossword puzzle playing program storage medium;

FIG. 12 shows a block diagram of an embodiment of a fifth crossword puzzle playing apparatus;

FIG. 13 shows a schematic configuration diagram of an embodiment of a sixth crossword puzzle playing program storage medium;

FIG. 14 shows a block diagram of an embodiment of a sixth crossword puzzle playing apparatus;

FIG. 15 shows a schematic configuration diagram of an embodiment of a seventh crossword puzzle playing program storage medium;

FIG. 16 shows a block diagram of an embodiment of a seventh crossword puzzle playing apparatus;

FIG. 17 shows a schematic configuration diagram of an embodiment of an eighth crossword puzzle playing program storage medium;

FIG. 18 shows a block diagram of an embodiment of an eighth crossword puzzle playing apparatus;

FIG. 19 shows a schematic configuration diagram of an embodiment of a ninth crossword puzzle playing program storage medium;

FIG. 20 shows a block diagram of an embodiment of a ninth crossword puzzle playing apparatus;

FIG. 21 shows a schematic configuration diagram of an embodiment of a tenth crossword puzzle playing program storage medium;

FIG. 22 shows a block diagram of an embodiment of a tenth crossword program playing apparatus;

FIG. 23 shows a display mode on a display screen of an embodiment of the first crossword puzzle playing apparatus;

FIG. 24 shows a display mode on the display screen of the embodiment of the first crossword puzzle playing apparatus;

FIG. 25 shows a module configuration diagram of a crossword puzzle playing apparatus;

FIG. 26 shows a flowchart of a process performed by a mouse cursor coordinates managing section;

FIG. 27 shows a flowchart of a process performed by a down clue managing section;

FIG. 28 shows a flowchart of a process performed by an across clue managing section;

FIG. 29 shows a flowchart of a process performed by an answer cell managing section;

FIG. 30 shows a display mode of the display screen;

FIG. 31 shows a display mode of the display screen;

FIG. 32 shows a partial flowchart replacing step d6 in FIG. 29;

FIG. 33 shows a display mode of the display screen of an embodiment of the second crossword puzzle playing apparatus;

FIG. 34 shows a display mode of the display screen of the embodiment of the second crossword puzzle playing apparatus;

FIG. 35 shows a module configuration diagram of a crossword puzzle playing apparatus;

FIG. 36 shows a flowchart of a process performed by a down clue managing section;

FIG. 37 shows a flowchart of a process performed by an across clue managing section;

FIG. 38 shows a display mode of the display screen;

FIG. 39 shows a display mode of the display screen;

FIG. 40 shows a display mode of the display screen of an embodiment of the third crossword puzzle playing apparatus;

FIG. 41 shows a display mode of the display screen of the embodiment of the third crossword puzzle playing apparatus;

FIG. 42 shows a partial flowchart replacing the section in box (A) in FIG. 29;

FIG. 43 shows a display mode of the display screen;

FIG. 44 shows a display mode of the display screen;

FIG. 45 shows a display mode of the display screen of an embodiment of the fourth crossword puzzle playing apparatus;

FIG. 46 shows a display mode of the display screen of the embodiment of the fourth crossword puzzle playing apparatus;

FIG. 47 shows a module configuration diagram of a crossword puzzle playing apparatus;

FIG. 48 shows a flowchart of a process performed by a mouse cursor coordinates managing section;

FIG. 49 shows a flowchart of a process performed by an answer cell managing section;

FIG. 50 shows a flowchart of a process performed by a down clue managing section;

FIG. 51 shows a flowchart of a process performed by an across clue managing section;

FIG. 52 shows a display mode of the display screen;

FIG. 53 shows a display mode of the display screen;

FIG. 54 shows a partial flowchart replacing the section in box (C) in the flowchart in FIG. 50;

FIG. 55 shows a display mode in an embodiment of the fifth crossword puzzle playing apparatus;

FIG. 56 shows a display implementation in the embodiment of the fifth crossword puzzle playing apparatus;

FIG. 57 shows a module configuration diagram of a crossword puzzle playing apparatus;

FIG. 58 shows a flowchart of a process performed by an answer cell managing section;

FIG. 59 shows a display mode in an embodiment of the sixth crossword puzzle playing apparatus;

FIG. 60 shows a display mode after an operation by a player in the embodiment of the sixth crossword puzzle playing apparatus;

FIG. 61 shows a module configuration diagram of a crossword puzzle playing apparatus;

FIG. 62 shows an answer cell status management array;

FIG. 63 shows a clue number and answer cell management table;

FIG. 64 shows a flowchart of a process performed by an answer cell managing section on receiving a notice of the entry of a character in any of the cells in an answer entry range;

FIG. 65 shows a flowchart of a process performed by the answer cell managing section on receiving a down clue number from a down clue managing section;

FIG. 66 shows a flowchart of a process performed by the answer cell managing section on receiving an across clue number from a across clue managing section;

FIG. 67 shows a flowchart of a process performed by the down clue managing section;

FIG. 68 shows a flowchart of a process performed by the across clue managing section;

FIG. 69 shows a display mode in an embodiment of the seventh crossword puzzle playing apparatus;

FIG. 70 shows a display mode in the embodiment of the seventh crossword puzzle playing apparatus;

FIG. 71 shows a module configuration of a crossword puzzle playing apparatus;

FIG. 72 shows a flowchart of a process performed by an answer cell managing section;

FIG. 73 shows a display mode in an embodiment of the eighth crossword puzzle playing apparatus;

FIG. 74 shows a display mode in the embodiment of the eighth crossword puzzle playing apparatus;

FIG. 75 shows a display mode in the embodiment of the eighth crossword puzzle playing apparatus;

FIG. 76 shows a flowchart of a process performed by a down clue managing section;

FIG. 77 shows a flowchart of a process performed by an across clue managing section;

FIG. 78 shows a display mode in an embodiment of the ninth crossword puzzle playing apparatus;

FIG. 79 shows a display mode in the embodiment of the ninth crossword puzzle playing apparatus;

FIG. 80 shows a flowchart of a process performed by a down clue managing section;

FIG. 81 shows a flowchart of a process performed by an across clue managing section;

FIG. 82 shows a display mode in an embodiment of the tenth crossword puzzle playing apparatus;

FIG. 83 shows a display mode in the embodiment of the tenth crossword puzzle playing apparatus;

FIG. 84 shows an accessed page storing HTML file;

FIG. 85 shows a Web page accessed based on link information stored in the accessed page storing HTML file;

FIG. 86 shows a module configuration;

FIG. 87 shows a flowchart of a process performed by a link information managing section; and

FIG. 88 shows a flowchart of a process performed by an accessed page managing section.

### DETAILED DESCRIPTION OF THE PREFERRED EMBODIMENTS

Embodiments of the present invention will be described below.

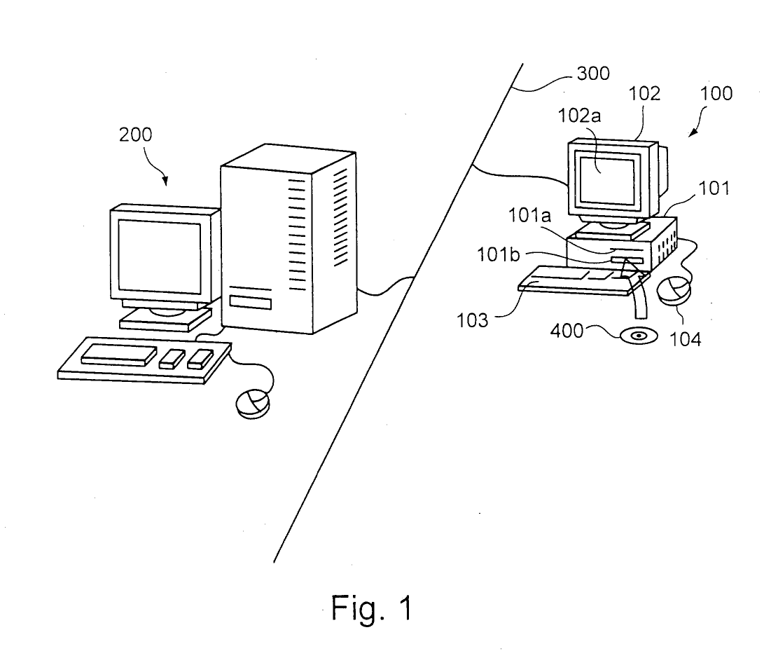

FIG. 1 shows a schematic configuration of a server-client system including one embodiment of a crossword puzzle playing apparatus according to the present invention. The crossword puzzle playing apparatus, which is one embodiment of the present invention, comprises hardware, an operating system (OS) of a personal computer (PC) 100, and an application program installed and executed in the PC 100, which is an embodiment of a crossword puzzle playing program according to the present invention.

The PC 100 is connected to a server computer 200 over a communication line 300 and acts as a client computer of the server computer 200.

While only the single PC 100 is illustrated as a representative of client computers, many other client computers may be connected onto the communication line 300. While the single server computer 200 is illustrated, a number of server computers may be distributed and connected over the communication line 300 for providing separate services.

The PC 100 shown in FIG. 1 comprises a main unit 101, an image display unit 102 for displaying images on a display screen 102a according to instructions from the main unit 101, a keyboard 103 through which information is inputted in response to key operations, and a mouse 104 for inputting instructions by specifying any voluntary position on the display screen relevant to icons, for example. Viewing from outside, the main unit 101 has a flexible disk slot 101a through which a flexible disk (hereinafter sometimes abbreviated to FD) is loaded and a CD-ROM slot 101b through which a CD-ROM is loaded.

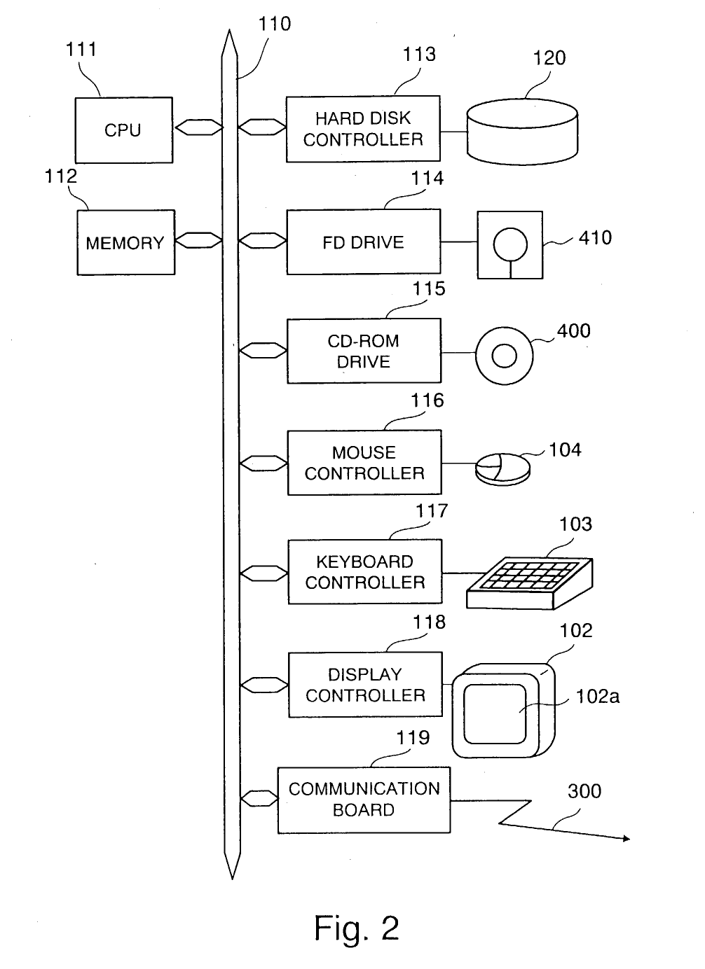

FIG. 2 shows a hardware configuration of the PC 100 shown in FIG. 1.

As shown in FIG. 2, the main unit 101 of the PC 100 shown in FIG. 1 has a CPU 111 within it for executing programs, memory 112 into which programs are loaded for execution, a hard disk 120 for storing programs and data, a hard disk controller 113 for accessing the hard disk 120, a FD drive 114 for accessing an FD 410 loaded in it, a CD-ROM drive 115 for accessing a CD-ROM 400 loaded in it, a mouse controller 116 for communicating operations of the mouse 104 to the CPU 111, a keyboard controller 117 for communicating key operations on the keyboard 103 to the CPU 111, a display controller 118 for communicating direction from the CPU 111 to the image display unit 102 to cause it to display images on the display screen 102a, and a communication board 119 connected to the communication line 300 for providing communications over the communication line 300. The CPU 111, memory 112, hard disk controller 113, FD drive 114, CD-ROM drive 115, mouse controller 116, keyboard controller 117, display controller 118, and communication board 119 are interconnected though a bus 110.

There will be described embodiments of a crossword puzzle playing program storage medium storing a crossword puzzle playing program of the present invention that is executed on the PC 100 shown in FIGS. 1 and 2. Also there will be described embodiments of a crossword puzzle playing apparatus of the present invention that is implemented by hardware and OS of the PC 100 and the crossword puzzle playing program executed on the PC 100.

In the following description, the assumption is that a crossword puzzle playing program storage medium of any of embodiments of the present invention is a CD-ROM and a crossword puzzle playing program stored in the CD-ROM is installed and executed in the PC 100. However, the crossword puzzle playing program of the present invention is not necessarily required to be stored in a CD-ROM. It may be stored in an FD or any of other removable storage media and installed in the PC 100, or may be previously installed in a hard disc of the PC 100, or may be downloaded over the communication line 300. The program may take any form that allows the program to be eventually executed on the PC 100.

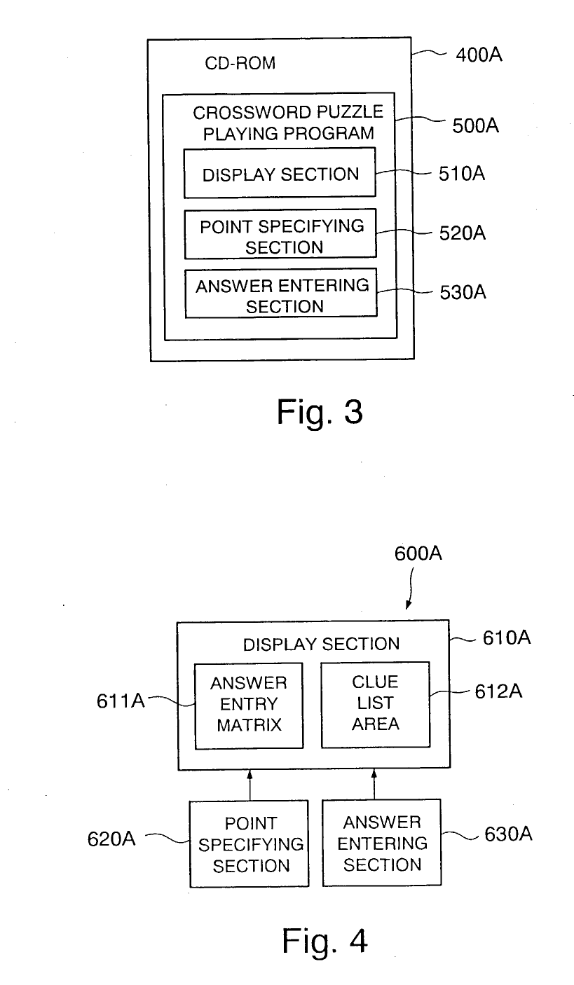

FIG. 3 schematically shows a configuration of a first crossword puzzle playing program storage medium according to the present invention.

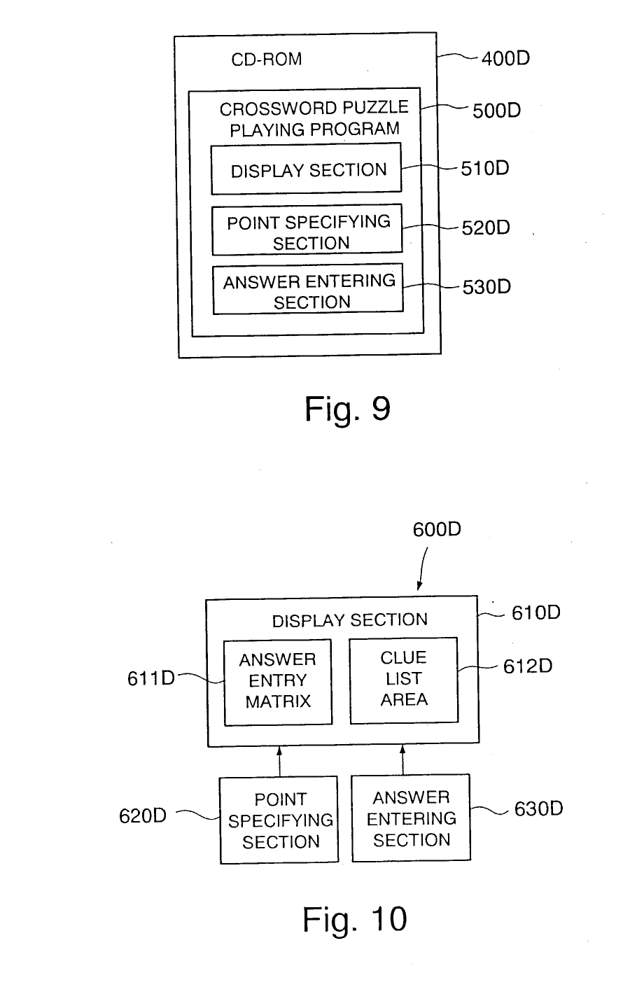

The crossword puzzle playing program 500A shown in FIG. 3 comprises a display section 510A, a point specifying section 520A, and an answer entering section 530A. The crossword puzzle playing program 500A in this example is stored in a CD-ROM 400A. While the point specifying section 520A is included in the crossword puzzle playing program 500A in the present embodiment, it is not necessarily required to be included in the program 500A. Instead, a point specification section of any other programs, such as an OS (operating system) may be used as the point specifying section 520A. This also applies to other crossword puzzle playing programs, such as a crossword puzzle playing program 500D shown in FIG. 9, that are stored in crossword puzzle playing program storage media of other embodiments of the present invention.

The CD-ROM 400A shown in FIG. 3 is equivalent to the CD-ROM 400 shown in FIGS. 1 and 2. The CD-ROM 400A is loaded into the PC 100 and accessed, and then the crossword puzzle playing program 500A stored in the CD-ROM 400A is installed and executed in the PC 100. When executed on the PC 100, the crossword puzzle playing program 500A causes the PC 100 to display a matrix of rows and columns of cells and function as a crossword puzzle playing apparatus in which answers are entered in the cells in accordance with operations performed by a player. Functions of the display section 510A, point specifying section 520A, and answer entering section 530A will be described in conjunction with FIG. 4.

FIG. 4 shows a configuration block diagram of one embodiment of a first crossword puzzle playing apparatus of the present invention.

The crossword puzzle playing apparatus 600A shown in FIG. 4 is implemented by a combination of hardware of the PC 100 shown in FIGS. 1 and 2, an OS (operating system) running on the PC 100, and the crossword puzzle playing program executed on the PC 100 under the control of the OS, a configuration of which program is shown in FIG. 3. The crossword puzzle playing apparatus 600A comprises a display section 610A, point specifying section 620A, and an answer entering section 630A. The display section 610A, point specifying section 620A, and answer entering section 630A correspond to the display section 510A, point specifying section 520A, and answer entering section 530A in FIG. 3, respectively. The display section 610A, point specifying section 620A, and answer entering section 630A making up the crossword puzzle playing apparatus 600A in FIG. 4 are implemented by a combination of hardware and the OS of the PC 100 and the application program executed on the PC 100 as described above, whereas the display section 510A, point specifying section 520A, and answer entering section 530A making up the crossword puzzle playing application 500A in FIG. 3 are implemented by the application program alone. The functions of the components 510A, 520A, and 530A of the crossword puzzle playing program 500A shown in FIG. 3 are the functions of the components 610A, 620A, and 630A of the crossword puzzle playing apparatus 600A shown in FIG. 4, which are provided when the crossword puzzle playing program 500A is executed on the PC 100. Therefore, the functions of the components of the crossword puzzle playing apparatus 600A in FIG. 4 alone will be described and the description of the components 510A, 520A, and 530A of the crossword puzzle playing program 500 in FIG. 3 will be omitted.

The display section 610A, which is part of the crossword puzzle playing apparatus 600A shown in FIG. 4, causes the image display unit 102 shown in FIGS. 1 and 2 to display on its display screen 102a an answer entry matrix 611A of cells arranged horizontally and vertically to which answer is to be entered and a clue list area 612A containing clues to answers to be entered in the answer entry matrix. The display section 610A as hardware is implemented by a combination of the image display unit 102, the display controller 118, CPU 111, and other components shown in FIGS. 1 and 2.

The point specifying section 620A in FIG. 4 functions so as to specify a point on the display screen in accordance with a player operation. The point specifying section 620A as hardware is implemented by a combination of the mouse 104, mouse controller 116, CPU 111, and other components shown in FIGS. 1 and 2.

The answer entering section 630A is used for entering answers in the answer entry matrix according to player operations and, as hardware, is primarily implemented by the keyboard 103 shown in FIGS. 1 and 2 in the present embodiment.

The display section 610A, in response to specification of a clue on the clue list by the point specifying section, highlights an answer entry range consisting of one or more cells in the answer entry matrix that correspond to the clue specified through the point specifying section.

The display section 610A displays the answer entry matrix on the above-mentioned display screen in a scrollable fashion. The display section 610A receives specification of a clue in the clue list area 612A which is provided from the point specifying section 620A and highlights the answer entry range. If the answer entry range in the answer entry matrix 611A that corresponds to the clue specified through the point specifying section 620A is hidden, the display section 610A scrolls through to bring the answer entry range into view and highlights the answer entry range.

This allows the player to know at first sight the answer entry range in which an answer corresponding to the specified clue is to be entered.

Specific embodiments of the first crossword puzzle playing program storage medium and the first crossword puzzle playing apparatus, embodiments of which have been described with reference to FIGS. 3 and 4, will be further described later.

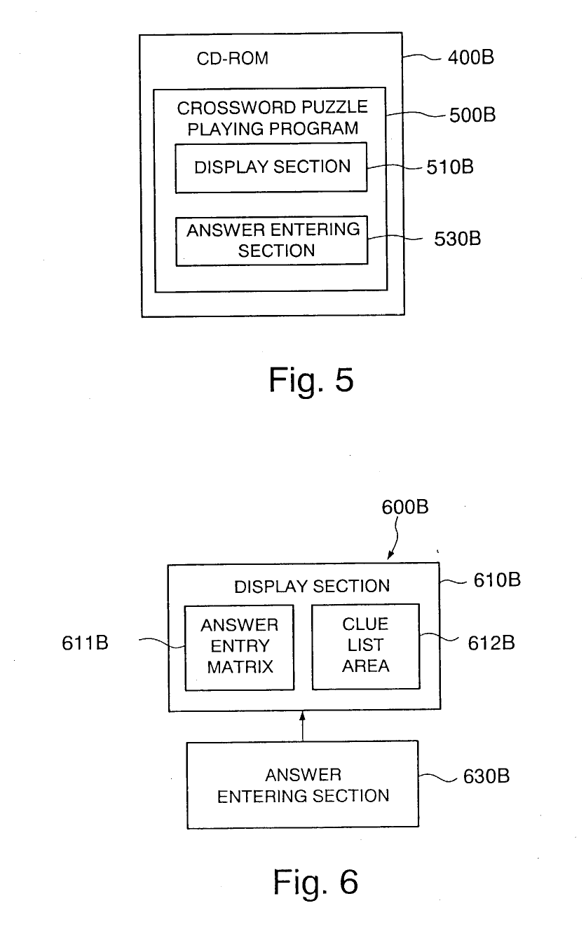

FIG. 5 schematically shows a configuration of an embodiment of a second crossword puzzle program storage medium according to the present invention.

The crossword puzzle playing program 500 shown in FIG. 5 comprises a display section 510B and an answer entering section 530B. The crossword puzzle playing program 500B in this example is stored in a CD-ROM 400B, like the one described with respect to FIG. 3.

Like the CD-ROM 400A shown in FIG. 3, the CD-ROM 400B is equivalent to the CD-ROM 400 shown in FIGS. 1 and 2. The CD-ROM 400B is loaded into the PC 100 and accessed, and then the crossword puzzle playing program 500B stored in the CD-ROM 400B is installed and executed in the PC 100. When executed on the PC 100, the crossword puzzle playing program 500B causes the PC 100 to display a matrix of rows and columns of cells and function as a crossword puzzle playing apparatus in which answers are entered in cells according to operations by a player. Functions of the display section 510B and answer entering section 530B will be described in conjunction with the description of FIG. 6.

FIG. 6 shows a configuration block diagram of one embodiment of a second crossword puzzle playing apparatus of the present invention.

Like the first crossword puzzle playing apparatus shown in FIG. 4, the crossword puzzle playing apparatus 600B shown in FIG. 6 is implemented by a combination of hardware of the PC 100 shown in FIGS. 1 and 2, an OS (operating system) running on the PC 100, and the crossword puzzle playing program 500B executed on the PC 100 under the control of the OS, a configuration of which is shown in FIG. 5. The crossword puzzle playing apparatus 600B comprises a display section 610B and an answer entering section 630B. The display section 610B and answer entering section 630B correspond to the display section 510B and answer entering section 530B in FIG. 5, respectively. The display section 610B and answer entering section 630B making up the crossword puzzle playing apparatus 600B are implemented by a combination of hardware and the OS of the PC 100 and the application program executed on the PC 100 as described above, whereas the display section 510B and answer entering section 530B making up the crossword puzzle playing program 500B are implemented by the application program alone. The functions of the components 510B and 530B of the crossword puzzle playing program 500B shown in FIG. 5 are the functions of the components 610B and 630B of the crossword puzzle playing apparatus 600B shown in FIG. 6, which are provided when the crossword puzzle playing program 500B is executed on the PC 100. Therefore, the functions of the components of the crossword puzzle playing apparatus 600B in FIG. 6 alone will be described and the description of the components 510B and 530B of the crossword puzzle playing program 500B in FIG. 5 will be omitted.

The display section 610B, which is part of the crossword puzzle playing apparatus 600B shown in FIG. 6, causes the computer to display an answer entry matrix 611B of cells arranged horizontally and vertically in which answers are entered and a clue list area 612B containing clues to answers to be entered in the answer entry matrix 611B on the display screen 102a of the image display unit 102 shown in FIGS. 1 and 2, with the clue list are 612B being scrollable. The display section 610B as hardware is implemented by a combination of the image display unit 102 and the display controller 118, CPU 111, and other components shown in FIGS. 1 and 2.

The answer entering section 630B is used for entering answers in the answer entry matrix 611B according to player operations and, as hardware, is primarily implemented by the keyboard 103 shown in FIGS. 1 and 2 in the present embodiment.

The display section 610B highlights an answer entry range consisting of one or more cells in the answer entry matrix 611B that correspond to a clue displayed in a particular position (the top of the display) in the clue list area 612B.

The display section 610B displays the clue list area 612B in the display screen 102a (see FIG. 1) in a scrollable fashion. It also displays the answer entry matrix 611B in the display screen 102a in a scrollable fashion. When the clue displayed in the particular position (the top of the display) is changed by scrolling the clue list area 612B, the display section 610B highlights the particular answer entry range in the answer entry matrix 611B that corresponds to the clue displayed in the particular position (the top of the display). If the answer entry range is hidden, the display section 610B scrolls through the answer entry matrix 6111B to bring the answer entry range into view, and highlights the answer entry range.

This allows the player to know at first sight the answer entry range in which an answer corresponding to the specified clue is to be entered.

Further specific embodiments of the second crossword puzzle playing program storage medium and the second crossword puzzle playing apparatus, one embodiment of which has been described with reference to FIGS. 5 and 6, will be described later.

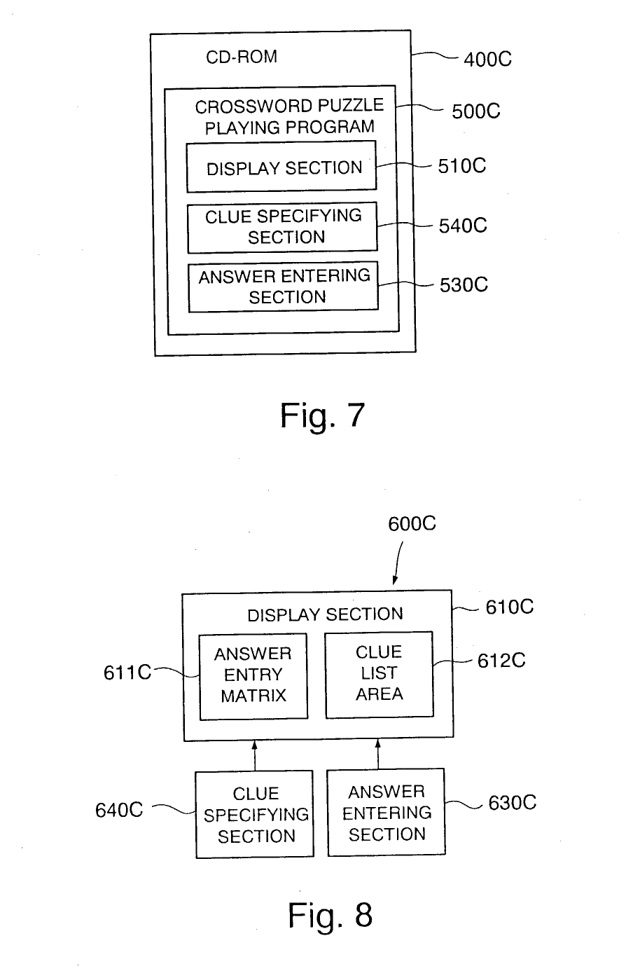

FIG. 7 schematically shows a configuration of an embodiment of a third crossword puzzle playing program storage medium according to the present invention.

A crossword puzzle playing program 500C shown in FIG. 7 comprises a display section 510C, a clue specifying section 540C, and an answer entering section 530C. The crossword puzzle playing program 500C in this example is stored on a CD-ROM 400C.

The CD-ROM 400C is equivalent to the CD-ROM 400 shown in FIGS. 1 and 2. The CD-ROM 400C is loaded into the PC 100 and accessed, and then the crossword puzzle playing program 500C stored in the CD-ROM 400C is installed and executed in the PC 100. When executed on the PC 100, the crossword puzzle playing program 500C causes the PC 100 to display a matrix of rows and columns of cells and function as a crossword puzzle playing apparatus in which answers are entered in cells according to operations by a player. Functions of the display section 510C, clue specifying section 540C, and answer entering section 530C will be described in conjunction with the description of FIG. 8.

FIG. 8 shows a configuration block diagram of one embodiment of a third crossword puzzle playing apparatus of the present invention.

The crossword puzzle playing apparatus 600C shown in FIG. 8 is implemented by a combination of hardware of the PC 100 shown in FIGS. 1 and 2, an OS (operating system) running on the PC 100, and the crossword puzzle playing program 500C executed on the PC 100 under the control of the OS, a configuration of which is shown in FIG. 7. The crossword puzzle playing apparatus 600C comprises a display section 610C, clue specifying section 640C, and an answer entering section 630C. The display section 610C, point specifying section 640C, and answer entering section 630C correspond to the display section 510C, point specifying section 540C, and answer entering section 530C in FIG. 7, respectively. The display section 610C, clue specifying section 640C, and answer entering section 630C making up the crossword puzzle playing apparatus 600C in FIG. 8 are implemented by a combination of hardware and the OS of the PC 100 and the application program executed on the PC 100 as described above, whereas the display section 510C, clue specifying section 540C, and answer entering section 530C making up the crossword puzzle playing program 500C in FIG. 7 are implemented by the application program alone. The functions of the components 510C, 540C, and 530C of the crossword puzzle playing program 500C shown in FIG. 7 are the functions of the components 610C, 640C, and 630C of the crossword puzzle playing apparatus 600C shown in FIG. 8, which are provided when the crossword puzzle playing program 500C is executed on the PC 100. Therefore, the functions of the components of the crossword puzzle playing apparatus 600C in FIG. 8 alone will be described and the description of the components 510C, 540C, and 530C of the crossword puzzle playing program 500C in FIG. 7 will be omitted.

The display section 610C, which is part of the crossword puzzle playing apparatus 600C shown in FIG. 8, causes the image display unit 102 shown in FIGS. 1 and 2 to display on its display screen 102a an answer entry matrix 611C of cells arranged horizontally and vertically in which answers are entered and a clue list area 612C containing clues to answers to be entered in the answer entry matrix 611C, with the answer entry matrix 611C being scrollable. The display section 610C as hardware is implemented by a combination of the image display unit 102 and the display controller 118, CPU 111, and other components shown in FIGS. 1 and 2.

The clue specifying section 640C in FIG. 8 functions so as to specify a clue in the clue list area 612C according to an operation performed by a player and, as hardware, is implemented by a combination of the mouse 104, mouse controller 116, CPU 111, and other components shown in FIGS. 1 and 2.

The answer entering section 630C is used for entering answers in the answer entry matrix 611C according to player operations and, as hardware, is primarily implemented by the keyboard 103 shown in FIGS. 1 and 2 in the present embodiment.

The display section 610C, in response to specification of a clue in the clue list area 612C which is provided from the clue specifying section 640C, scrolls the answer entry matrix 611C to display on the display screen an answer entry range consisting of one or more cells that correspond to the clue specified through the clue specifying section 640C if the answer entry range is hidden.

This can ensure that the answer entry range in which answer corresponding to the specified clue is to be entered is displayed on the display screen.

FIG. 9 schematically shows a configuration of an embodiment of a fourth crossword puzzle playing program storage medium according to the present invention.

The crossword puzzle playing program 500D shown in FIG. 9 comprises a display section 510D, a point specification section 520D, and an answer entering section 530D. The crossword puzzle playing program 500D in this example is stored in a CD-ROM 400D.

The CD-ROM 400D is equivalent to the CD-ROM 400 shown in FIGS. 1 and 2. The CD-ROM 400D is loaded into the PC 100 and accessed, and then the crossword puzzle playing program 500D stored in the CD-ROM 400D is installed and executed in the PC 100. When executed on the PC 100, the crossword puzzle playing program 500D causes the PC 100 to display a matrix of rows and columns of cells and function as a crossword puzzle playing apparatus in which answers are entered in cells according to operations by a player. Functions of the display section 510D, point specifying section 520D, and answer entering section 530D will be described in conjunction with the description of FIG. 10.

FIG. 10 shows a configuration block diagram of an embodiment of a fourth crossword puzzle playing apparatus of the present invention.

The crossword puzzle playing apparatus 600D shown in FIG. 10 is implemented by a combination of hardware of the PC 100 shown in FIGS. 1 and 2, an OS (operating system) running on the PC 100, and the crossword puzzle playing program 500D executed on the PC 100 under the control of the OS, a configuration of which program is shown in FIG. 9. The crossword puzzle playing apparatus 600D comprises a display section 610D, point specifying section 620D, and an answer entering section 630D. The display section 610D, point specifying section 620D, and answer entering section 630D correspond to the display section 510D, point specifying section 520D, and answer entering section 530D in FIG. 9, respectively. The display section 610D, point specifying section 620D, and answer entering section 630D making up the crossword puzzle playing apparatus 600D are implemented by a combination of hardware and the OS of the PC 100 and the application program executed on the PC 100 as described above, whereas the display section 510D, point specifying section 520D, and answer entering section 530D making up the crossword puzzle playing program 500D are implemented by the application program alone. The functions of the components 510D, 520D, and 530D of the crossword puzzle playing program 500D shown in FIG. 9 are the functions of the components 610D, 620D, and 630D of the crossword puzzle playing apparatus 600D shown in FIG. 10, which are provided when the crossword puzzle playing program 500D is executed on the PC 100. Therefore, the functions of the components of the crossword puzzle playing apparatus 600D in FIG. 10 alone will be described and the description of the components 510D, 520D, and 530D of the crossword puzzle playing program 500D in FIG. 9 will be omitted.

The display section 610D, which is part of the crossword puzzle playing apparatus 600D shown in FIG. 10, causes the image display unit 102 shown in FIGS. 1 and 2 to display on its display screen 102a an answer entry matrix 611D of cells arranged horizontally and vertically in which answers are to be entered and a clue list area 612D containing clues to answers to be entered in the answer entry matrix 611D. The display section 610D as hardware is implemented by a combination of the image display unit 102 and the display controller 118, CPU 111, and other components shown in FIGS. 1 and 2.

The point specifying section 620D in FIG. 10 functions to specify a point on the display screen in accordance with a player operation. The point specifying section 620D as hardware is implemented by a combination of the mouse 104, mouse controller 116, CPU 111, and other components shown in FIGS. 1 and 2.

The answer entering section 630D is used for entering answers in the answer entry matrix 611D according to player operations and, as hardware, is primarily implemented by the keyboard 103 shown in FIGS. 1 and 2 in the present embodiment.

The display section 610D, in response to specification of an answer entry range consisting of one or more cells in the answer entry matrix 611D which is provided from the point specifying section 620D, highlights a clue in the clue list area 612D that corresponds to the answer entry range specified through the point specifying section 620D.

The display section 610D displays the clue list area 612D in a scrollable manner on the display screen. The display section 610D receives specification of an answer entry range in the answer entry matrix 611D, which is provided from the point specifying section 620D, and highlights a clue in the clue list area 612D that corresponds to the answer entry range specified through the point specifying section 620D. If the clue is hidden, the display section 610D scrolls through the display screen to display and highlight it in the display screen.

This allows the player to know at first sight the clue corresponding to an answer to be entered in the answer entry range specified.

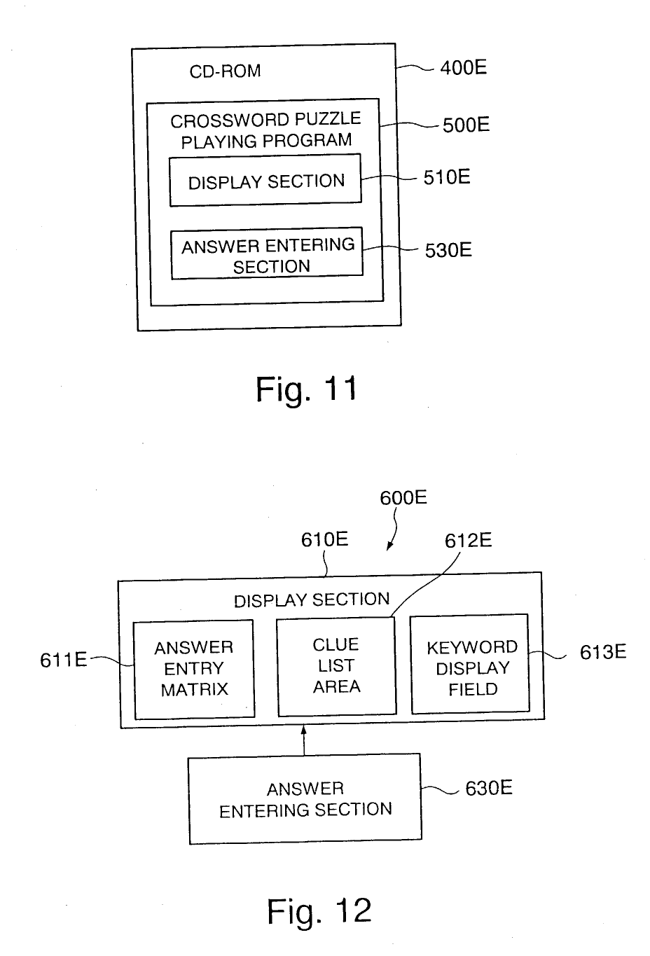

FIG. 11 schematically shows a configuration of an embodiment of a fifth crossword puzzle program storage medium according to the present invention.

The crossword puzzle playing program 500E shown in FIG. 11 comprises a display section 510E and an answer entering section 530E. The crossword puzzle playing program 500E in this example is stored in a CD-ROM 400E.

The CD-ROM 400E is equivalent to the CD-ROM 400 shown in FIGS. 1 and 2. The CD-ROM 400E is loaded into the PC 100 and accessed, and then the crossword puzzle playing program 500E stored in the CD-ROM 400E is installed and executed in the PC 100. When executed on the PC, the crossword puzzle playing program 500E causes the PC 100 to display a matrix of rows and columns of cells and function as a crossword puzzle playing apparatus in which answers are entered in cells according to operations by a player. Functions of the display section 510E and answer entering section 530E will be described in conjunction with the description of FIG. 12.

FIG. 12 shows a configuration block diagram of one embodiment of a fifth crossword puzzle playing apparatus of the present invention.

The crossword puzzle playing apparatus 600E shown in FIG. 12 is implemented by a combination of hardware of the PC 100 shown in FIGS. 1 and 2, an OS (operating system) running on the PC 100, and the crossword puzzle playing program executed on the PC 100 under the control of the OS, a configuration of which program is shown in FIG. 11. The crossword puzzle playing apparatus 600E comprises a display section 610E and an answer entering section 630E. The display section 610E and answer entering section 630E correspond to the display section 510E and answer entering section 530E, respectively. The display section 610E and answer entering section 630E making up the crossword puzzle playing apparatus 600E are implemented by a combination of hardware and the OS of the PC 100 and the application program executed on the PC 100 as described above, whereas the display section 510E and answer entering section 530E making up the crossword puzzle playing program 500E are implemented by the application program alone. The functions of the components 510E and 530E of the crossword puzzle playing program 500E shown in FIG. 11 are the functions of the components 610E and 630E of the crossword puzzle playing apparatus 600E shown in FIG. 12, which are provided when the crossword puzzle playing program 500E is executed on the PC 100. Therefore, the functions of the components of the crossword puzzle playing apparatus 600E in FIG. 12 alone will be described and the description of the components 510E and 530E of the crossword puzzle playing program 500E in FIG. 11 will be omitted.

The display section 610E which is a part of the crossword puzzle playing apparatus 600E shown in FIG. 12, causes the image display unit 102 shown in FIGS. 1 and 2 to display on its display screen 102a an answer entry matrix 611E of cells arranged horizontally and vertically in which answers are to be entered, a clue list area 612E containing clues to answers to be entered in the answer entry matrix 611E, and a keyword display field 613E listing, in a certain order, the same characters as those that are entered in some certain cells of the cells making up the answer entry matrix 611E. The display section 610E as hardware is implemented by a combination of the image display unit 102 and the display controller 118, CPU 111, and other components shown in FIGS. 1 and 2.

The answer entering section 630E is used for entering answers in the answer entry matrix 611E according to player operations and, as hardware, is primarily implemented by the keyboard 103 shown in FIGS. 1 and 2 in the present embodiment.

In response to entry of characters in particular cells in the answer entry matrix 611E through the answer entering section 630E, the display section 610E also displays the same characters in positions on the keyword display field 613E that correspond to the particular cells in which the character has been entered.

The display section 610E initially displays the answer entry matrix 611E and the clue list area 612E among the answer entry matrix 611E, clue list area 612E, and keyword display field 613E. It displays the keyword display field 613E when the first character is placed in particular cells in the answer entry matrix 611E through the answer entering section 630E.

This eliminates the need for the player to search the answer entry matrix for a keyword after completing the entry of an answer in the answer entry matrix 611E.

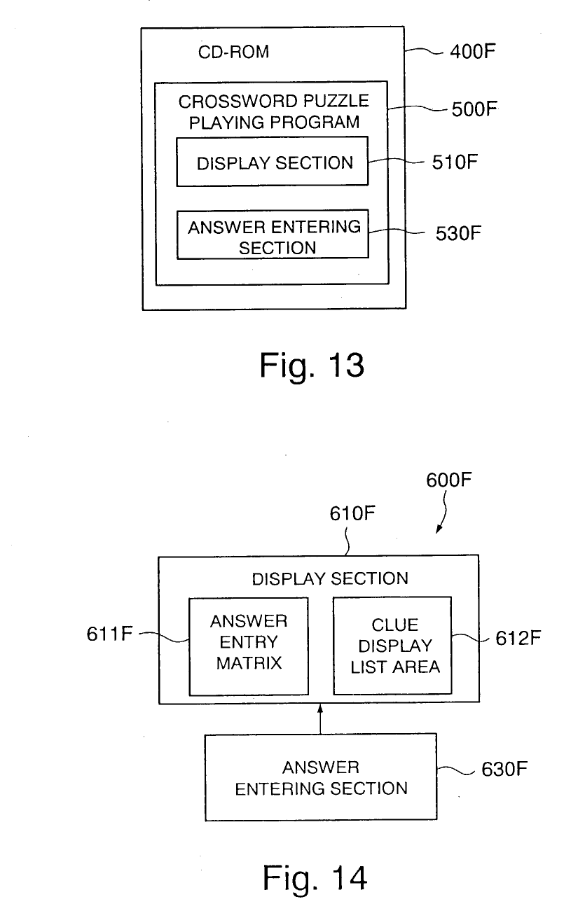

FIG. 13 schematically shows a configuration of an embodiment of a sixth crossword puzzle playing program storage medium according to the present invention.

The crossword puzzle playing apparatus 500F shown in FIG. 13 comprises a display section 510F and an answer entering section 530F. The crossword puzzle playing program 500F in this example is stored in a CD-ROM 400F.

The CD-ROM 400F is equivalent to the CD-ROM 400 shown in FIGS. 1 and 2. The CD-ROM 400F is loaded into the PC 100 and accessed, and then the crossword puzzle playing program 50OF stored in the CD-ROM 400F is installed and executed in the PC 100. When executed on the PC 100, the crossword puzzle playing program 500F causes the PC 100 to display a matrix of rows and columns of cells and function as a crossword puzzle playing apparatus in which answers are entered in cells according to operations by a player. Functions of the display section 510F and answer entering section 530F will be described in conjunction with the description of FIG. 14.

FIG. 14 shows a configuration block diagram of one embodiment of a sixth crossword puzzle playing apparatus of the present invention.

The crossword puzzle playing apparatus 600F shown in FIG. 14 is implemented by a combination of hardware of the PC 100 shown in FIGS. 1 and 2, an OS (operating system) running on the PC 100, and the crossword puzzle playing program 50OF executed on the PC 100 under the control of the OS, a configuration of which is shown in FIG. 13. The crossword puzzle playing apparatus 600F comprises a display section 610F and an answer entering section 630F. The display section 610F and answer entering section 630F correspond to the display section 510F and answer entering section 530F in FIG. 13, respectively. The display section 610F and answer entering section 630F making up the crossword puzzle playing apparatus 600F in FIG. 14 are implemented by a combination of hardware and the OS of the PC 100 and the application program executed on the PC 100 as described above, whereas the display section 510F and answer entering section 530F making up the crossword puzzle playing program 500F in FIG. 13 are implemented by the application program alone. The functions of the components 510F and 530F of the crossword puzzle playing program 500F shown in FIG. 13 are the functions of the components 610F and 630F of the crossword puzzle playing apparatus 600F shown in FIG. 14, which are provided when the crossword puzzle playing program 500F is executed on the PC 100. Therefore, the functions of the components of the crossword puzzle playing apparatus 600F in FIG. 14 alone will be described and the description of the components 510F and 530F of the crossword puzzle playing program 500F in FIG. 13 will be omitted.

The display section 610F, which is part of the crossword puzzle playing apparatus 600F shown in FIG. 14, causes the image display unit 102 shown in FIGS. 1 and 2 to display on its display screen 102a an answer entry matrix 611F of cells arranged horizontally and vertically in which answers are to be entered and a clue list area 612F containing clues to answers to be entered in the answer entry matrix 611F. The display section 610F as hardware is implemented by a combination of the image display unit 102 and the display controller 118, CPU 111, and other components shown in FIGS. 1 and 2.

The answer entering section 630F is used for entering answers in the answer entry matrix according to player operations and, as hardware, is primarily implemented by the keyboard 103 shown in FIGS. 1 and 2 in the present embodiment.

In response to entry of an answer in an answer entry range in the answer entry matrix 611F through the answer entering section 630F, the display section 610F provides a display indicating that the clue in the clue list area 612F that corresponds to that answer entry range has already been answered.

This allows the player to readily distinguish whether a clue has been answered or not.

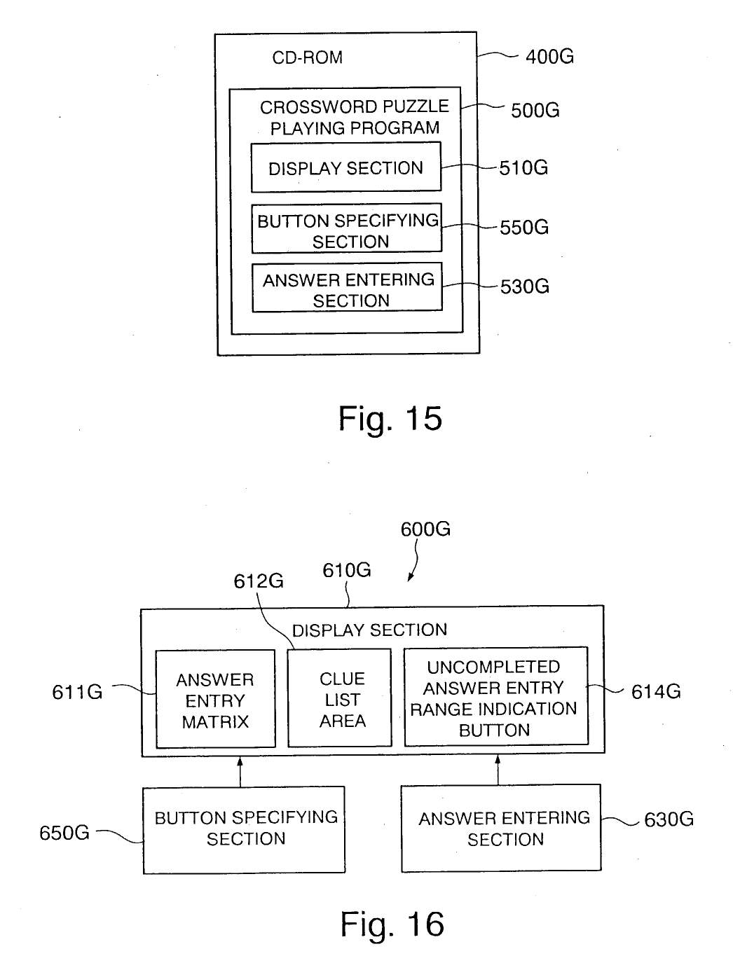

FIG. 15 schematically shows a configuration of an embodiment of a seventh crossword puzzle playing program storage medium according to the present invention.

The crossword puzzle playing program 500G shown in FIG. 15 comprises a display section 510G, a button specifying section 550G, and an answer entering section 530G. The crossword puzzle playing program 500G in this example is stored in a CD-ROM 400G.

The CD-ROM 400G is equivalent to the CD-ROM 400 shown in FIGS. 1 and 2. The CD-ROM 400G is loaded into the PC 100 and accessed, and then the crossword puzzle playing program 500G stored in the CD-ROM 400G is installed and executed in the PC 100. When executed on the PC 100, the crossword puzzle playing program 500G causes the PC 100 to display a matrix of rows and columns of cells and function as a crossword puzzle playing apparatus in which answers are entered in cells according to operations by a player. Functions of the display section 510G, button specifying section 550G, and answer entering section 530G will be described in conjunction with the description of FIG. 16.

FIG. 16 shows a configuration block diagram of one embodiment of a seventh crossword puzzle playing apparatus of the present invention.

The crossword puzzle playing apparatus 600G shown in FIG. 16 is implemented by a combination of hardware of the PC 100 shown in FIGS. 1 and 2, an OS (operating system) running on the PC 100, and the crossword puzzle playing program 500G executed on the PC 100 under the control of the OS, a configuration of which is shown in FIG. 15. The crossword puzzle playing apparatus 600G comprises a display section 610G, a button specifying section 650G, and an answer entering section 630G. The display section 610G, button specifying section 650G, and answer entering section 630G correspond to the display section 510G, button specifying section 550G, and answer entering section 530B in FIG. 15, respectively. The display section 610G, button specifying section 650G, and answer entering section 630G making up the crossword puzzle playing apparatus 600G in FIG. 16 are implemented by a combination of hardware and the OS of the PC 100 and the application program executed on the PC 100 as described above, whereas the display section 510G, button specifying section 550G, and answer entering section 530G making up the crossword puzzle playing program 500G are implemented by the application program alone. The functions of the components 510G, 550G, and 530G of the crossword puzzle playing program 500G shown in FIG. 15 are the functions of the components 610G, 650G, and 630G of the crossword puzzle playing apparatus 600G shown in FIG. 16, which are provided when the crossword puzzle playing program 500G is executed on the PC 100. Therefore, the functions of the components of the crossword puzzle playing apparatus 600G in FIG. 16 alone will be described and the description of the components 510G, 550G, and 530G of the crossword puzzle playing program 500G in FIG. 15 will be omitted.

The display section 610G, which is part of the crossword puzzle playing apparatus 600G shown in FIG. 16, causes the image display unit 102 shown in FIGS. 1 and 2 to display on its display screen 102a an answer entry matrix 611G of cells arranged horizontally and vertically in which answers are to be entered, a clue list area 612G containing clues to answers to be entered in the answer entry matrix 611G, and an uncompleted answer entry range indication button 614G. The display section 610G as hardware is implemented by a combination of the image display unit 102 and the display controller 118, CPU 111, and other components shown in FIGS. 1 and 2.

The button specifying section 650G in FIG. 16 specifies the uncompleted answer entry range indication button 614G in response to a player operation and, as hardware, is implemented by a combination of the mouse 104, mouse controller 116, CPU 111 and other components shown in FIGS. 1 and 2.

The answer entering section 630G is used for entering answers in the answer entry matrix 611G according to player operations and, as hardware, is primarily implemented by the keyboard 103 shown in FIGS. 1 and 2 in the present embodiment.

The display section 610G, in response to specification of the uncompleted answer entry range indication button 614G from the button specifying section 650G, highlights uncompleted answer entry ranges in the answer entry matrix 611G in which no answer is placed through the answer entering section 630G.

This allows the player to know at first sight uncompleted answer entry ranges in the answer entry matrix.

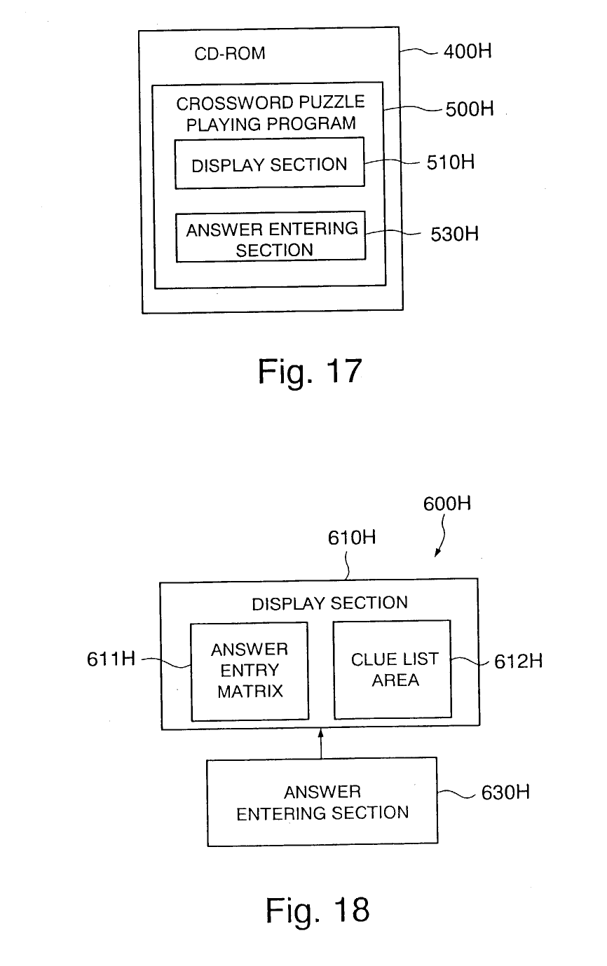

FIG. 17 schematically shows a configuration of an embodiment of an eighth crossword puzzle playing program storage medium according to the present invention.

A crossword puzzle playing program 500H shown in FIG. 17 comprises a display section 510H and an answer entering section 530H. The crossword puzzle playing program 500H in this example is stored on a CD-ROM 400H.

The CD-ROM 400H is equivalent to the CD-ROM 400 shown in FIGS. 1 and 2. The CD-ROM 400H is loaded into the PC 100 and accessed, and then the crossword puzzle playing program 500H stored in the CD-ROM 400H is installed and executed in the PC 100. When executed on the PC 100, the crossword puzzle playing program 500H causes the PC 100 to display a matrix of rows and columns of cells and function as a crossword puzzle playing apparatus in which answers are entered in cells according to operations by a player. Functions of the display section 510H and answer entering section 530H will be described in conjunction with the description of FIG. 18.

FIG. 18 shows a configuration block diagram of an embodiment of an eighth crossword puzzle playing apparatus of the present invention.

The crossword puzzle playing apparatus 600H shown in FIG. 18 is implemented by a combination of hardware of the PC 100 shown in FIGS. 1 and 2, an OS (operating system) running on the PC 100, and the crossword puzzle playing program 500H executed on the PC 100 under the control of the OS, a configuration of which is shown in FIG. 17. The crossword puzzle playing apparatus 600H comprises a display section 610H and an answer entering section 630H. The display section 610H and answer entering section 630H correspond to the display section 510H and answer entering section 530H in FIG. 17, respectively. The display section 610H and answer entering section 630H making up the crossword puzzle playing apparatus 600H are implemented by a combination of hardware and the OS of the PC 100 and the application program executed on the PC 100 as described above, whereas the display section 510H and answer entering section 530H making up the crossword puzzle playing program 500H are implemented by the application program alone. The functions of the components 510H and 530H of the crossword puzzle playing program 500H shown in FIG. 17 are the functions of the components 610H and 630H of the crossword puzzle playing apparatus 600H shown in FIG. 18, which are provided when the crossword puzzle playing program 500H is executed on the PC 100. Therefore, the functions of the components of the crossword puzzle playing apparatus 600H in FIG. 18 alone will be described and the description of the components 510H and 530H of the crossword puzzle playing program 500H in FIG. 17 will be omitted.

The display section 610H, which is part of the crossword puzzle playing apparatus 600H shown in FIG. 18, causes the image display unit 102 shown in FIGS. 1 and 2 to display on its display screen 102a an answer entry matrix 611H of cells arranged horizontally and vertically in which answers are to be entered and a clue list area 612H containing clues to answers to be placed in the answer entry matrix 611H such that the order in which clues in the clue list area 612H are listed can be changed. The display section 610H as hardware is implemented by a combination of the image display unit 102 and the display controller 118, CPU 111, and other components shown in FIGS. 1 and 2.

The answer entering section 630H is used for entering answers in the answer entry matrix 611H according to player operations and, as hardware, is primarily implemented by the keyboard 103 shown in FIGS. 1 and 2 in the present embodiment.

In response to entry of an answer in an answer entry range in the answer entry matrix 611H through the answer entering section 630H, the display section 610H changes the display mode of the clue list area 612 to mode in which a clue for which an answer is entered in the associated answer entry range is moved to a predetermined position.

As a result, the clue to the answer entered is moved to the predetermined position (the bottom of the clue list which is not displayed in the clue list area) to organize the clues so that the player can readily distinguish between answered and unanswered clues.

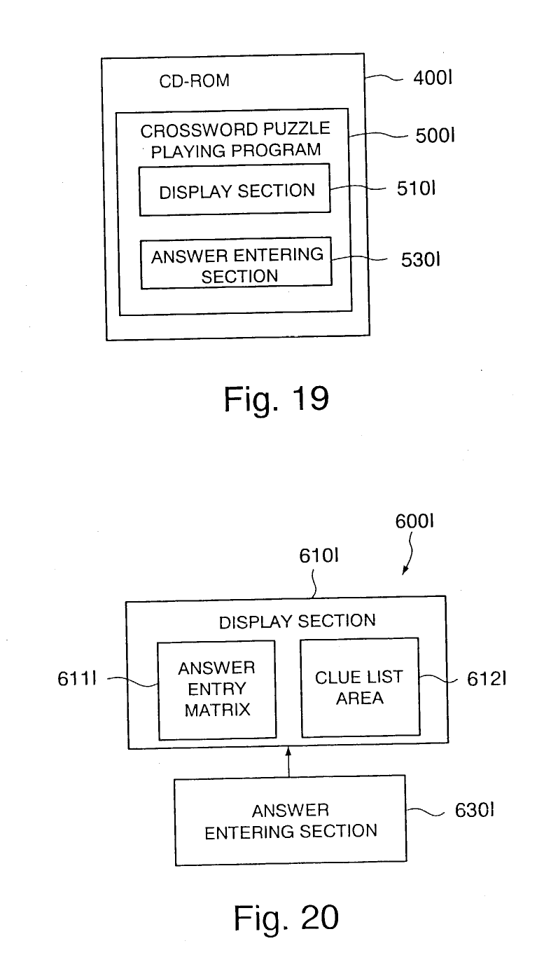

FIG. 19 schematically shows a configuration of an embodiment of a ninth crossword puzzle program storage medium according to the present invention.

The crossword puzzle playing program 500I shown in FIG. 19 comprises a display section 510I and an answer entering section 530I and is stored in a CD-ROM 400I, in this example.

The CD-ROM 400I is equivalent to the CD-ROM 400 shown in FIGS. 1 and 2. The CD-ROM 400I is loaded into the PC 100 and accessed, and then the crossword puzzle playing program 500I stored in the CD-ROM 400I is installed and executed in the PC 100. When executed on the PC 100, the crossword puzzle playing program 500I causes the PC 100 to display a matrix of rows and columns of cells and function as a crossword puzzle playing apparatus in which answers are entered in cells according to operations by a player. Functions of the display section 510I and answer entering section 530I will be described in conjunction with the description of FIG. 20.

FIG. 20 shows a configuration block diagram of one embodiment of a ninth crossword puzzle playing apparatus of the present invention.

The crossword puzzle playing apparatus 600I shown in FIG. 20 is implemented by a combination of hardware of the PC 100 shown in FIGS. 1 and 2, an OS (operating system) running on the PC 100, and the crossword puzzle playing program 500I executed on the PC 100 under the control of the OS, a configuration of which is shown in FIG. 19. The crossword puzzle playing apparatus 600I comprises a display section 610I and an answer entering section 630I. The display section 610I and answer entering section 630I correspond to the display section 510I and answer entering section 530I in FIG. 19, respectively. The display section 610I and answer entering section 630I making up the crossword puzzle playing apparatus 600I are implemented by a combination of hardware and the OS of the PC 100 and the application program executed on the PC 100 as described above, whereas the display section 5101 and answer entering section 530I making up the crossword puzzle playing program 500I are implemented by the application program alone. The functions of the components 510I and 530I of the crossword puzzle playing program 500I shown in FIG. 19 are the functions of the components 610I and 630I of the crossword puzzle playing apparatus 600I shown in FIG. 20, which are provided when the crossword puzzle playing program 500I is executed on the PC 100. Therefore, the functions of the components of the crossword puzzle playing apparatus 600I in FIG. 20 alone will be described and the description of the components 510I and 5301 of the crossword puzzle playing program 500I in FIG. 19 will be omitted.

The display section 610I, which is part of the crossword puzzle playing apparatus 600I shown in FIG. 20, causes the image display unit 102 shown in FIGS. 1 and 2 to display on its display screen 102a an answer entry matrix 611I of cells arranged horizontally and vertically in which answers are to be entered and a clue list area 612I containing clues to answers to be entered in the answer entry matrix 611I, with the clue list area 612I being scrollable. The display section 610I as hardware is implemented by a combination of the image display unit 102 and the display controller 118, CPU 111, and other components shown in FIGS. 1 and 2.

The answer entering section 630I is used for entering answers in the answer entry matrix 611I according to player operations and, as hardware, is primarily implemented by the keyboard 103 shown in FIGS. 1 and 2 in the present embodiment.

The display section 601I is responsive to entry of an answer in an answer entry range in the answer entry matrix 611I through the answer entering section 630I, scrolls through the clue list area 612I to display a clue to an answer that has not yet been entered.

As a result, the clue list is scrolled to display the unanswered clue at a predetermined position (at the top of the list) so that the player can readily know the unanswered clue.

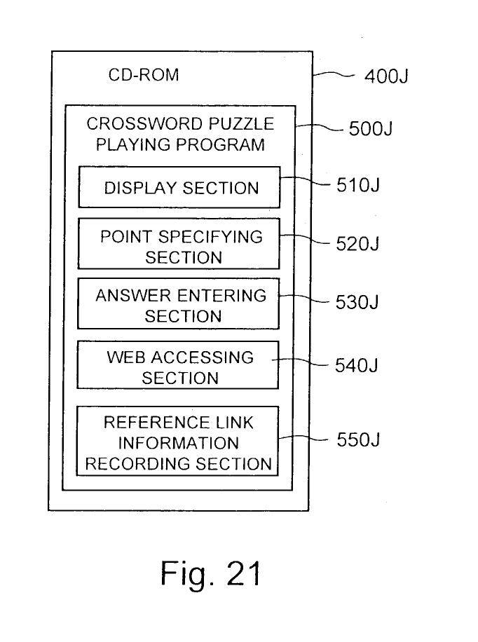

FIG. 21 schematically shows a configuration of an embodiment of a tenth crossword puzzle playing program storage medium according to the present invention.

The crossword puzzle playing program 500J shown in FIG. 21 comprises a display section 510J, a point specifying section 520J, an answer entering section 530J, Web accessing section 540J, and a reference link information recording section 550J. The crossword puzzle playing program 500J in this example is stored in a CD-ROM 400J.

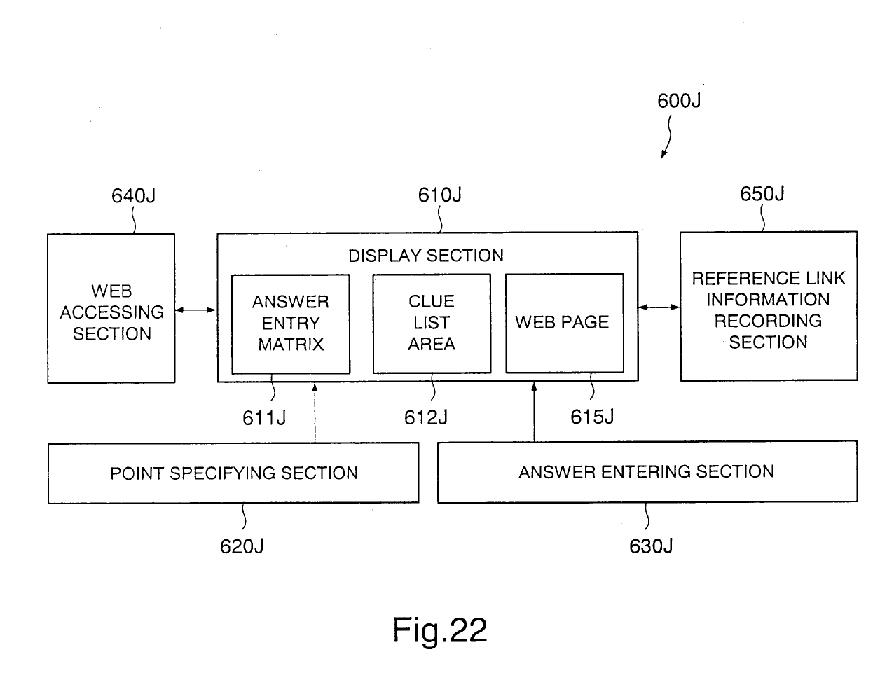

The CD-ROM 400J is equivalent to the CD-ROM 400 shown in FIGS. 1 and 2. The CD-ROM 400J is loaded into the PC 100 and accessed, and then the crossword puzzle playing program 500J stored in the CD-ROM 400J is installed and executed in the PC 100. When executed on the PC 100, the crossword puzzle playing program 500J causes the PC 100 to display a matrix of rows and columns of cells and function as a crossword puzzle playing apparatus in which answers are entered in cells according to operations by a player. Functions of the display section 510J, point specifying section 520J, answer entering section 530J, Web accessing section 540J, and reference link information recording section 550J will be described in conjunction with the description of FIG. 22.

FIG. 22 shows a configuration block diagram of an embodiment of a tenth crossword puzzle playing apparatus according to the present invention.

The crossword puzzle playing apparatus 600J shown in FIG. 22 is implemented by a combination of hardware of the PC 100 shown in FIGS. 1 and 2, an OS (operating system) running on the PC 100, and the crossword puzzle playing program 500J executed on the PC 100 under the control of the OS, a configuration of which is shown in FIG. 21. The crossword puzzle playing apparatus 600J comprises a display section 610J, a point specifying section 620J, an answer entering section 630J, a Web accessing section 640J, and reference link information recording section 650J. The display section 610J, point specifying section 620J, answer entering section 630J, Web accessing section 640J, and reference link information recording section 650J correspond to the display section 510J, point specifying section 520J, answer entering section 530J, Web accessing section 540J, and reference link information recording section 550J in FIG. 21, respectively. The display section 610J, point specifying section 620J, answer entering section 630J, Web accessing section 640J, and reference link information recording section 650J making up the crossword puzzle playing apparatus 600J in FIG. 22 are implemented by a combination of hardware and the OS of the PC 100 and the application program executed on the PC 100 as described above, whereas the display section 510J, point specifying section 520J, answer entering section 530J, Web accessing section 540J, and reference link information recording section 550J making up the crossword puzzle playing program 500J in FIG. 21 are implemented by the application program alone. The functions of the components 510J, 520J, 530J, 540J, and 550J of the crossword puzzle playing program 500J shown in FIG. 21 are the functions of the components 610J, 620J, 630J, 640J, and 650J of the crossword puzzle playing apparatus 600J shown in FIG. 22, which are provided when the crossword puzzle playing program 500J is executed on the PC 100. Therefore, the functions of the components of the crossword puzzle playing apparatus 600J in FIG. 22 alone will be described and the description of the components 510J, 520J, 530J, 540J, and 550J of the crossword puzzle playing program 500J in FIG. 21 will be omitted.

The display section 610J, which is part of the crossword puzzle playing apparatus 600J shown in FIG. 22, causes the image display unit 102 shown in FIGS. 1 and 2 to display on its display screen 102a an answer entry matrix 611J of cells arranged horizontally and vertically in which answers are to be entered and a clue list area 612J containing clues to answers to be entered in the answer entry matrix 611J and liked to a Web page. The display section 610J as hardware is implemented by a combination of the image display unit 102 and the display controller 118, CPU 111, and other components shown in FIGS. 1 and 2.

The point specifying section 620J in FIG. 22 functions to specify a point on the display screen in accordance with a player operation. The point specifying section 620J as hardware is implemented by a combination of the mouse 104, mouse controller 116, CPU 111, and other components shown in FIGS. 1 and 2, in the present embodiment.

The answer entering section 630J is used for entering answers in the answer entry matrix 611J according to player operations and, as hardware, is primarily implemented by the keyboard 103 shown in FIGS. 1 and 2 in the present embodiment.

The Web accessing section 640J, in response to specification by the point specifying section 620J of a clue in the clue list 612J that is linked to a Web page, accesses the Web page to which the clue is linked.

The display section 610J displays on the display screen the Web page 615J accessed by the Web access section 640J, in addition to the answer entry matrix 611J and clue list area 612J.

The reference link information recording section 650J associates and records link information to the Web page accessed by the Web accessing section 640J with a clue linked to the Web page and/or an answer corresponding to the clue.

This allows a player not only to temporarily use the information obtained by referring to the Web page to which the clue is linked for the moment, but also to readily review the information later.

The reference link information recording section 650J may associate and record link information with a clue and/or answer on a particular Web page.

Specific embodiments relating to the embodiments of the first through tenth crossword puzzle playing apparatuses (including the first through tenth crossword puzzle playing programs) will be described below.

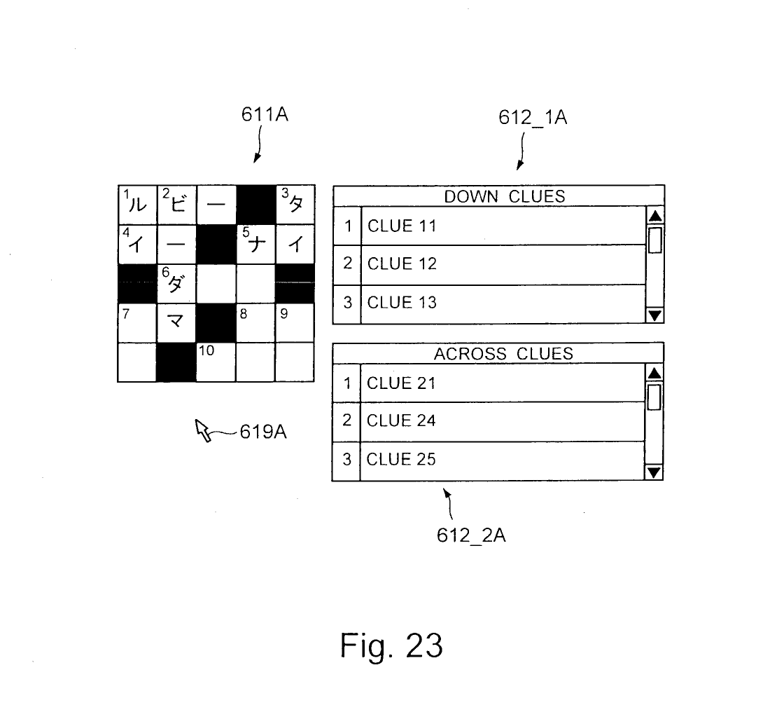

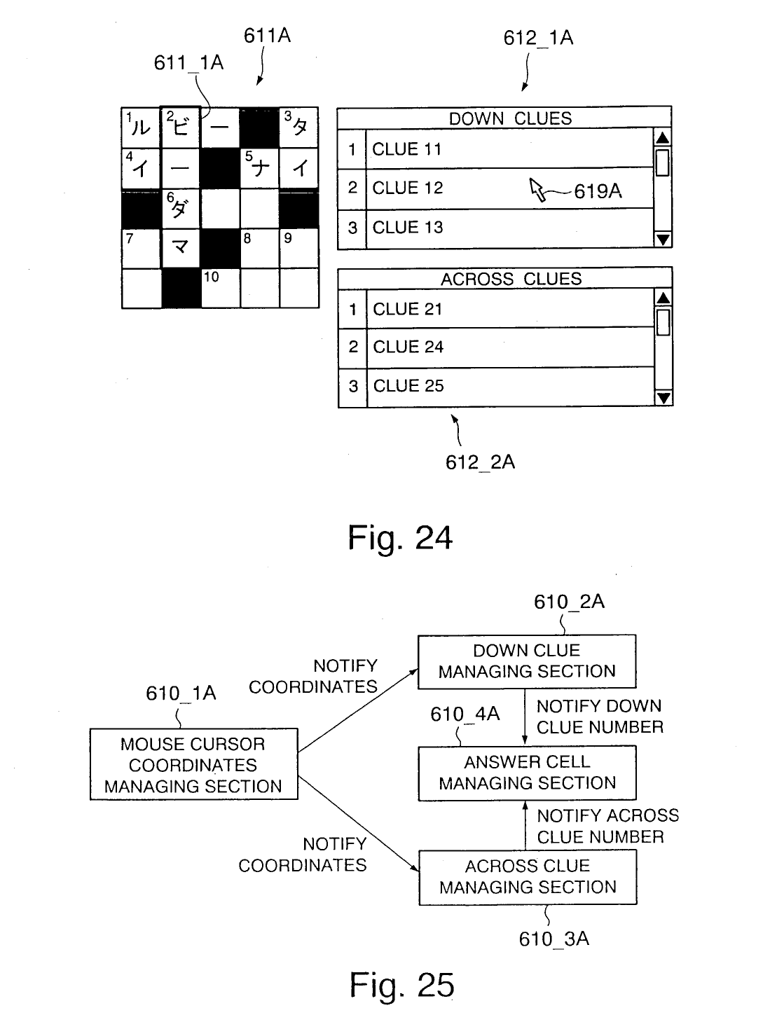

FIGS. 23 and 24 each show a panel on a display screen in one embodiment of the first crossword puzzle playing apparatus according to the present invention. FIG. 23 shows the panel before a player performs an operation and FIG. 24 shows the panel after the player performs the operation.

FIG. 23 shows an answer entry matrix 611A, a down clue list area 612_1A, and an across clue list area 612_2A, which correspond to a clue list area of the present invention, and a mouse cursor 619A. These elements are displayed on the display screen 102a of the image display unit 102 of the PC 100 shown in FIG. 1.

The mouse 104 shown in FIG. 1 is operated to place the mouse cursor 619A on “Clue 12”, which is the second clue in the “down” clue list area 612_1A shown in FIG. 24. This operation corresponds to a function of the point specifying section 620A in the crossword puzzle playing apparatus 600A in FIG. 4. Then, an answer entry range 611_1A in the answer entry matrix 611A shown in FIG. 24 in which the answer corresponding to clue 12 is to be placed (or has been placed) is highlighted with a red frame.

While a red frame is used in this example, any other types of highlighting may be used.

In this way, the player places mouse cursor 619A on a particular clue to highlight the answer entry range corresponding to that clue and enters answers in cells in the answer entry matrix 611A by operating the keyboard 103 in FIG. 1 and other devices. This operation corresponds to a function of the answer entering section 630A in the crossword puzzle playing apparatus 600A in FIG. 4.

FIG. 25 shows a module configuration of the crossword puzzle playing apparatus of the present embodiment. The configuration of sections shown corresponds to the internal configuration of the display section 610A in the crossword puzzle playing apparatus 600A shown in FIG. 4.

Shown in FIG. 25 are a mouse cursor coordinates managing section 610_1A, a “down” clue managing section 610_2A, an across clue managing section 6103A, and an answer cell managing section 610_4A.

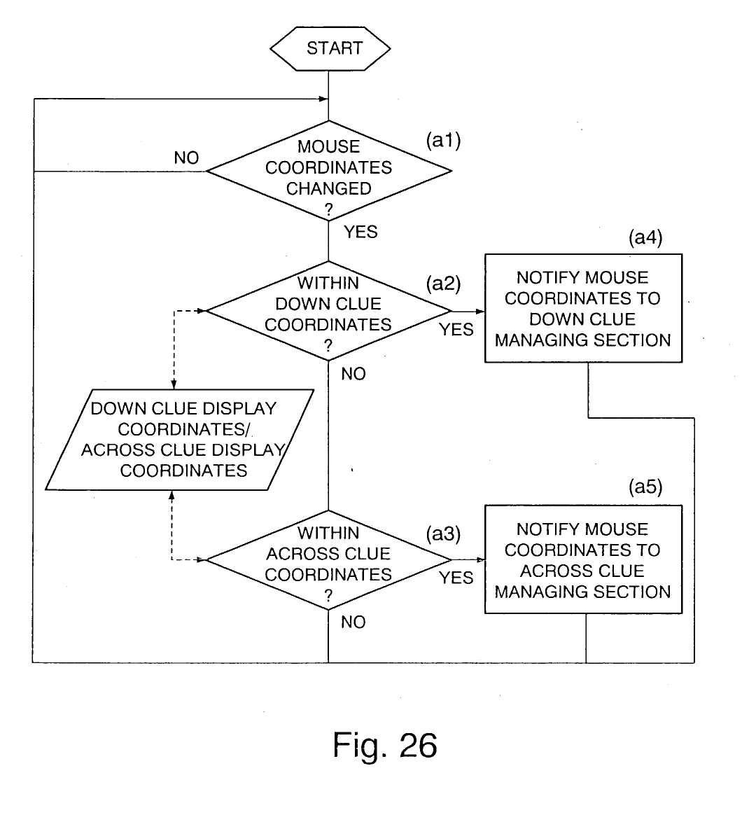

FIG. 26 shows a flowchart of a process performed by the mouse cursor managing section 610_1A in FIG. 25.

It is monitored whether the mouse coordinates are changed (step al). If the mouse coordinates (the coordinates of the mouse cursor) is changed, down clue display coordinates and across clue display coordinates are referred to determine whether or not the changed mouse coordinates are within the range of the down clue display coordinates (step a2) and whether or not they are within the range of the across clue display coordinates (step a3). If the mouse coordinates are within the range of the down clue display coordinates, the mouse coordinates are notified to the down clue managing section (step a4). If the mouse coordinates are within the range of the across clue display coordinates, the mouse coordinates are notified to the across clue managing section (step a5).

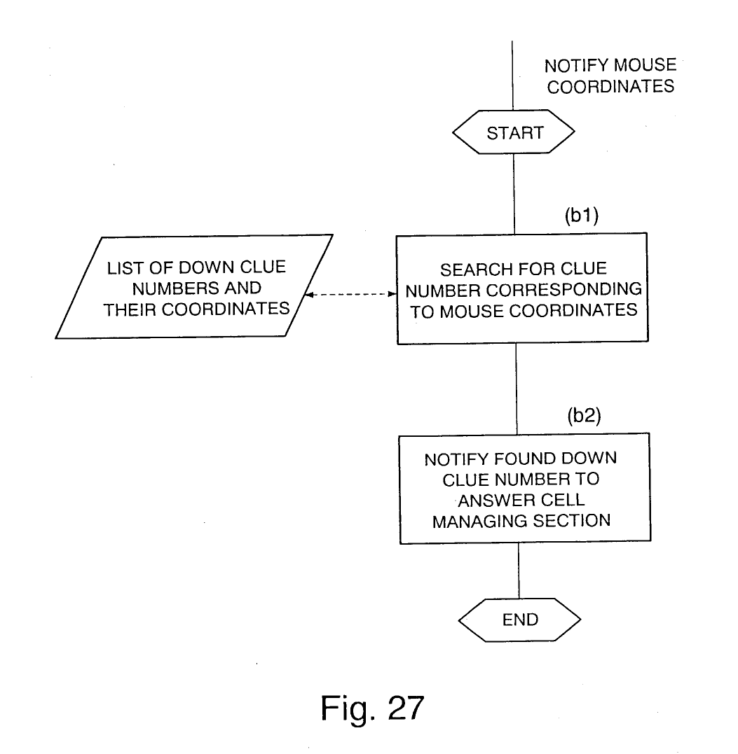

FIG. 27 shows a flowchart of a process performed by the down clue managing section 610_2A shown in FIG. 25.

When receiving indication of mouse coordinates from the mouse cursor managing section 610_1A, the down clue managing section 610_2A searches a list of down clue numbers and the display coordinates of clues associated with the clue numbers for a clue number corresponding to the mouse coordinates (step b1) and indicates a found down clue number to the answer cell managing section (step b2).

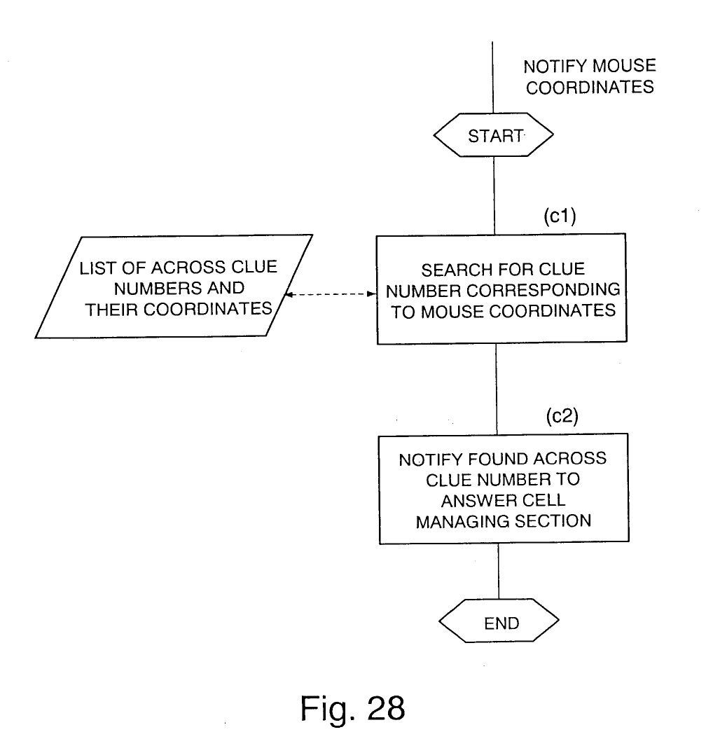

FIG. 28 shows a flowchart of a process performed by the across clue managing section 610_3A shown in FIG. 25.

When receiving notification of mouse coordinates from the mouse cursor managing section 610_1A, the across clue managing section 610_3A searches a list of across clue numbers and the display coordinates of clues associated with the clue numbers for a clue number corresponding to the mouse coordinates (step c1) and indicates a found across clue number to the answer cell managing section (step c2).

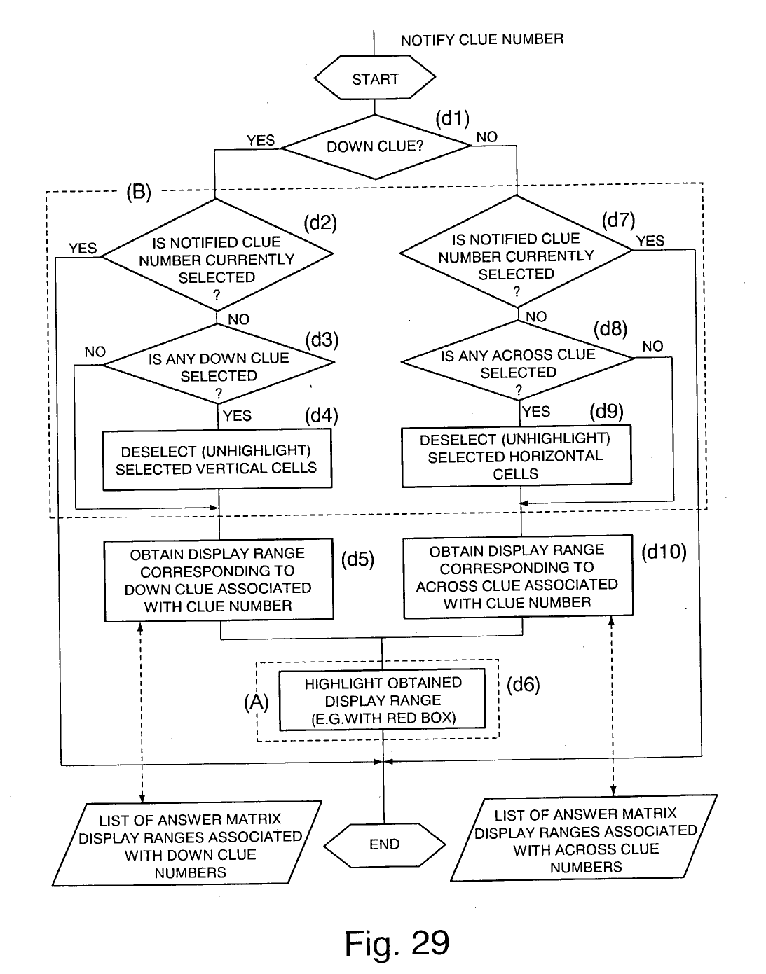

FIG. 29 shows a flowchart of a process performed by the answer cell managing section 610_4A. Dashed boxes (A) and (B) in FIG. 29 are provided for convenience of later explanation.

When receiving notification of a clue number from the down clue managing section 610_2A or the across clue managing section 610_3A, the answer cell managing section 610_4A determines whether the notified clue number is the number of a down clue or that of an across clue (step d1). If it is the number of a down clue, the process proceeds to step d2. On the other hand, if it is the number of an across clue, the process proceeds to step d7.

If it is determined at step d1 that the notified clue number is the number of a down clue, the process proceeds to step d2, where it is determined whether the notified clue number is currently selected. If it is selected, the process proceeds to END. On the other hand, if the notified clue number is currently not selected, the process proceeds step d3, where it is determined whether any of the vertical clues is selected. If any of the down clues is selected, a selected vertical answer cell or cells are deselected (highlight is cleared) (step d4). At step d5, a list of answer matrix display ranges associated with the down clue numbers is referred to in order to obtain the vertical answer matrix range that corresponds to the notified clue number. Then the process proceeds to step d6, where the obtained display range is enclosed in a red box or otherwise highlighted.

Likewise, if it is determined at step d1 that the notified clue number is the clue number of an across clue, the process proceeds to step 7, where it is determined whether the notified clue number is currently selected. If it is not selected, the process proceeds to step d8, where it is determined whether any of the across clues is selected. If any of the across clue is selected, a selected horizontal cell or cells are deselected (highlight is cleared) (step d9). At step d10, a list of answer matrix display ranges associated with the across clues are referred to in order to obtain the horizontal answer matrix range that corresponds to the notified clue number. Then the process proceeds to step d6, where the obtained display range is enclosed in a red box or otherwise highlighted.

A variation of the first crossword puzzle playing apparatus described with reference to FIGS. 23 through 29 will be described below.

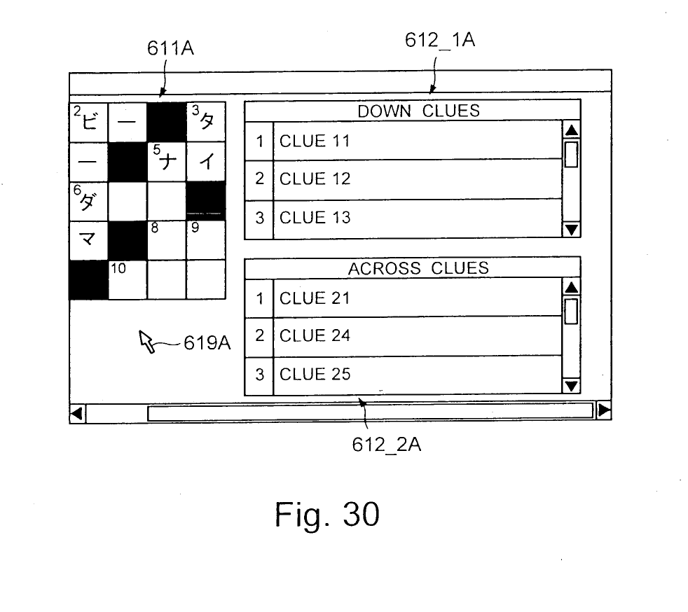

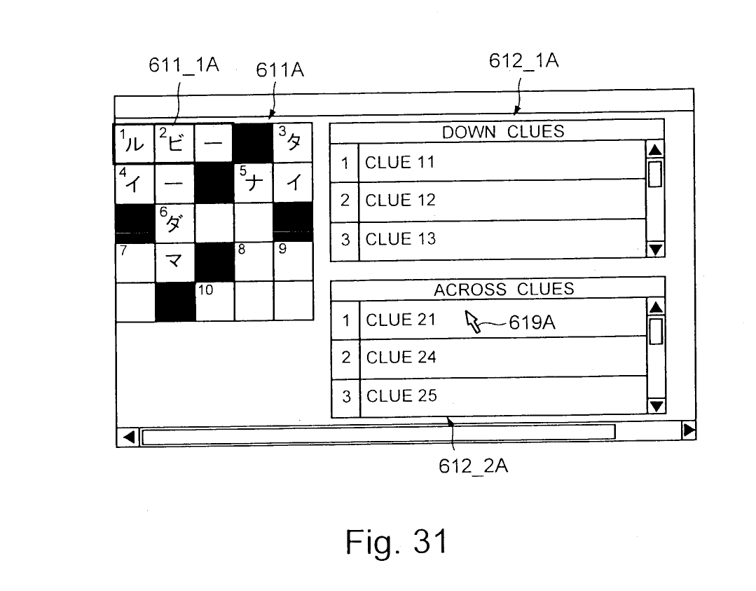

FIGS. 30 and 31 show a display on a display screen according to the variation. FIG. 30 shows a display before the player performs an operation and FIG. 31 shows a display after the player performs the operation.

As shown in FIG. 30, the entire panel is horizontally scrollable and each of the down clue list 612_1A and across clue list 612_2A is vertically scrollable.

A player operates the mouse 104 shown in FIG. 1 to place a mouse cursor 619A on “Clue 21” in the across clue list area 612_2A, for example, as shown in FIG. 31. Because the answer entry range that corresponds to Clue 21 is not displayed in the display screen as shown in FIG. 30, the panel is scrolled through to display the answer entry range 611_1A corresponding to clue 21, which is highlighted with a red box around it.

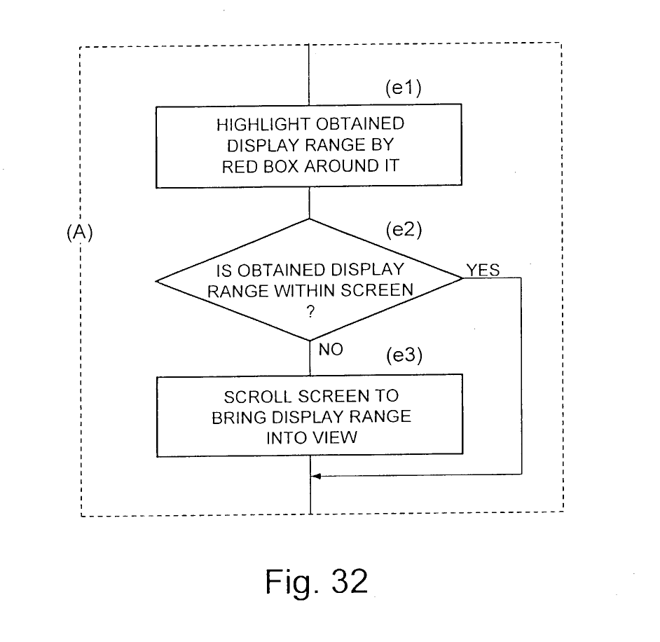

The process shown in FIGS. 25 through 28 of the embodiment shown in FIGS. 23 through 29 can be applied to this variation. Therefore drawings equivalent to these drawings and description thereof will be omitted. The flowchart in FIG. 29 is used as a flowchart for the present variation, with the portion within dashed box (A) in FIG. 29 being replaced with a partial flowchart shown in FIG. 32. The description of the flowchart in FIG. 29 will be omitted and only the replacing portion will be described.

FIG. 32 shows a flowchart, which replaces step d6 in FIG. 29.

In this process, a display range obtained is highlighted with, for example, a red box around it (step e1), then it is determined whether the obtained display range is within a display (step e2) and, if the display range is not displayed in the display screen, the display is scrolled through to bring the display range into the screen (step e3).

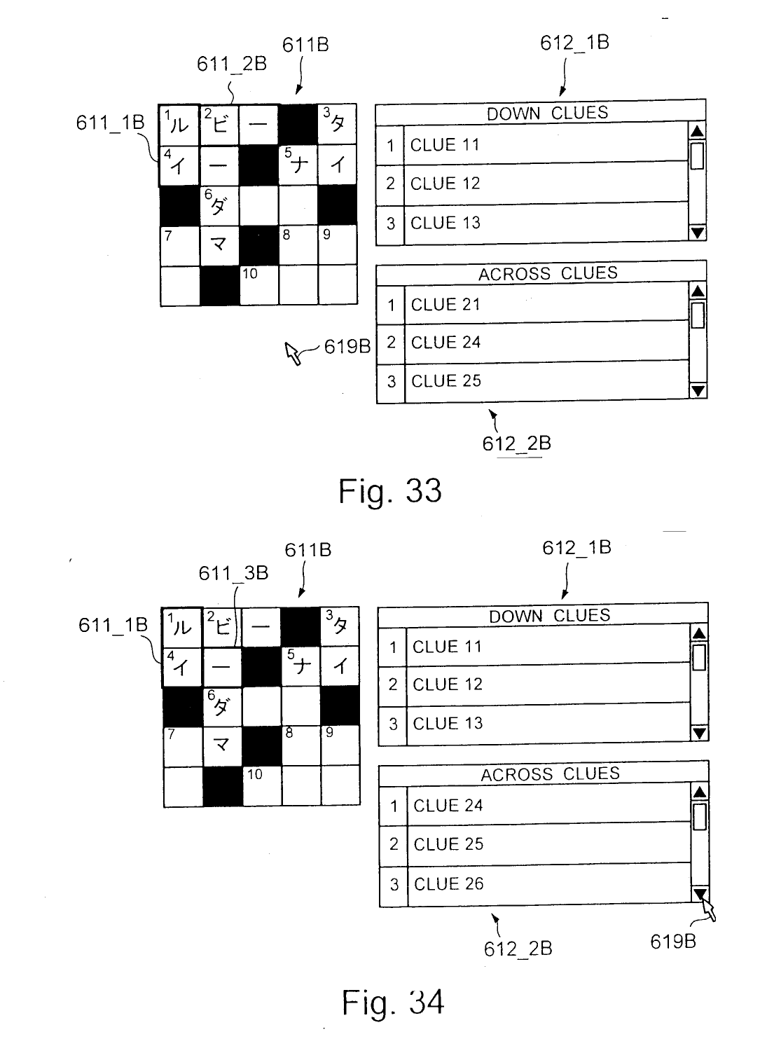

FIGS. 33 and 34 show a panel on the display screen of one embodiment of the second crossword puzzle playing apparatus according to the present invention. FIG. 33 shows the panel before a player operation and FIG. 34 shows the panel after the player operation.

Shown in FIG. 33 are an answer entry matrix 611B, and a down clue list area 612_1B and an across clue list area 612_2B which are the clue list areas of the present invention, and a mouse cursor 619B. In the answer entry matrix 611B, the answer entry range 611_1B that corresponds to “Clue 11” with clue number 1 in the down clue list area 612_1B and the answer entry range 611_2B that corresponds to “Clue 21” with clue number 1 in the across clue list area 612_2B are enclosed in red boxes.

In this way, the answer entry range 611_1B corresponding to the clue (having clue number 1 in FIG. 33) displayed at the top of the down clue list area 612_1B and the answer entry range 611_2B corresponding to the clue (having clue number 1 in FIG. 33) at the top of the across clue list area 612_2B are highlighted with the red boxes around them in the present embodiment.

When a player operates the mouse 104 shown in FIG. 1 to scroll through the across clue list area 612_2B to bring “clue 24” with clue number 4 to the top of the across clue list area 612_2B as shown in FIG. 34, the red box around the highlighted answer entry range 611_1B corresponding to “Clue 21” of the across clue with clue number 1 disappears and an answer entry range 611_3B corresponding to “clue 24” of the across clue with clue number 4 is highlighted with a red box around it.

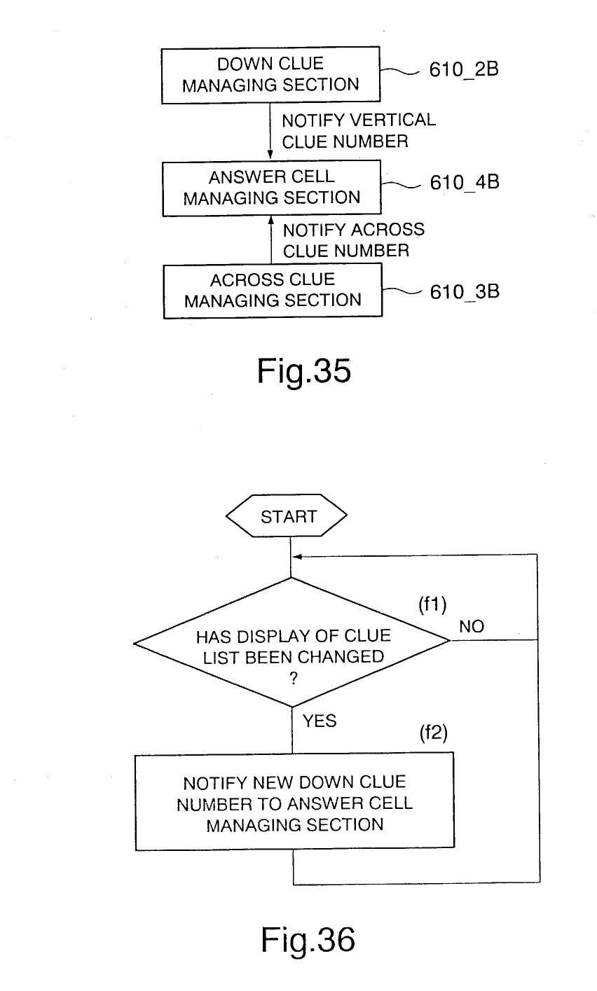

FIG. 35 shows a module configuration a crossword puzzle playing apparatus according to the present embodiment. The configuration of sections shown in FIG. 35 is equivalent to the internal configuration of the display section 610B of the crossword puzzle playing apparatus 600B shown in FIG. 6.

Shown in FIG. 35 are a down clue managing section 610_2B, an across clue managing section 610_3B, and an answer cell managing section 610_4B.

FIG. 36 shows a flowchart of a process performed by the down clue managing section 610_2B in FIG. 35.

It is monitored whether the display of the clue list in the down clue list area has been changed (step f1). If it has been changed, a new down clue number is notified to the answer cell managing section 611_4B (step f2).

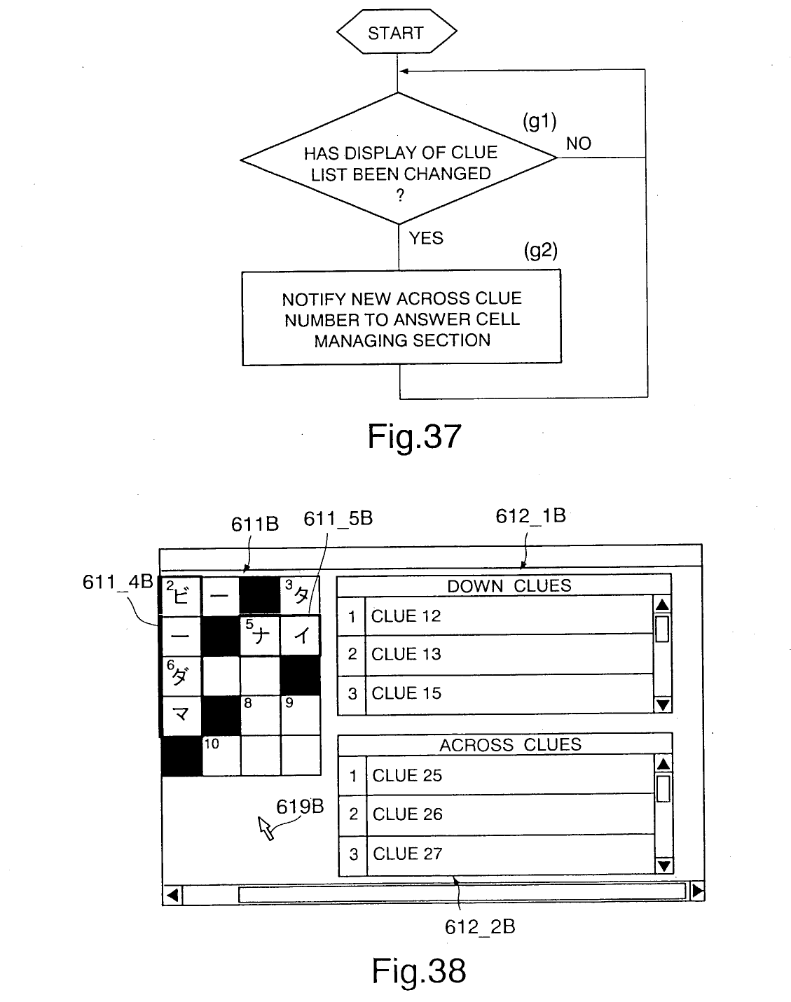

FIG. 37 shows a flowchart of a process performed by the across clue managing section 610_3B in FIG. 35.

In this process, it is monitored whether the display of the clue list in the across clue list area has been changed (step g1). If it has been changed, a new across clue number is notified to the answer cell managing section 610_4B (step g2).

The process performed by the answer cell managing section 610_4B when receiving the notification of the clue number from the down clue managing section 610_2B or across clue managing section 610_3B is the same the one shown in flowchart in FIG. 29 and therefore the description of which will be omitted.

A variation of the second crossword puzzle playing apparatus described with reference to FIGS. 33 through 37 will be described below.

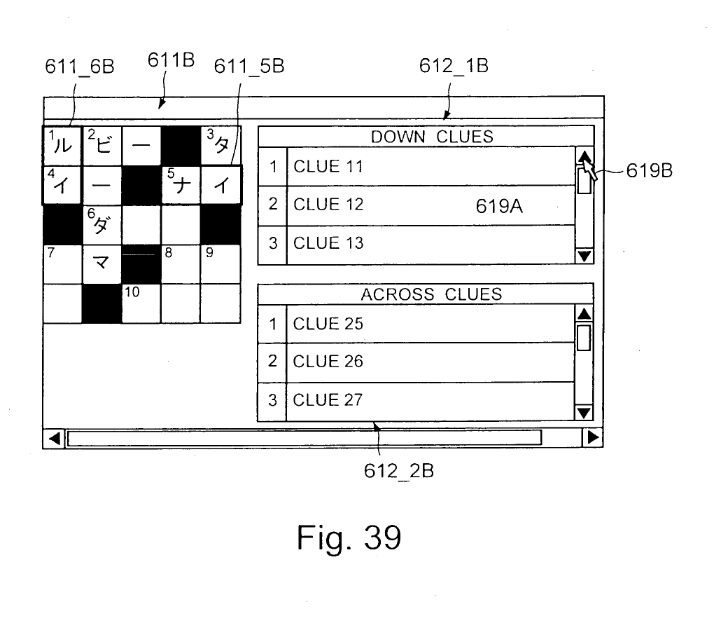

FIGS. 38 and 39 show a panel of a display screen according to the variation. FIG. 38 shows the panel before an operation by a player and FIG. 39 shows the panel after the player operation.

As shown in FIG. 38, the entire panel is horizontally scrollable and each of a down clue list area 612_1B and an across clue list area 612_2B is vertically scrollable.

In this panel, the answer range 611_4B corresponding to “clue 12” with clue number 2, which is displayed at the top of the down clue list area 612_1B, and the answer range 611_5B corresponding to “clue 25” with clue number 5, which is displayed at the top of the across clue list area 612_2B, are highlighted with red boxes around them.

An player operates the mouse 104 shown in FIG. 1 to scroll through the down clue list area 612_1B to bring “Clue 11” with clue number 1 to the top of the down clue list area 612_1B, for example. In response to this, the answer entry range 611_4B corresponding to the down clue with number 2 which is highlighted with the red box around it, of the answer entry matrix 611B is unhighlighted and the answer entry range 611_6B that corresponds to Clue 11 of the down clue with clue number 1, which was outside the display, appears on the screen with a red box around it.

FIGS. 35 to 37 of the embodiment described with reference to FIGS. 33 to 37 can also be applied to the present variation. Therefore redundant description thereof will be omitted. The flowchart in FIG. 29, with the section within dashed box (A) being replaced with the partial flowchart in FIG. 32, can be used for describing an operation flow of the answer cell managing section 610_4B shown in FIG. 35 and therefore redundant description of which will be omitted.

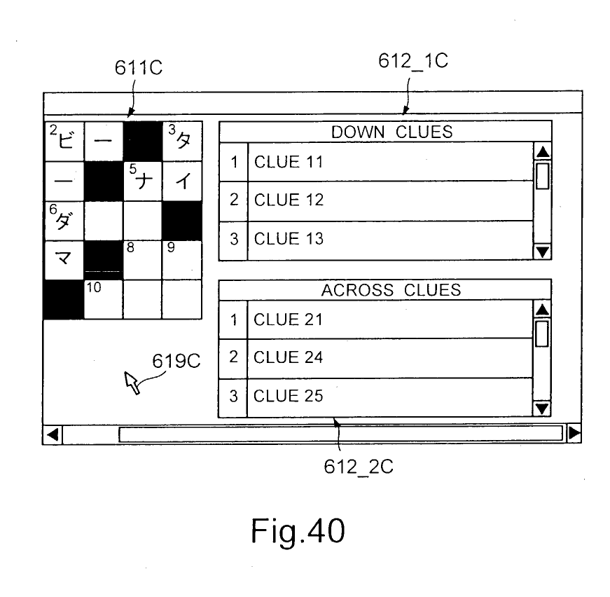

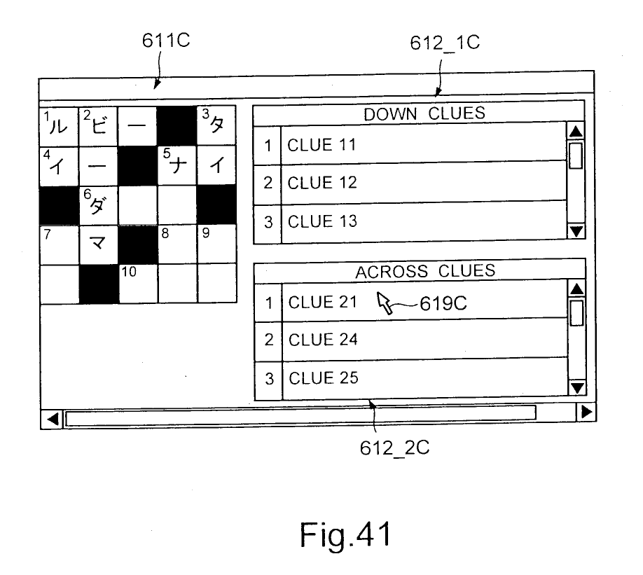

FIGS. 40 and 41 show a panel on the display screen of one embodiment of the third crossword puzzle playing apparatus according to the present invention. FIG. 40 shows the panel before an operation by a player and FIG. 41 shows the panel after the player operation.

Shown in FIG. 40 are an answer entry matrix 611C and, a down clue list area 612_1C and an across clue list area 612_2C, which are the clue list areas of the present invention, and a mouse cursor 619C. The entire panel including the answer entry matrix 611C, down clue list area 612_1C, and across clue list area 612_2C is horizontally scrollable. Each of the down clue list area 612_1C and across clue list area 612_2C is vertically scrollable.

A player operates the mouse 104 shown in FIG. 1 to place the mouse cursor 619C on “Clue 21” with clue number 1 in the across clue list area, as shown in FIG. 41. Because the answer entry range with down clue number 1 in the answer entry matrix 511C that corresponds to Clue 21 is initially outside the panel as shown in FIG. 40, the answer entry matrix 611C is scrolled to bring the answer entry range into the display screen as shown in FIG. 41.

The module configuration of a display section of the present embodiment is the same as the one shown in FIG. 25. A process performed by a mouse cursor coordinates managing section 610_1A in the module configuration is the same as the one shown in FIG. 26. Processes performed by a down clue managing section 610_2A and an across clue managing section 610_3A are the same as those shown in FIGS. 26 and 27. Therefore description of these processes will be omitted.

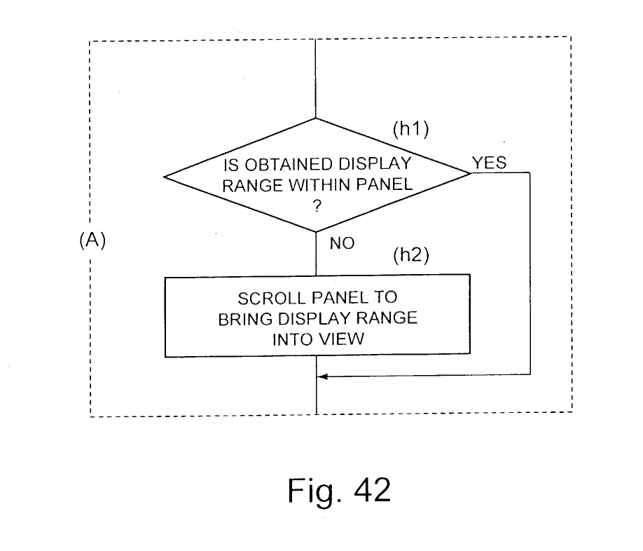

The flowchart in FIG. 29 is used as a flowchart for describing a process performed by an answer cell managing section 610_4A in the present embodiment, which is shown in FIG. 25, with the partial flowchart in box (B) in FIG. 29 being eliminated and the section in box (A) being replaced with a partial flowchart shown in FIG. 42. Because the flowchart in FIG. 29 has been described earlier, only the partial flowchart shown in FIG. 42 will be described below.

FIG. 42 shows a partial flowchart that replaces the section in box (A) in the flowchart in FIG. 29.

In this process, it is determined whether the obtained display range is included in the display screen (step h1). If it is outside the display panel, the display panel is scrolled to bring the display range into the panel (step h2).

A variation of the third crossword puzzle playing apparatus described with reference to FIGS. 40 through 42 will be described below.

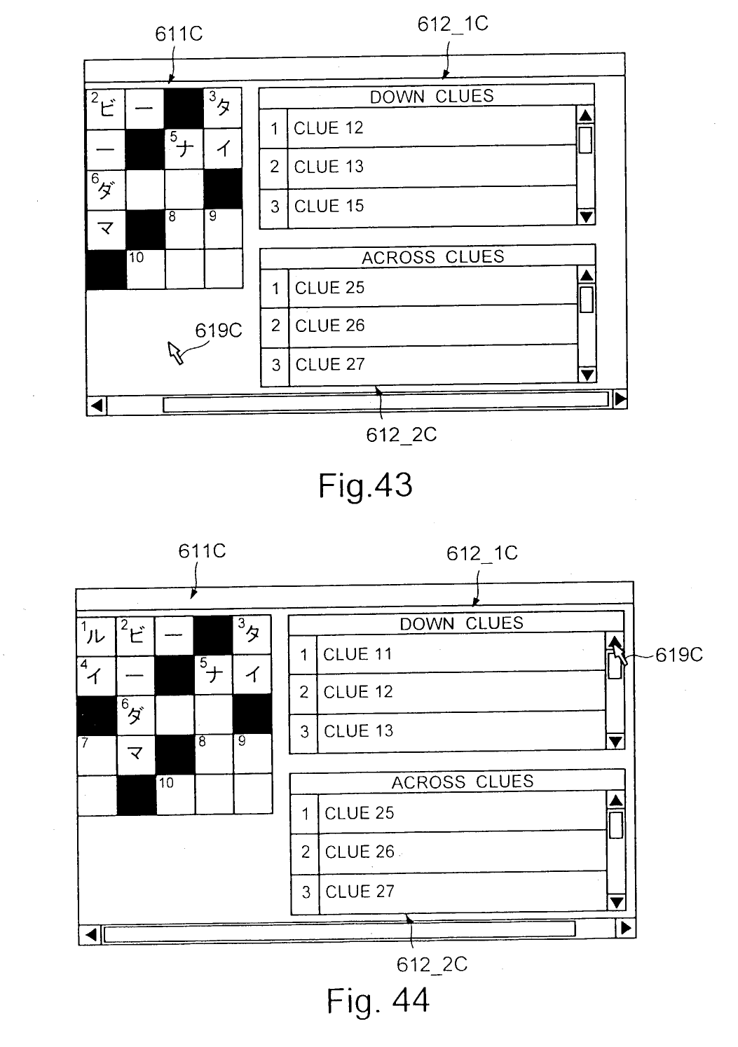

FIGS. 43 and 44 show a display mode of the display screen of the variation. FIG. 43 shows the display mode before an operation performed by a player and FIG. 44 shows the display mode after the player operation.

In the present variation, a display panel is scrolled so that answer ranges that correspond to the clue at the top of the down clue list area 612_1C (“clue 12” with clue number 2, in this example) and the clue at the top of the across clue list area 612_2C (“clue 25” with clue number 5, in this example), always appear in the answer matrix 611C. However, If the answer range corresponding to the clue at the top of the down clue list area 612_1C and the answer range corresponding to the clue at the top of the across clue list area 612_C cannot be displayed on the display panel at a time, the panel is scrolled so as to bring at least the answer range corresponding to the clue at the top of the down clue list area 612_1C, for example, into the panel.

A player operates the mouse 104 shown in FIG. 1 to scroll the down clue list area 612_1C in the display panel shown in FIG. 43 to bring “Clue 11” with clue number 1 to the top of the down clue list area 612_1C as shown in FIG. 44. Because the answer area that corresponds to “Clue 11” is not displayed in the display panel in FIG. 43, the panel scrolls to the answer range corresponding to “Clue 11.”

The module configuration shown in FIG. 35 can be used as a configuration of the display section of the present variation. The flowcharts in FIGS. 36 and 37 can be used as flowcharts of processes performed by the down clue managing section 610_2B and across clue managing section 610_3B shown in FIG. 35, respectively, in the present variation. As with the embodiment described with reference to FIGS. 40 through 42, the flowchart shown in FIG. 29 can be used as a flowchart of a process performed by the answer cell managing section 610_4B shown in FIG. 35, with the section in box (B) in FIG. 29 being eliminated and the section in box (A) in FIG. 29 being replaced with the partial flowchart shown in FIG. 42. These flowcharts also have described above, therefore the description of them will be omitted.

A specific embodiment of the fourth crossword puzzle playing apparatus will be described below.

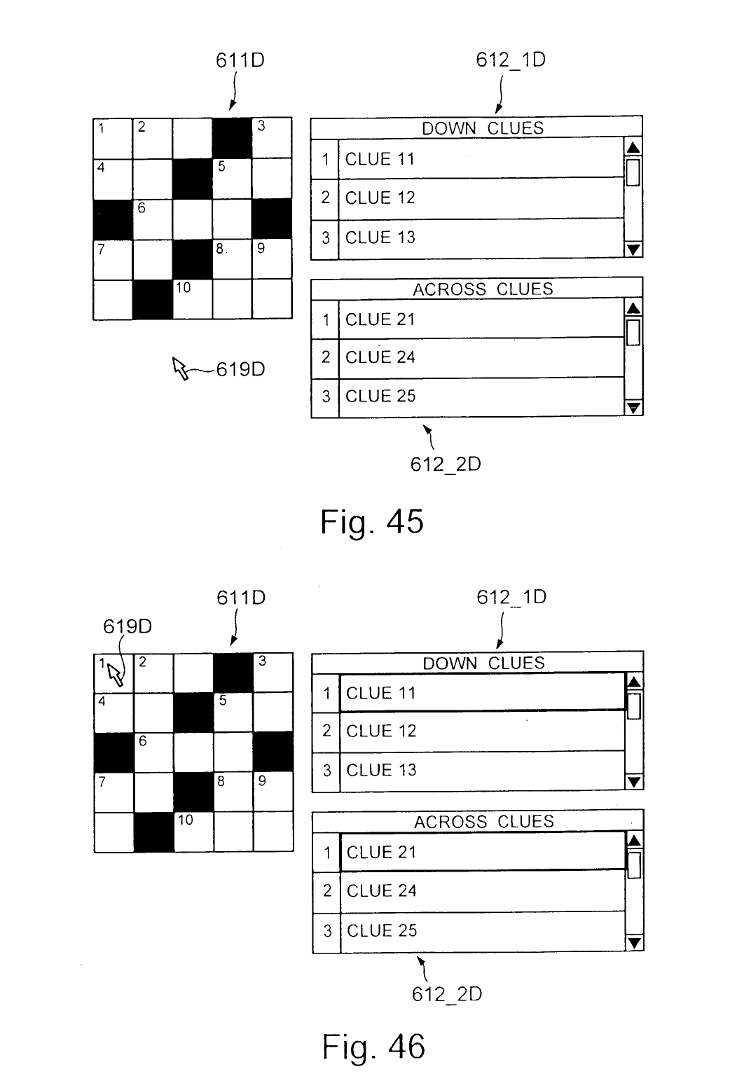

FIGS. 45 and 46 show a display mode of the display screen of one embodiment of the fourth crossword puzzle playing apparatus. FIG. 45 shows the panel before an operation performed by a player and FIG. 46 shows the panel after the player operation.

Shown in FIG. 45 are an answer entry matrix 611D and, a down clue list area 612_1D and an across clue list area 612_2D, which are referred to as the clue list area of the present invention, and a mouse cursor 619D. These elements are displayed on the display screen 102 of the image display apparatus 102a of the PC 100 shown in FIG. 1.

A player operates the mouse 104 shown in FIG. 1 to place the mouse cursor 619D in a cell labeled with “1”, for example, in the answer matrix 611D as shown in FIG. 46. This operation corresponds to an effect of the point specifying section 620D in the crossword puzzle playing apparatus 600D shown in FIG. 10.

The cell labeled with “1” and pointed at by the mouse pointer 619D is included in both of an answer entry range in which an answer to “Clue 11” with clue number 1 in the down clue list area is to be placed and another answer entry range in which an answer to “Clue 21” with clue number 1 in the across clue list area is to be placed.

When the mouse cursor 610D is placed on the cell with number 1, “Clue 11” with clue number 1 in the down clue list area 612_1D and “Clue 21” with clue number 1 in the across clue list area 612_2D are highlighted with read boxes around them.

In this way, when the mouse cursor 619D is placed in a cell labeled with a number in the answer entry matrix 611D, clues to answers to be placed in the answer entry ranges including that cell are highlighted with red boxes.

The player places the mouse cursor 619D in particular cells to highlight clues and uses devices such as the keyboard 103 shown in FIG. 1 to enter answers to the cells in the answer entry matrix 611D. This corresponds to an effect of the answering section 630D of the crossword puzzle playing apparatus 600D in FIG. 10.

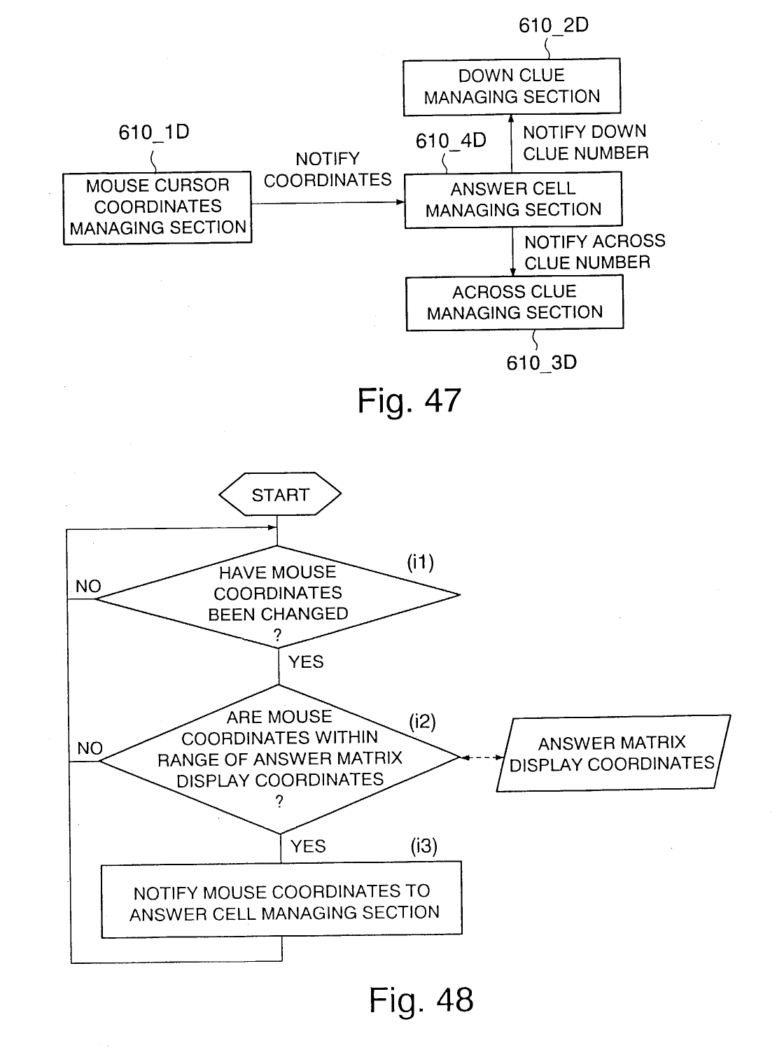

FIG. 47 shows a module configuration of the crossword puzzle playing apparatus of the present embodiment. The module configuration shown here corresponds to the internal configuration of the display section 610D of the crossword puzzle playing apparatus 600D shown in FIG. 10.

FIG. 47 shows a mouse cursor managing section 610_1D, a down clue managing section 610_2D, an across clue managing section 610_3D and answer cell managing section 610_4D.

FIG. 48 shows a flowchart of a process performed by the mouse cursor coordinates managing section 610_1D shown in FIG. 47.

It is monitored whether the mouse coordinates (the coordinates of the mouse cursor) have been changed (step i1). When the mouse coordinates have been changed, the answer matrix display coordinates are referred to in order to determine whether the changed mouse coordinates are within the range of answer matrix display coordinates. If they are within the answer matrix display coordinates, the mouse coordinates are notified to the answer cell managing section.

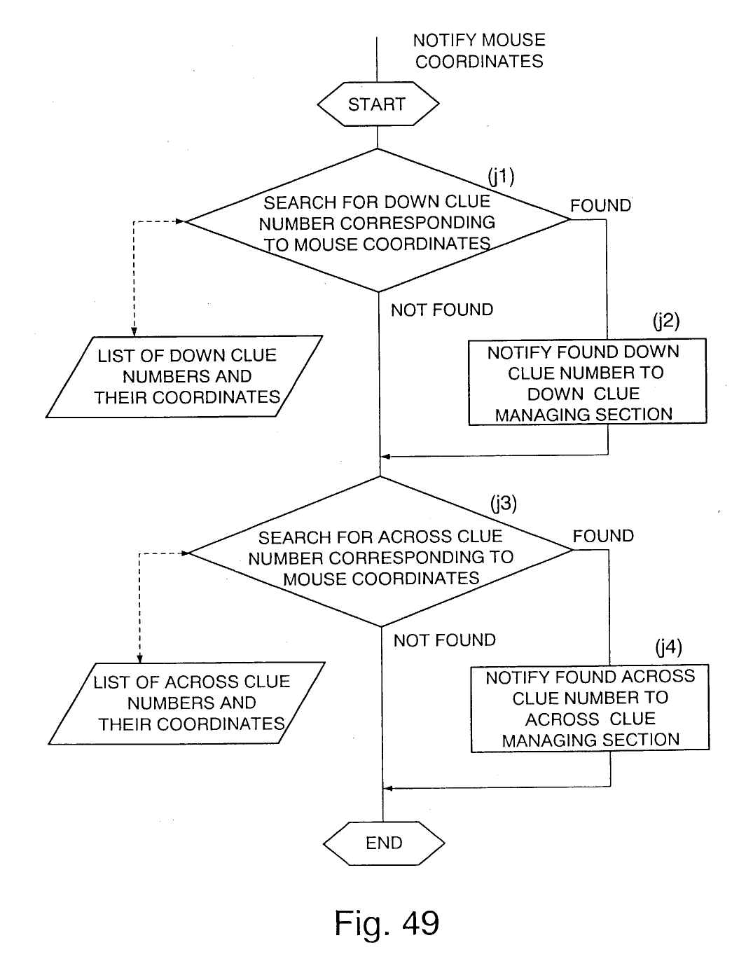

FIG. 49 shows a flowchart of a process performed by the answer cell managing section 610_4D.

The answer cell managing section 610_4D receives the notification of the mouse coordinates from the mouse cursor coordinate managing section 610_1D and searches a list of down clue numbers and their coordinates for the down clue number that corresponds to the mouse coordinates (step j1). If the answer cell managing section 610_4d find the down clue number corresponding to the mouse coordinates, it provides the found down clue number to the down clue managing section 610_2D (step j2). Also, it searches a list of across clue numbers and their coordinates for the across clue number that corresponds to the mouse coordinates based on the notified mouse coordinates (step j3). If it finds the across clue number corresponding to the mouse coordinates, it notifies it to the across clue managing section 610_3D (step j4).

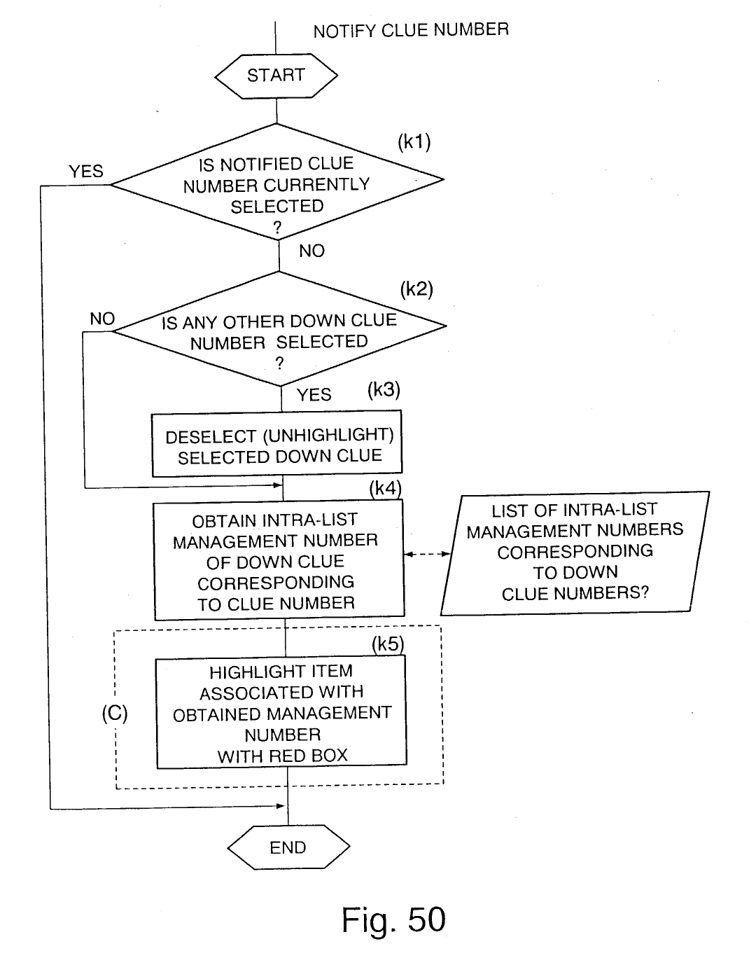

FIG. 50 shows a flowchart of a process performed by the down clue managing section 610_2D.

When receiving notification of a clue number, the down clue managing section 610_2D determines whether the notified clue number is currently selected (step k1). If the notified clue number is selected, it exits this routine. If, on the other hand, the notified clue number is not selected, the down clue managing section 610_2D determines whether any other down clue is selected (step k2). If a down clue is selected, it deselects (unhighlights) that down clue (step k3).

The down clue managing section 610_2D refers to a list of intra-list management numbers associated with the down clue numbers to obtain the intra-list management number of the clue that corresponds to the clue number (step k4) and highlights the item associated with the obtained management number with a red box around it, for example (step k5).

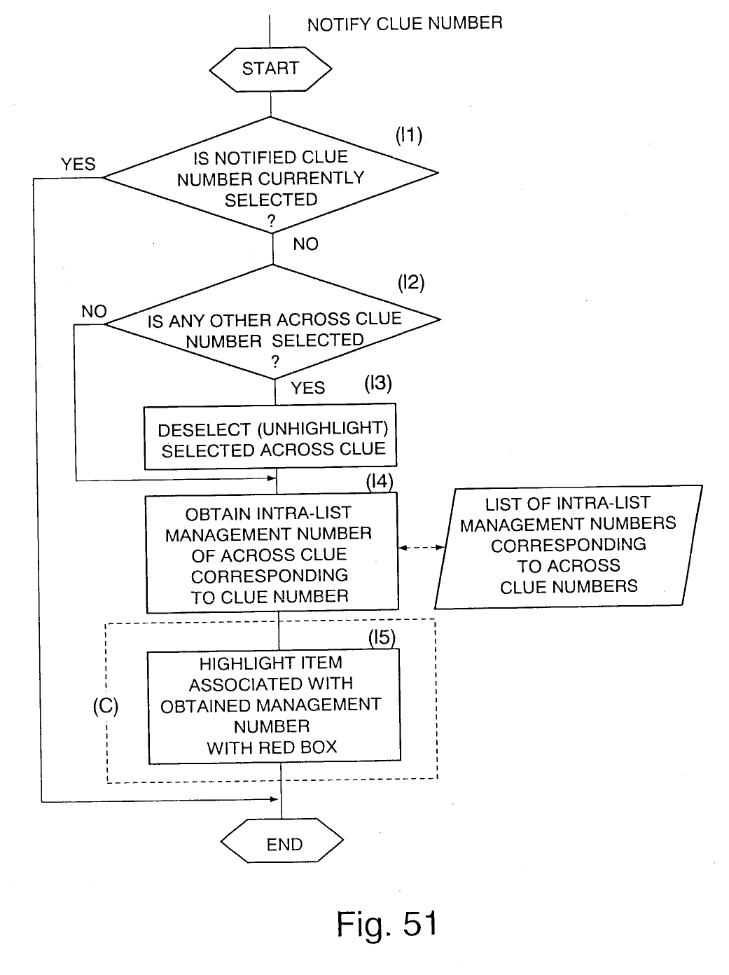

FIG. 51 shows a flowchart performed by the across clue managing section 610_3D.

When receiving notification of a clue number, the across clue managing section 610_3D determines whether the notified clue number is currently selected (step 11). If the notified clue number is selected, the across clue managing section 610_3D exits the routine. If, on the other hand, the notified clue number is not selected, it determines whether any other across clue is selected (step 12). If an across clue is selected, it deselects (unhighlights) that across clue (step 13). It refers to a list of intra-list management numbers associated with the across clue numbers to obtain the intra-list management number of the across clue that corresponds to the clue number (step 14) and highlights the item associated with the obtained management number with a red box, for example (step 15).

A variation of the fourth crossword puzzle playing apparatus described above with reference to FIGS. 45 through 51 will be described below.

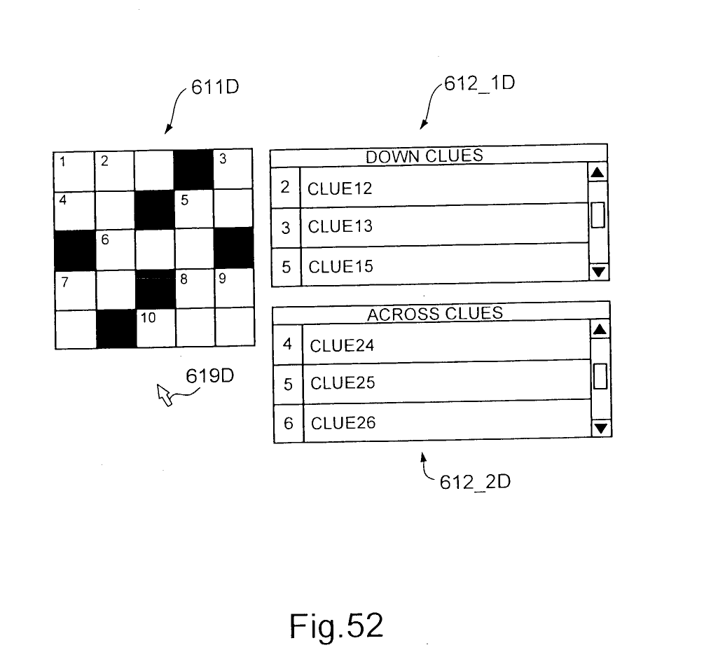

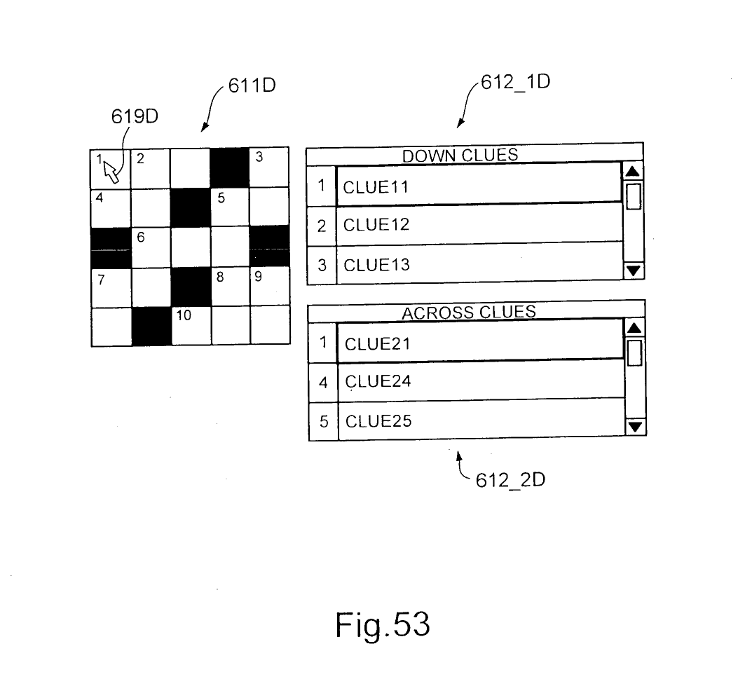

FIGS. 52 and 53 show a display mode of a display screen in the variation. FIG. 52 shows the display mode before an operation performed by a player and FIG. 53 shows the display mode after the player operation.

A down clue list area 612_1D and an across clue list area 612_2D are vertically scrollable.

In FIG. 52, the clues with clue number 1 are displayed neither the down clue list area 612_1D nor the across clue list area 612_2D.

In FIG. 52, in which the panel before operation is shown, a player operates the mouse 104 shown in FIG. 1 to place the mouse cursor 619D in a cell labeled with number 1 in the answer entry matrix 611D as shown in FIG. 53. The cell labeled with number 1 is included in both of the answer entry range that corresponds to a clue with down clue number 1 and the answer entry range that corresponds to a clue with across clue number 1.

When the player places the mouse cursor 619D in the cell labeled with number 1 as shown in FIG. 53, the down clue list area 612_1D is scrolled to bring Clue 11 which is the down clue with clue number 1, into view and the across clue list area 612_2D is also scrolled to bring Clue 21, which is the across clue with clue number 1, into view, corresponding to two answer entry ranges including the cell. In addition, “Clue 11” and “Clue 21” are highlighted with red boxes around them.

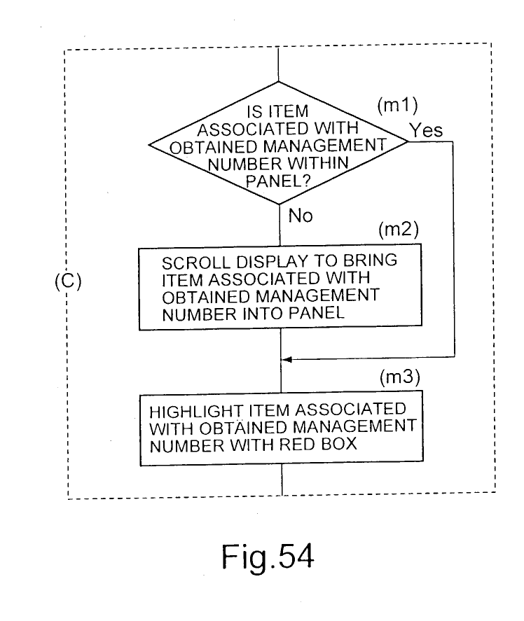

FIGS. 47 through 49 of the embodiment described with reference to FIGS. 45 through 51 can be applied to the present variation. Redundant description of these drawings will be omitted. The process flows in FIGS. 50 and 51 can be applied also to the down clue managing section 610_2D and across clue managing section 610_3D shown in FIG. 47 in the present variation, with the steps in box (C) in FIGS. 50 and 51 (step k5 in FIG. 50 and step 15 in FIG. 51) being replaced with a partial flowchart shown in FIG. 54.

Because FIGS. 50 and 51 have been described above, only a partial flow that replaces the sections in boxes C in FIGS. 50 and 51 will be described.

FIG. 54 shows the partial flowchart replacing the sections in box (C) in FIGS. 50 and 51.

In this section, it is determined whether an item associated with an obtained management number is within the panel (step m1). If it is outside the panel, the display is scrolled to bring the item associated with the obtained management number into the display (step m2) and the item with the obtained management number is highlighted with a red box, for example (step m3).

As a result, the display shown in FIG. 52 is changed to the display shown in FIG. 53.

Next, a specific embodiment of the fifth crossword puzzle playing apparatus will be described.

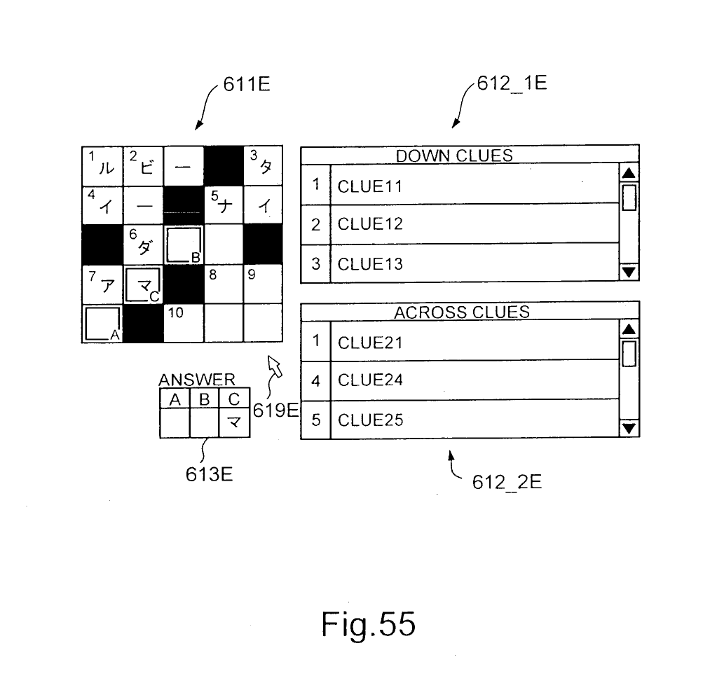

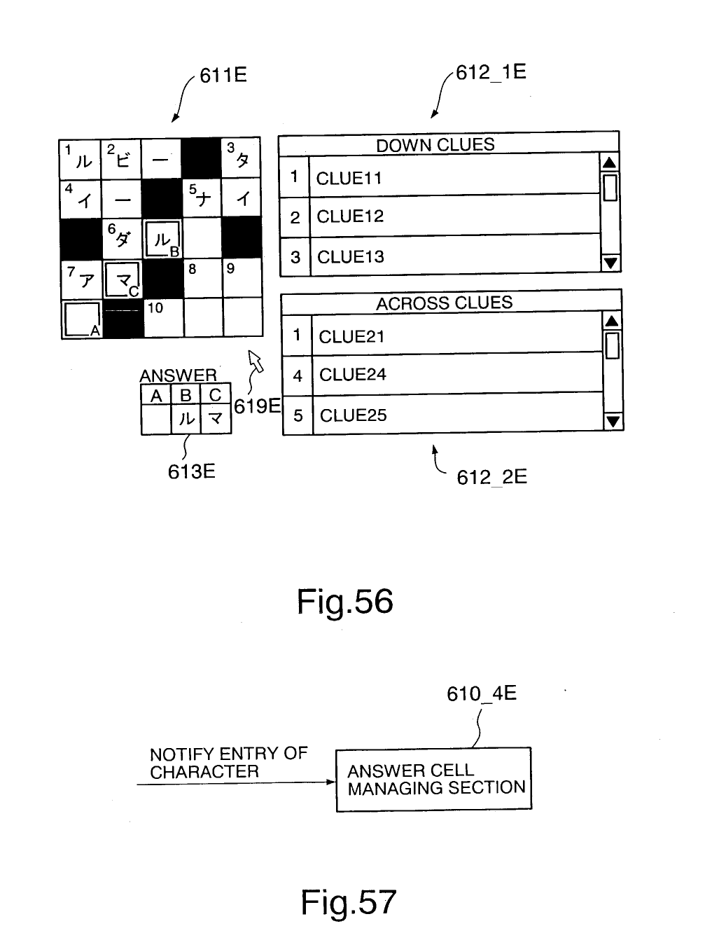

FIGS. 55 and 56 show a display mode in one embodiment of the fifth crossword puzzle playing apparatus. FIG. 55 shows the panel before an operation performed by a player and FIG. 56 shows the panel after the player operation.

Shown in FIG. 55 are an answer entry matrix 611E and, a down clue list area 612_1E and an across clue list area 612_2E, which are referred to as clue list areas of the present invention, a keyword display field area 613E, and a mouse cursor 619E.

In the answer entry matrix 611E, three cells labels with symbols A, B, and C are displayed in the answer entry matrix 611E. Letters entered in the three cells, when arranged in the order corresponding to the order of symbols A, B, and C, forms a keyword.

In the display shown in FIG. 55, an answer is placed in the answer entry range corresponding to a down clue with clue number 2. As a result, a character is placed in the cell labeled with C.

In the present embodiment, the answer entry matrix 611E, down clue list area 612_1E, and across clue list area 612_2E are displayed initially. However, the keyword display field 613E is displayed in addition to them in response to entry of a character in any of the three cells labeled with symbols A, B, and C in the answer entry matrix 611E. The same character as those that is placed in the cell in the answer entry matrix 611E appears in the corresponding cell in the keyword display field 613E.

When answers are entered in an answer entry range corresponding to across clue number 6 in the display panel shown in FIG. 55, a character placed in a cell labeled with symbol “B” as shown in FIG. 56 also appears in the corresponding cell in the keyword display field 613E.

FIG. 57 shows a module configuration of the crossword puzzle playing apparatus of the present embodiment. The module configuration shown here corresponds to the internal configuration of the display section 610E of the crossword puzzle playing apparatus 600E shown in FIG. 12.

An answer cell managing section 610_4E is shown in FIG. 57.

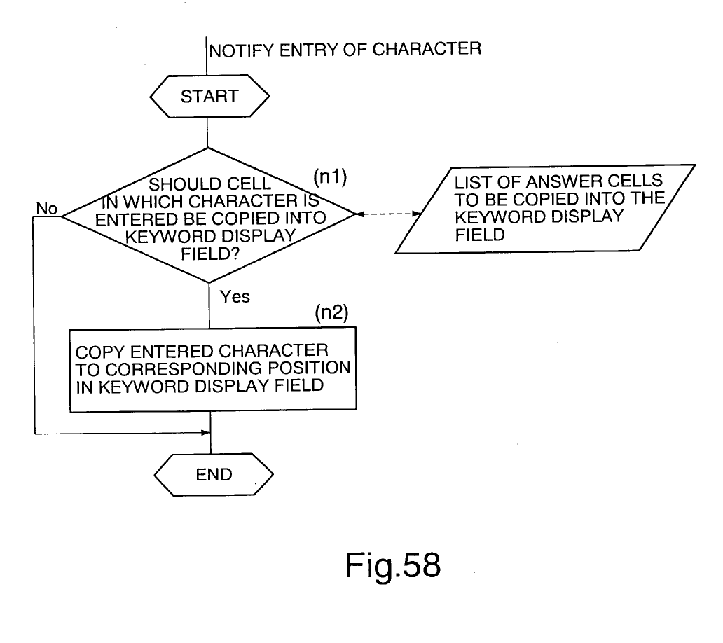

FIG. 58 shows a flowchart of a process performed by the answer cell managing section 610_4E shown in FIG. 57.

When receiving notification of entry of a character, the answer cell managing section 610_4E refers to a list of answer cells to be copied into the keyword display field to determine whether the cell in which the character is entered should be displayed in the keyword display field (step n1). If the cell should be displayed in the keyword display field, it copies the character to the corresponding position in the keyword display field (step n2).

A specific embodiment of the sixth crossword puzzle playing apparatus will be described below.

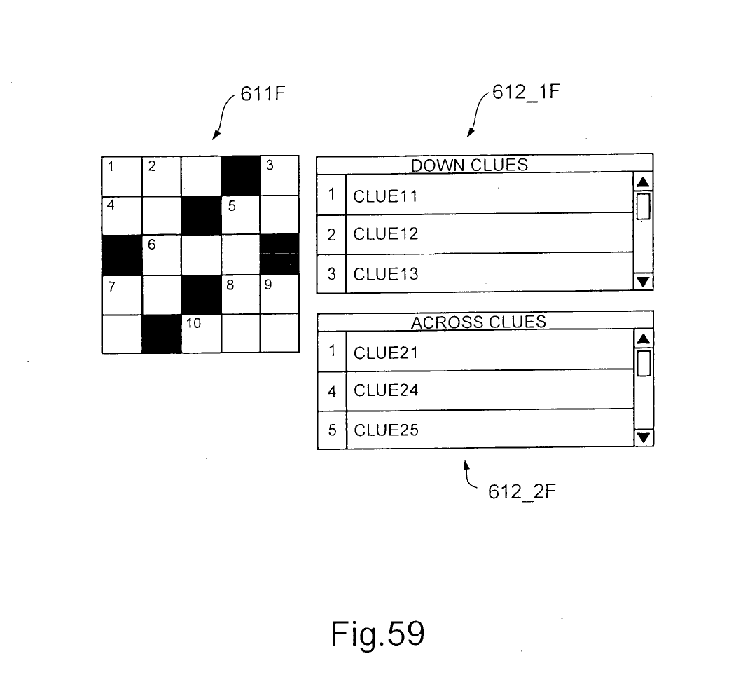

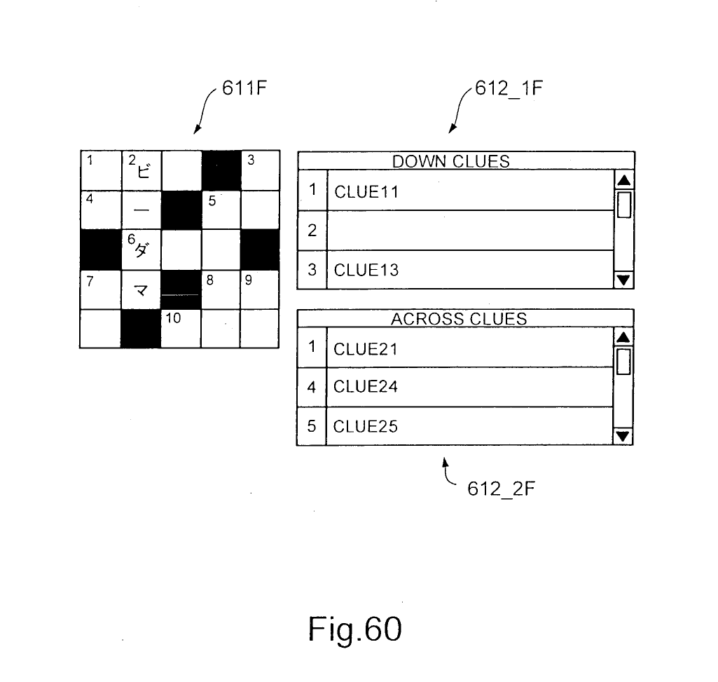

FIGS. 59 and 60 show a display mode in one embodiment of the sixth crossword puzzle playing apparatus. FIG. 59 shows the display mode before an operation performed by a player and FIG. 60 shows the display mode after the player operation.

FIG. 59 shows an answer entry matrix 611F, a down clue list area 612_1F and an across clue list area 612_2F, which are referred to as clue list areas of the present invention.

When an answer is entered in an answer entry range with down clue number 2, for example, in the display panel shown in FIG. 59, a deletion mark is displayed over a clue (“clue 12” with down clue number 2 in this example) to the entered answer as shown in the down clue list area 612_1F in FIG. 60 to indicate that it has been answered.

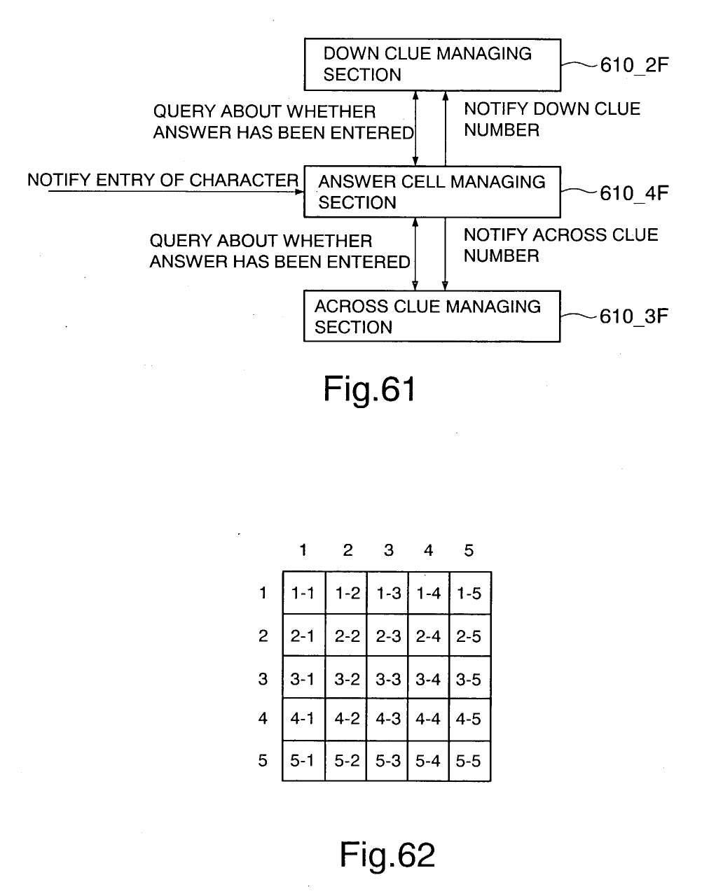

FIG. 61 shows a module configuration of the crossword puzzle playing apparatus of the present embodiment. The module configuration shown corresponds to the internal configuration of the display section 610F of the crossword puzzle playing apparatus 600F shown in FIG. 14.

Shown in FIG. 61 are an answer cell managing section 610_4F and, a down clue managing section 610 2F, and an across clue managing section 610_3F.

FIG. 62 shows a status managing array of an answer matrix.

As shown in FIG. 62, columns and rows are labeled with numbers associated with the answer cells. The cells are managed as array data to which management numbers, 1-1, 1-2, . . . , 5-4, 5-5, from the upper left to the lower right, are assigned. Data about whether each answer cell contains a character is stored in each array element. For example, if a cell contains a character, data “1” is stored in its corresponding array element. Otherwise, “0” is stored in the array element. For example, if the answer cell corresponding to array element 1-1 contains a character, “1” is stored in array element 1-1. Otherwise, “0” is stored in array element 1-1.

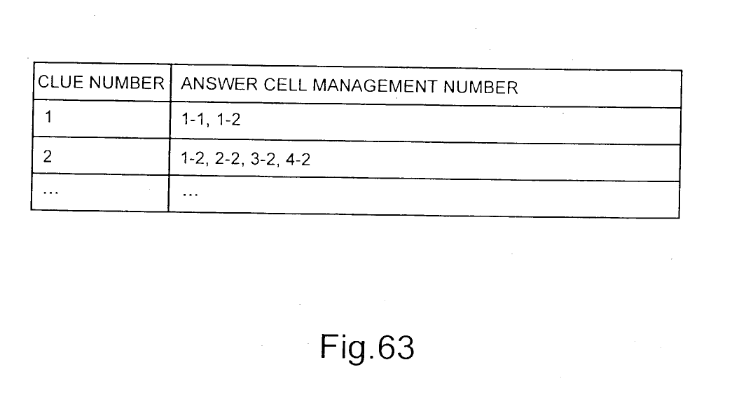

FIG. 63 shows a clue number and answer cell managing table.

Which answer cells having answer cell management numbers (1-1, 1-5, etc.) make up an answer entry range having a down clue number is managed as relational data as shown in FIG. 63. The across clues are also managed as table data similar to this.

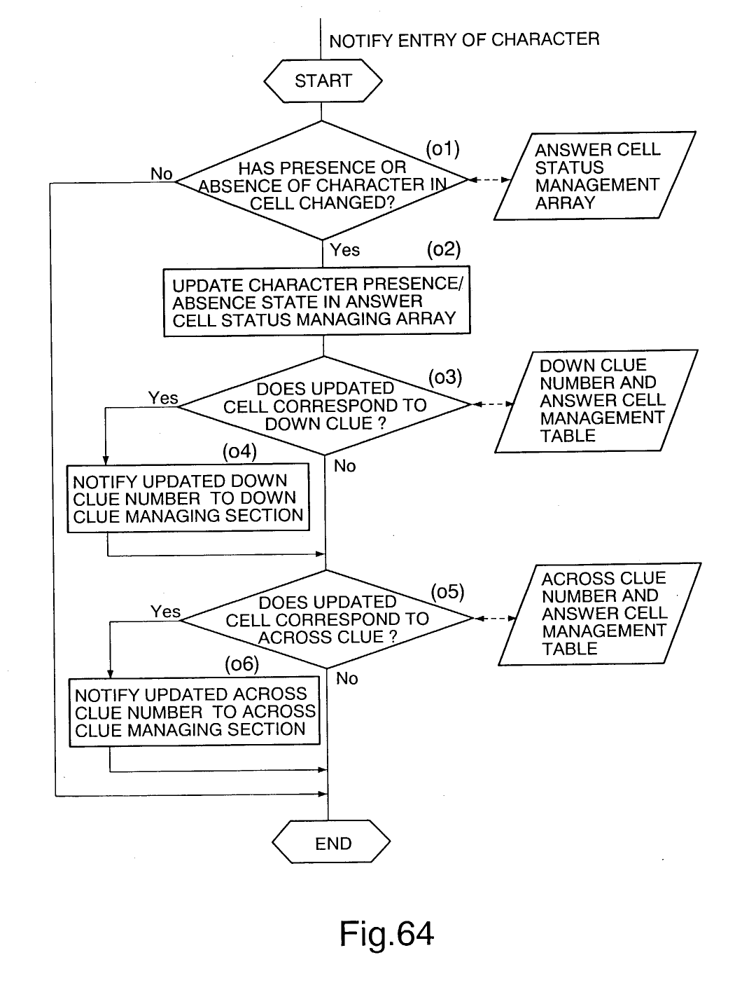

FIG. 64 shows a flowchart of a process which is performed by the answer cell managing section 610_4F shown in FIG. 61 when receiving notification that a character is entered in any of the answer cells in the answer entry matrix 611F (see FIG. 14).

When receiving notification of entry of a character in any of the answer cells in the answer entry matrix 611F, the answer cell managing section 610_4F determines whether the presence or absence of the character in the cell has been changed (step o1). If it has not been changed, it exits this routine.

On the other hand, if the presence or absence of the character in the cell has been changed, the presence/absence states of the answer cell status managing array in FIG. 62 is updated accordingly (step o2). Then, a down clue number and answer cell managing table shown in FIG. 63 is referred to in order to determine whether or not the changed cell corresponds to a down clue (step o3). If the changed cell corresponds to a down clue, the down clue number of updated cell is notified to the down clue managing section 610_2F shown in FIG. 61 (step o4). Also, an across clue number and answer cell managing table similar to the table shown in FIG. 63 is referred to in order to determine whether or not the changed cell corresponds to an across clue (step o5). If the updated cell corresponds to an across clue, the across clue number of the updated cell is notified to the across clue managing section 610_3F (step o6).

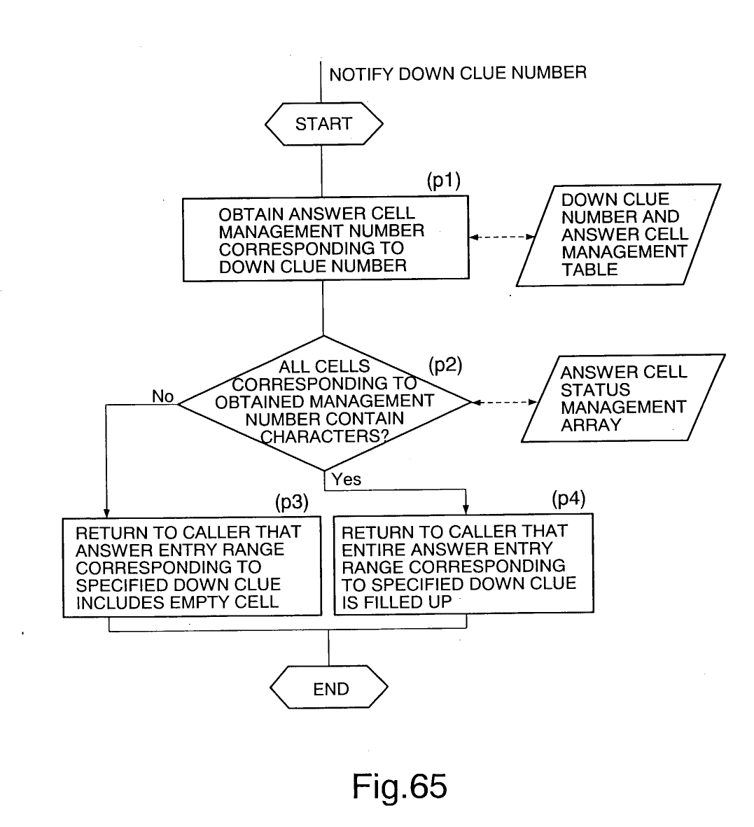

FIG. 65 shows a flowchart of a process performed by the answer cell managing section 610_4F shown in FIG. 61 when it receives a down clue number from the down clue managing section 610_2F.

The answer cell managing section 610_4F refers to the down clue number and answer cell managing table shown in FIG. 63 to obtain an answer cell management number associated with the notified down clue number (step p1) and refers to the answer cell status managing array shown in FIG. 62 to determine whether all the answer cells of the obtained management number contain characters (step p2). Suppose here that the reported down clue number is number 2. The answer cell managing section 610_4F determines whether all the four answer cells that make up the answer entry range corresponding to the down clue number contain characters. If any of the cells corresponding to the clue number contains no character, it returns to the caller (the down clue managing section 610_2F) notification that the answer entry range corresponding to the specified down clue includes an empty cell (step p3). On the other hand, if all the cells corresponding to the down clue number contain characters, it returns to the caller notification that the entire answer entry range is filled up (step p4).

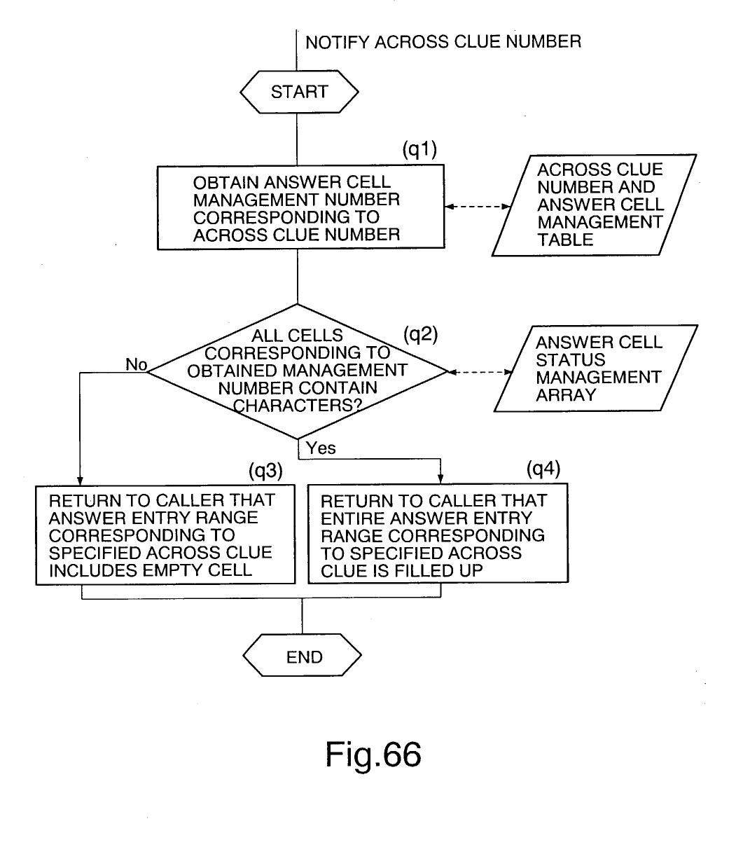

FIG. 66 shows a flowchart of a process performed by the answer cell managing section 610_4F shown in FIG. 61 when receiving an across clue number from the across clue managing section 610_3F.

When receiving an across clue number reported, the answer cell managing section 610_4F refers to an across clue number and answer cell management table similar to the table shown in FIG. 63 to obtain an answer cell management number corresponding to the notified across clue number (step q1), then refers to the answer cell status management array shown in FIG. 62 to determine whether all the answer cells associated with the obtained management number contain characters (step q2). For example, if the reported across clue number is number 4, the answer cell managing section 610_4F determines whether all of the two cells that make up the answer entry range corresponding to across clue number 4 contain characters.

If any of the cells corresponding to the clue number is still empty, the answer cell managing section 610_4F returns to the caller (the across clue managing section 610_3F) notification that the answer entry range associated with the specified across cue includes an empty cell (step q3). On the other hand, if all the cells corresponding to the clue number contain characters, it returns to the caller that the entire answer entry range is filled up (step q4).

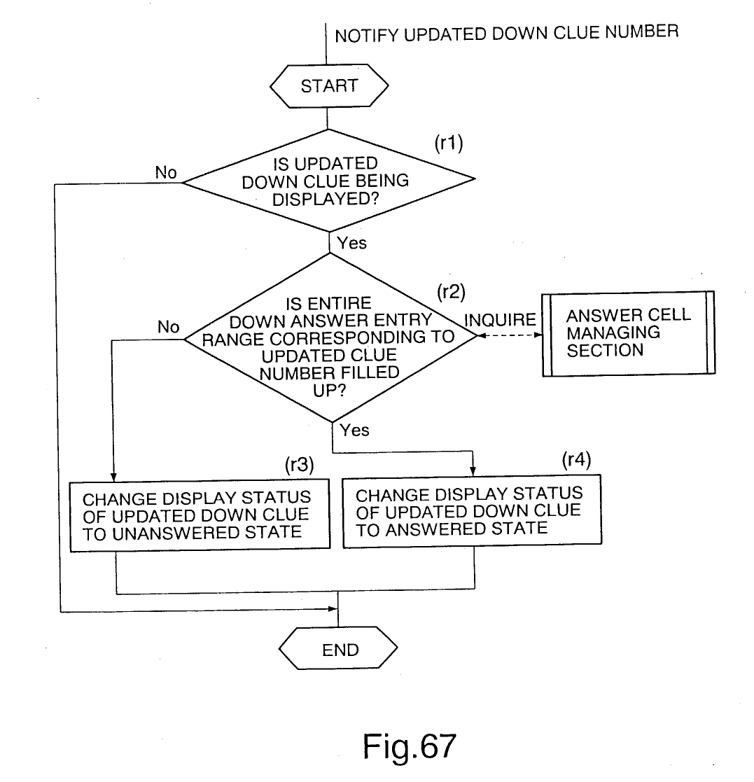

FIG. 67 shows a flowchart of a process performed by the down clue managing section 610_2F shown in FIG. 61.

When receiving an updated down clue number from the answer cell managing section 610_4F shown in FIG. 61 (see step o4 in FIG. 64), the down clue managing section 610_2F determines whether the updated down clue is currently displayed on the display screen (step r1). If it is not displayed, the down clue managing section 610_2F simply exits this routine. On the other hand, if it is displayed, the process proceeds to step r2, where the down clue managing section 610_2F provides the updated clue number to the answer cell managing section 610_4F to make inquiry (see FIG. 65) to determine whether the entire vertical answer entry range corresponding to the updated clue number is filled up. If any of the cells in the answer entry range corresponding to the updated clue number is empty, the down clue managing section 610_2F changes the display status of the updated down clue to the unanswered state (step r3). If all the cells in the answer entry range corresponding to the updated clue number are filled, it changes the display status of the updated down clue to the answered state (with a deletion mark as shown in FIG. 60) (step r4).

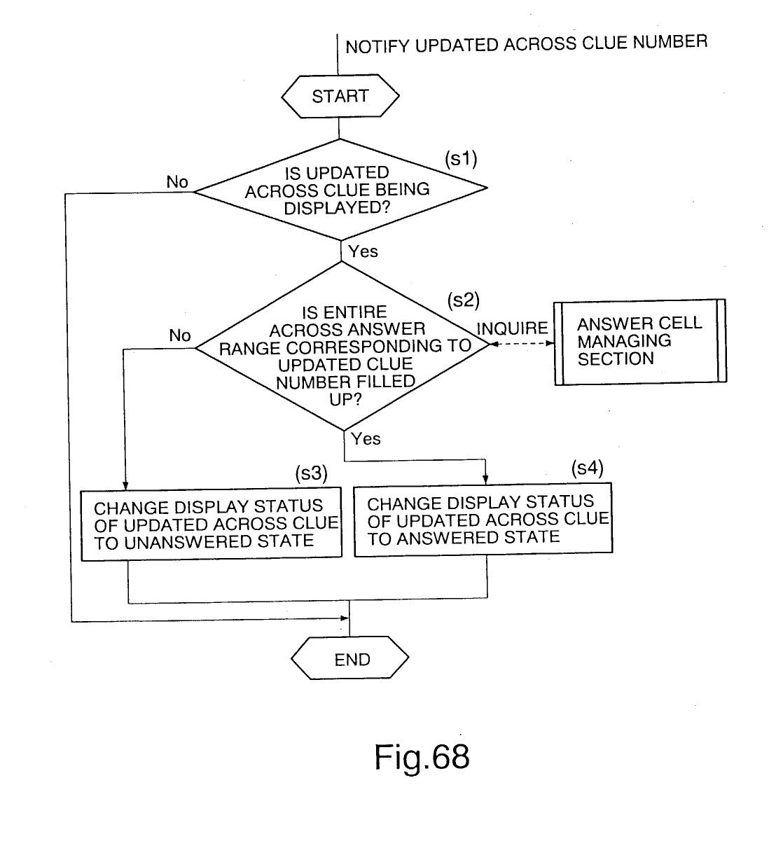

FIG. 68 shows a flowchart of a process performed by the across clue managing section 610_3F shown in FIG. 61.

When receiving an updated across clue number from the answer cell managing section 610_4F shown in FIG. 61 (see step o6 in FIG. 64), the across clue managing section 610_3F determines whether the updated across clue is currently displayed on the display screen (step s1). If it is not displayed, the across clue managing section 610_3F simply exits the routine. On the other hand, if it is displayed, the process proceeds to step s2, where the across clue managing section 610_3F provides the updated clue number to the answer cell managing section 610_4F to make inquiry (see FIG. 66) to determine whether the entire horizontal answer entry range corresponding to the updated clue number is filled up. If any of the cells in the answer entry range corresponding to the updated clue number is empty, the across clue managing section 610_3F changes the display status of the updated across clue to the unanswered state (step s3). On the other hand, if all the cells in the answer entry range corresponding to the update clue number are filled, it changes the display status of the updated across clue to the answered state (step s4).

A specific embodiment of the seventh crossword puzzle playing apparatus will be described below.

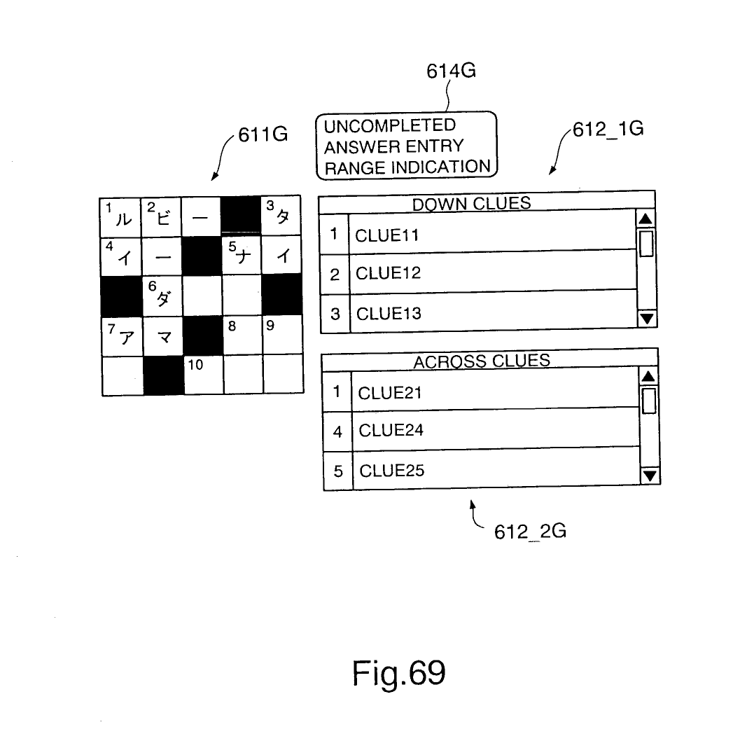

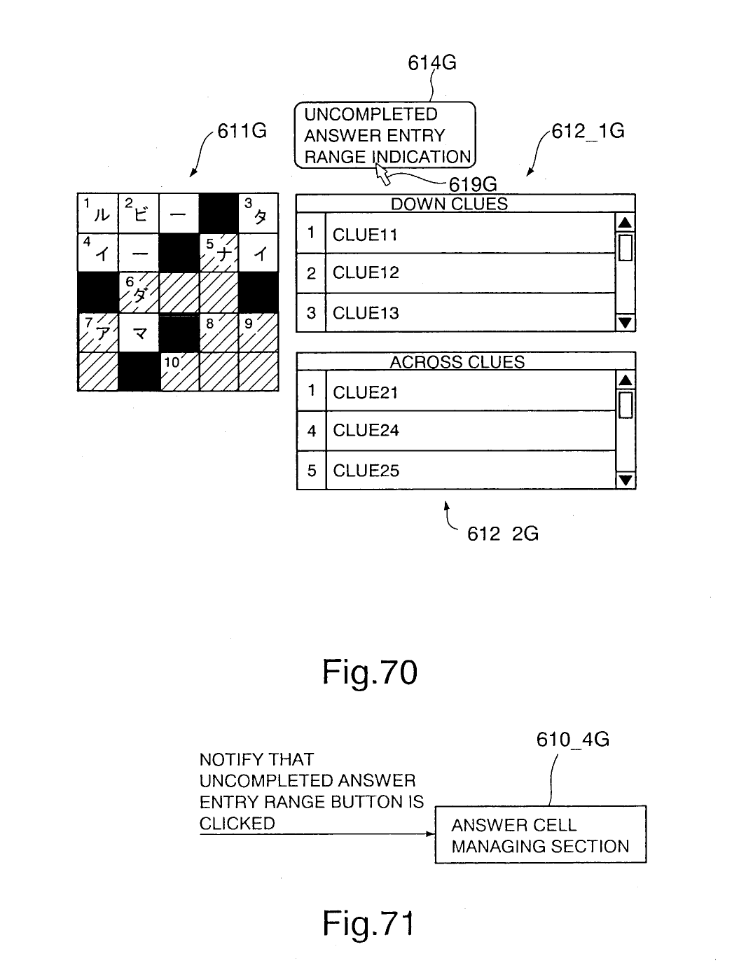

FIGS. 69 and 70 show a display mode in an embodiment of the seventh crossword puzzle playing apparatus. FIG. 69 shows the display mode before an operation performed by a player and FIG. 70 shows the display mode after the player operation.

Shown in FIG. 69 are an answer entry matrix 611G and, a down clue list area 612_1G and an across clue list area 612_2G, which are referred to as clue list areas herein, and an uncompleted answer entry range indication button 614G.

The player operates the mouse 104 shown in FIG. 2 to place the mouse cursor 619G on the uncompleted answer entry range indication button 614G and clicks it.

While the uncompleted answer entry range indication button 614G is being clicked, answer entry ranges corresponding to unanswered clues in the answer entry matrix 611G are highlighted with a different color of cells as indicated by a hatch pattern in FIG. 70.

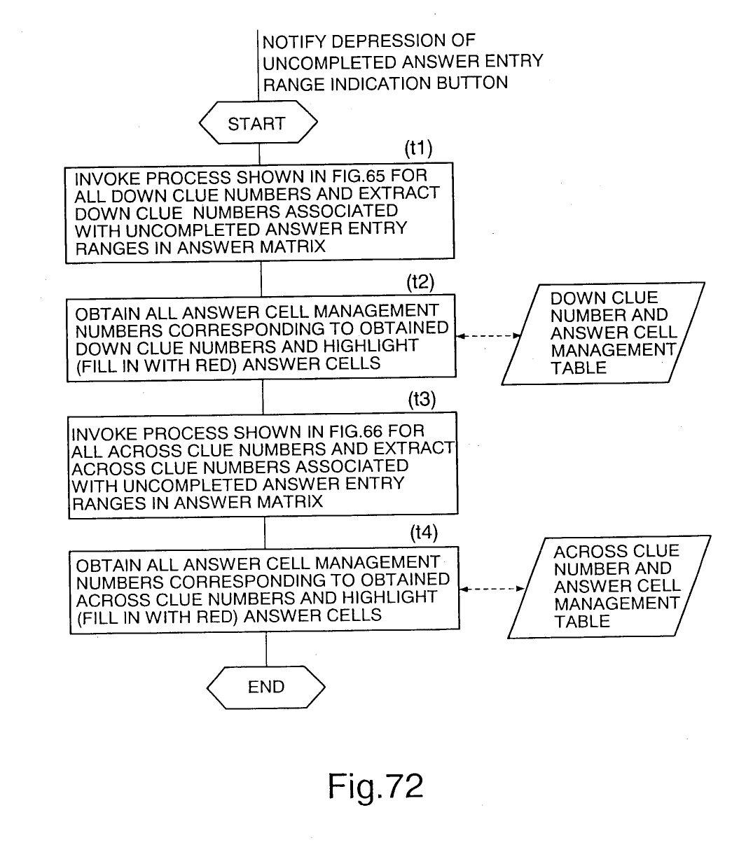

FIG. 71 shows a module configuration of the crossword puzzle playing apparatus of the present embodiment. The module configuration shown corresponds to the internal configuration of the display section 610G of the crossword puzzle playing apparatus 600G shown in FIG. 16.

An answer cell managing section 610_4G is shown in FIG. 71.

FIG. 72 shows a flowchart of a process performed by the answer cell managing section 610_4G shown in FIG. 71.

In the present embodiment, the processes shown in FIGS. 65 and 66 are performed in addition to the process shown in FIG. 72.

In the flowchart shown in FIG. 72, in response to a notification that the uncompleted answer entry range indication button is pushed down, the process shown in FIG. 65 is invoked for all the down clue numbers and down clue numbers associated with answer entry ranges including empty cells are extracted (step t1). All the answer cell management numbers that correspond to down clue numbers obtained by referring to the down clue number and answer cell management table (see FIG. 63) are obtained and the answer cells associated with the answer cell management numbers are highlighted (filled in with red) (step t2). Likewise, the process shown in FIG. 66 is invoked for all the across clue numbers and across clue numbers associated with answer entry ranges including empty cells are extracted (step t3). All the answer cell management numbers that correspond to across clue numbers obtained by referring to the across clue number and answer cell management table are obtained and the answer cells associated with the answer cell management numbers are highlighted (filled in with red) (step t4).

A specific embodiment of the eighth crossword puzzle playing apparatus will be described below.

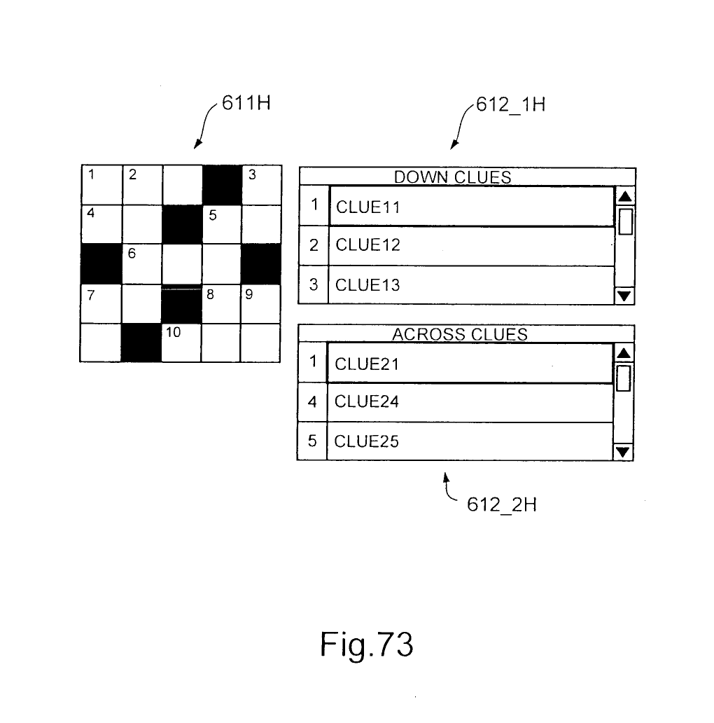

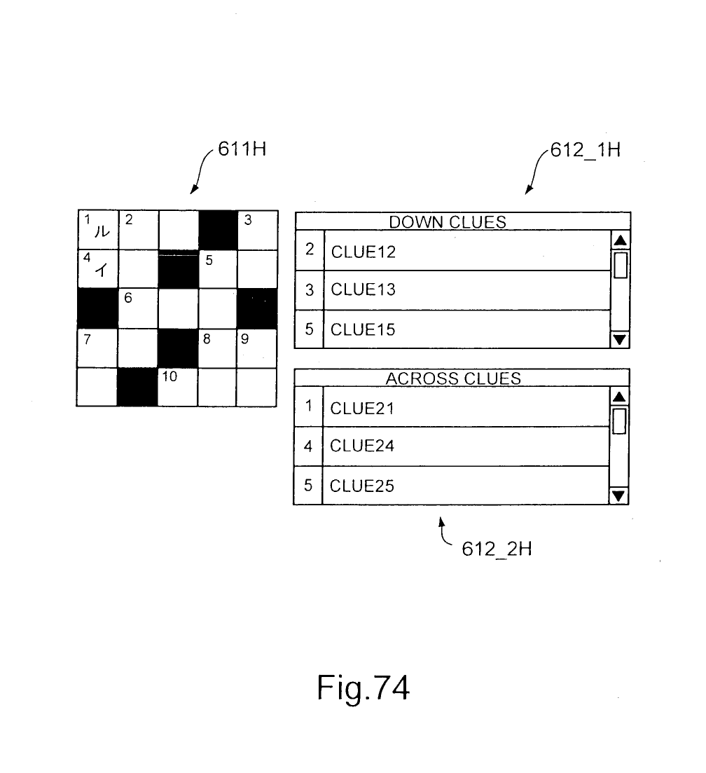

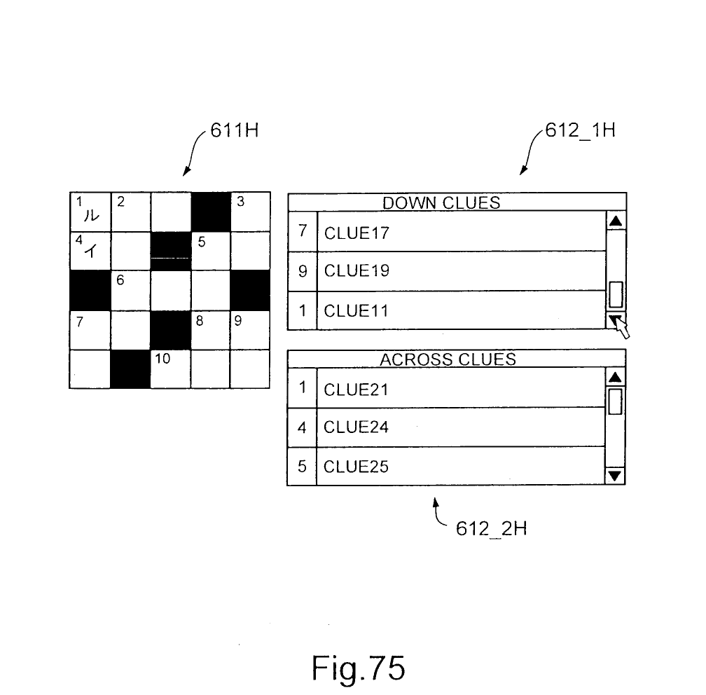

FIGS. 73, 74, and 75 show a display mode in one embodiment of the eighth crossword puzzle playing apparatus. FIG. 73 shows the display mode before an operation, FIG. 74 shows the display mode after an answer to down clue number 1 is entered, and FIG. 75 shows the display mode after it is scrolled.

Shown in FIG. 73 are an answer entry matrix 611H and, a down clue list area 612_1H and an across clue list area 612_2H, which are referred to as clue list areas of the present invention.

An answer is entered in the answer entry range in the answer entry matrix 611H that corresponds to clue 11 with down clue number 1 through a keyboard operation, as shown in FIG. 74. Then, clue 11 with down clue number 1 displayed at the top of the down clue list area 612_1H in FIG. 74 disappears from the display screen and is moved to the bottom of the down clue list. As a result, the second and third clues, “clue 12” and “clue 13”, from the top of the down clue list area 612_1H move up by one position as shown in FIG. 74.

When the down clue list area 612_1H is scrolled up to display the bottom of the down clue list, “clue 11” with clue number 1 appears at the bottom as shown in FIG. 75.

The module configuration shown in FIG. 61 may be applied to a display section 610H in the present embodiment. The process flows shown in FIGS. 64 to 66 may be used as process flows in the answer cell managing section in the module configuration shown in FIG. 61. Therefore, the description of them will be omitted here.

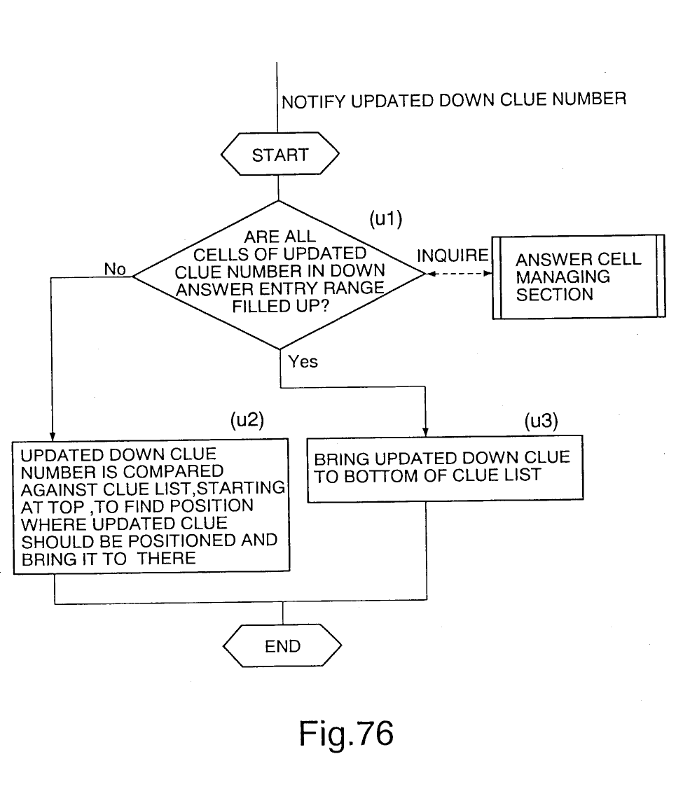

FIG. 76 shows a flowchart of a process performed by a down clue managing section in the module configuration shown in FIG. 61 in the present embodiment.

In response to the notification of an update down clue number, the down clue managing section provides the undated down clue number to the answer cell managing section. It is determined whether the entire vertical answer entry range corresponding to the updated clue number is filled up (step u1). If any of the cells in the answer entry range corresponding to the down clue number is empty, the updated down clue is compared with the clue number of each clue on the down clue list, starting at the top, to find the position at which the updated clue should be placed, and the updated down clue is placed at the found position. Then, the down clue list area 612_1H is scrolled through to display the updated down clue to display at the top of the down clue list area 612_1H (step u2). On the other hand, if all the cells in the down answer entry range corresponding to the updated clue number are filled in, the updated down clue is brought to the bottom of the down clue list (step u3).

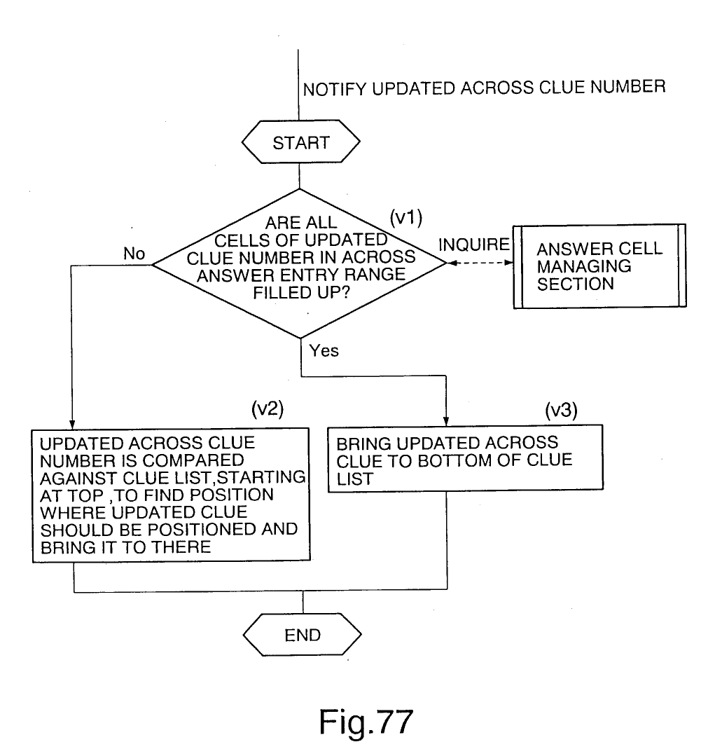

FIG. 77 shows a flowchart of a process performed by an across clue managing section in the module configuration shown in FIG. 61 in the present embodiment.

In response to the notification of an updated across clue number, the across clue managing section provides the updated across clue number to the answer cell managing section. Then, it is determined whether the entire horizontal answer entry range corresponding to the updated clue number is filled up (step v1).

If it is determined that any of the cells in the horizontal answer entry range corresponding to the updated clue number is empty, the updated down clue is compared with the clue number of each clue on the across clue list, starting at the top, to find the position at which the updated across clue should be placed, and the updated down clue is placed at the found position. Then, the across clue list area 612_2H is scrolled through to display the updated across clue to display at the top of the across clue list area 612_2H (step v2). On the other hand, if all the cells in the across answer entry range corresponding to the updated clue number are filled in, the updated across clue is brought to the bottom of the across clue list (step v3).

A specific embodiment of the ninth crossword puzzle playing apparatus shown in FIG. 20 will be described below.

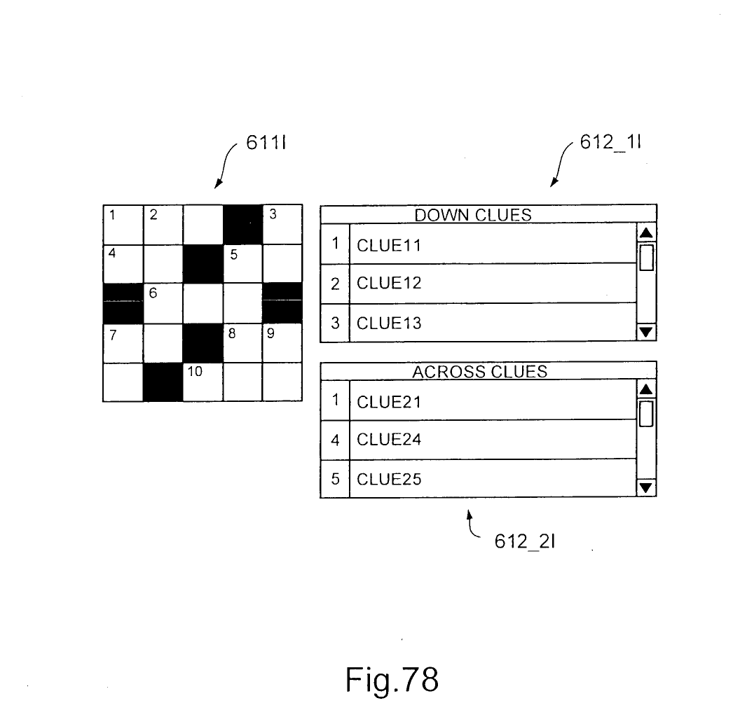

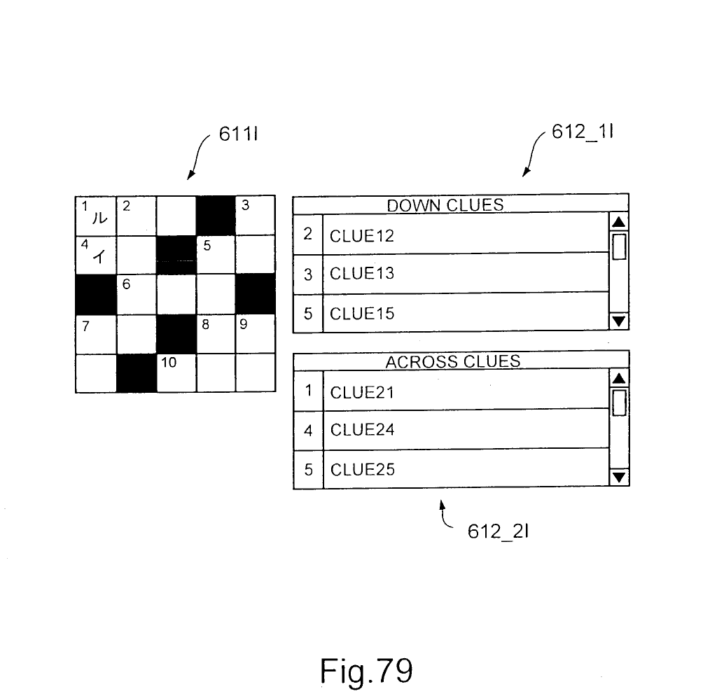

FIGS. 78 and 79 show a display mode of one embodiment of the ninth crossword puzzle playing apparatus. FIG. 78 shows the display mode before an operation and FIG. 79 shows the display mode after an answer to down clue number 1 is entered.

Shown in FIG. 78 are an answer entry matrix 611I and, a down clue list area 612_1I and an across clue list area 612_2I, which make up a clue list area of the present invention.

An answer is entered in the answer entry range in the answer entry matrix 611I that corresponds to clue 11 with down clue number 1 through a keyboard operation, as shown in FIG. 79. Then, the down clue list area 612_1I scrolls up by one position. As a result, “clue 11” with down clue number 1 displayed at the top of the down clue list area 612_1I disappears and the second and third clues, “clue 12” and “clue 13”, from the top of the down clue list area 612_1I shown in FIG. 78 move up by one position as shown in FIG. 79.

The module configuration shown in FIG. 61 may be applied to the present embodiment. The process flows shown in FIGS. 64 to 66 may be used as process flows in the answer cell managing section in the module configuration shown in FIG. 61. Therefore the description of them will be omitted here.

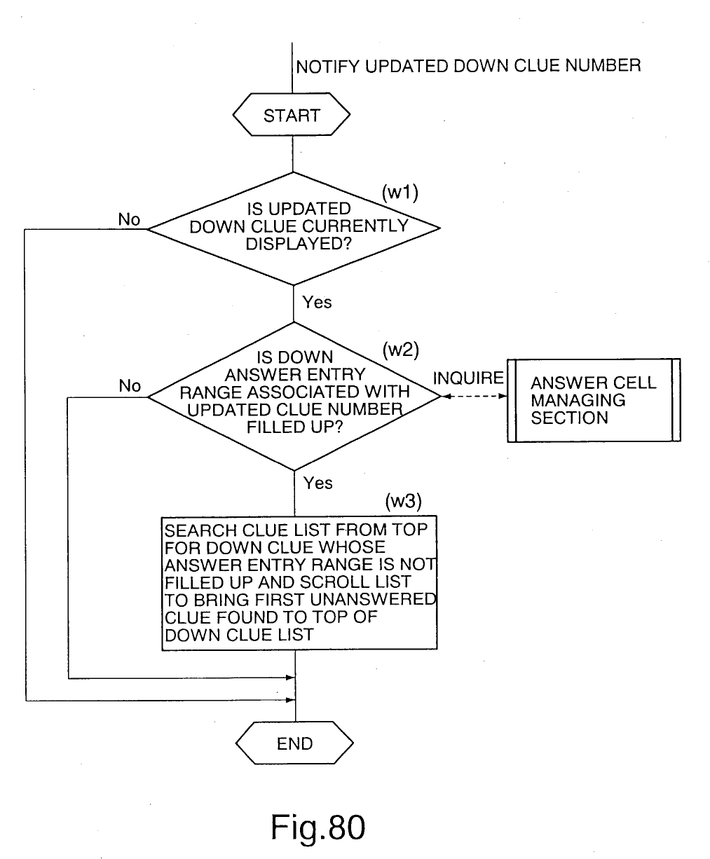

FIG. 80 shows a flowchart of a process performed by the down clue managing section in the module configuration shown in FIG. 61 in the present embodiment.

In response to the notification of an updated down clue number, the down clue managing section determines whether the updated down clue is currently displayed on the display screen (step w1). If it is not displayed, the down clue managing section exits this routine. On the other hand, if it is displayed, the down clue managing section notifies the updated down clue number to the answer entry cell managing section and inquires of it whether the entire vertical answer entry range corresponding to the updated clue number is filled up (step w2). If any of the cells in the vertical answer entry range corresponding to the updated clue number is empty, the down clue managing section simply exits this routine. On the other hand, if all the cells in the vertical answer entry range corresponding to the updated clue number are filled, the down clue managing section searches the down clue list from the top for clues whose corresponding answer entry ranges are not filled up and scrolls the list so that the first unanswered clue found is displayed at the top of the down clue list area (step w3).

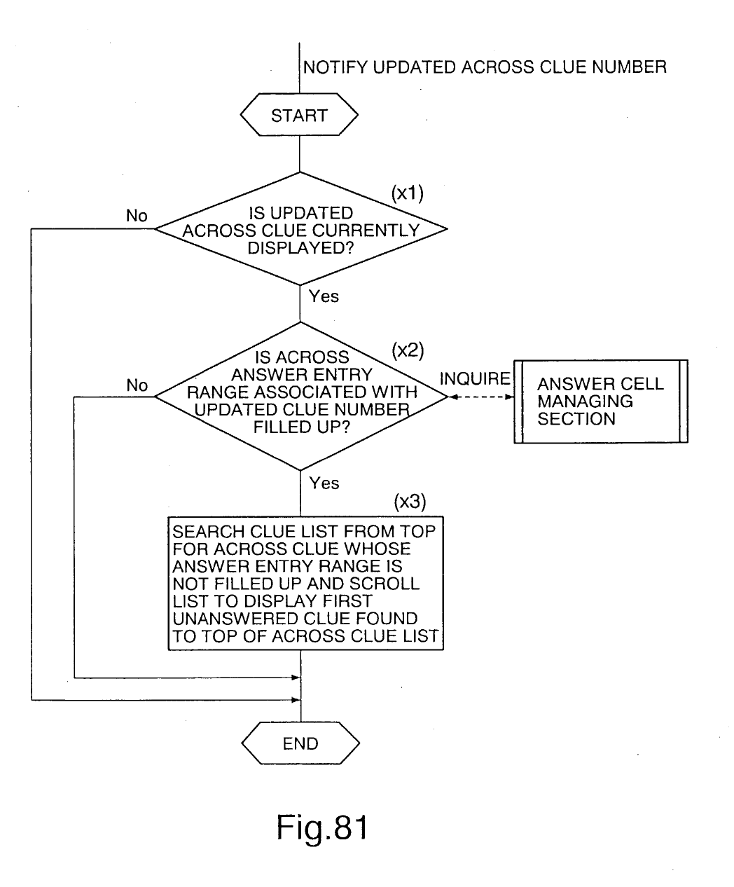

FIG. 81 shows a flowchart of a process performed by an across clue managing section shown in the module configuration shown in FIG. 61 in the present embodiment.

In response to the notification of an updated across clue number, the across clue managing section determines whether the updated across clue is currently displayed on the display screen (step x1). If it is not displayed, the across clue managing section simply exits this routine. On the other hand, if it is displayed, the across clue managing section provides the updated across clue number to the answer cell managing section to inquires of it whether the horizontal answer entry range associated with the updated clue number is filled up (step x2). If any of the cells in the horizontal answer entry range associated with the updated clue number is empty, the across clue managing section exits this routine. On the other hand, if all the cell in the horizontal answer entry range associated with the updated clue number are filled, the across clue managing section scrolls the list so that the first unanswered clue found is displayed at the top of the across clue list area (step x3).

A specific embodiment of the tenth crossword puzzle playing apparatus will be described below.

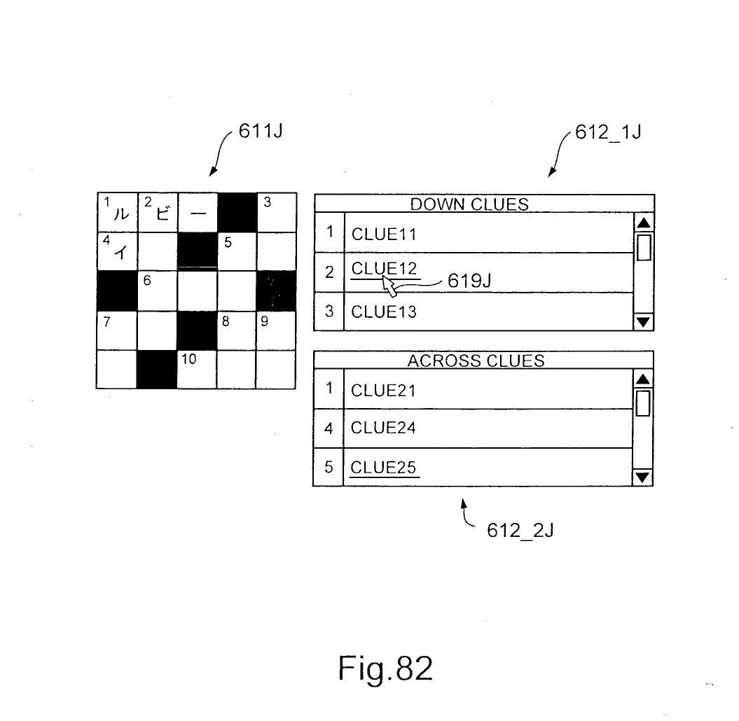

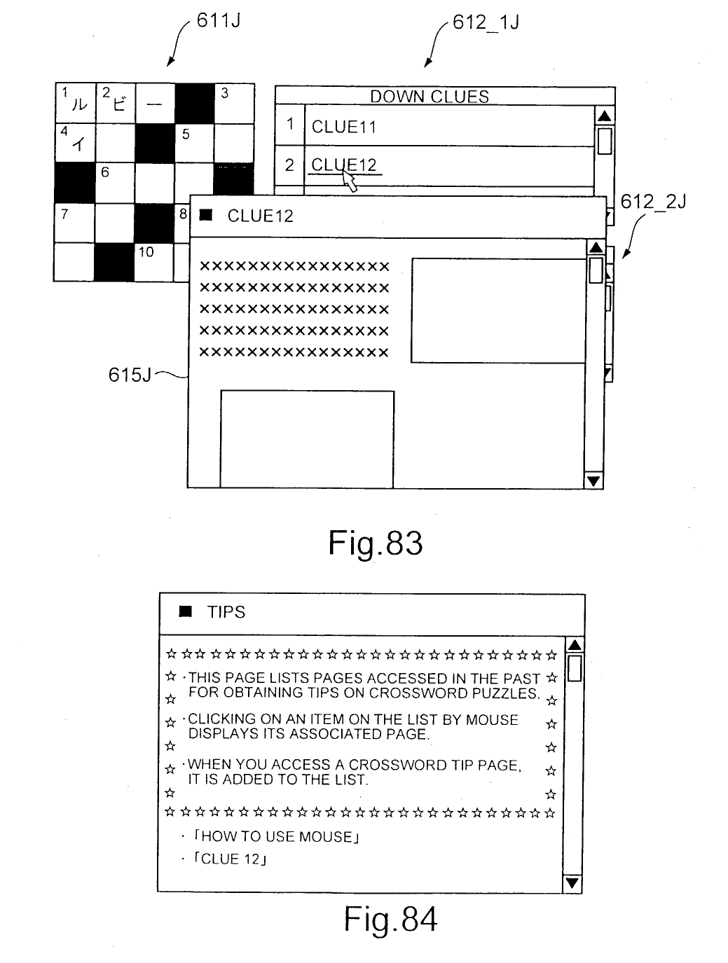

FIGS. 82 and 83 show a display mode of one embodiment of the tenth crossword puzzle playing apparatus.

Shown in FIG. 82 are an answer entry matrix 611J, and a down clue list area 612_1J and an across clue list area 612_2J, which correspond to the clue list area of the present invention. In the specific example shown in FIG. 82, “Clue 12” with clue number 2 in the down clue list area 612_1J and “Clue 25” with clue number 5 in the across clue list area 612_2J are underlined to indicate that links to Web pages are provided. While the entire text of “Clue 12” and “Clue 25” is underlined in this example, a part of or a word in the clue text may be underlined and linked to Web pages.

When the mouse 104 in FIG. 1 is operated to place the mouse cursor 619J on “Clue 12” as shown in FIG. 82 and clicked, link information associated with “Clue 12” is referred to and a Web page to which “Clue 12” is linked is accessed, displaying the Web page 615J on the display screen, as shown in FIG. 83.

FIG. 84 shows an accessed page storing HTML file.

Link information about a Web page accessed as described above is added to the accessed page storing HTML file shown in FIG. 84.

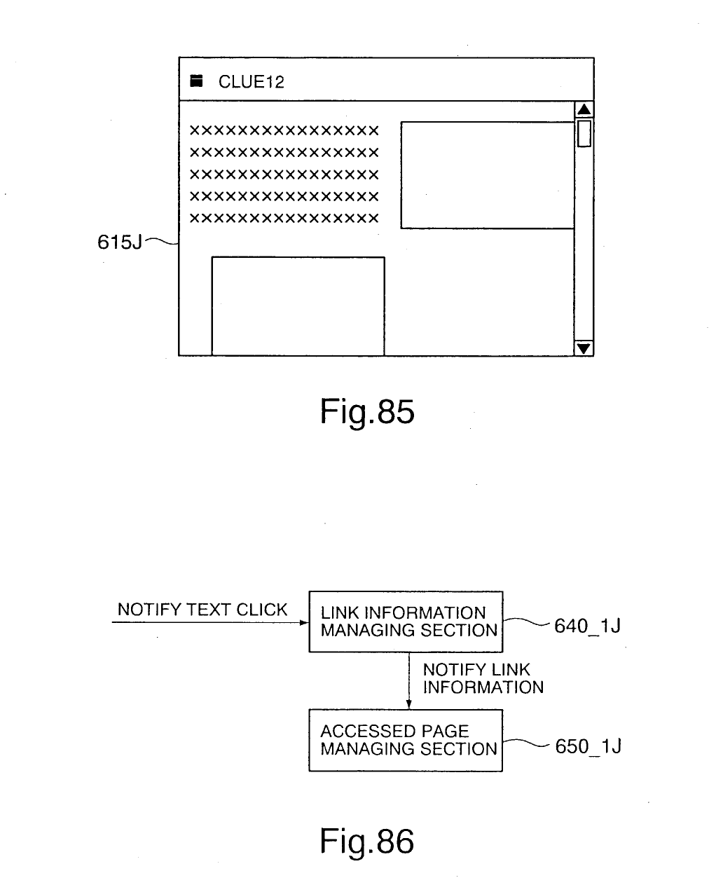

FIG. 85 shows a Web page accessed based on link information stored in the accessed page storing HTML file.

When the accessed page storing HTML file shown in FIG. 84 is opened and “Clue 12” placed at the bottom of the HTML file is clicked by mouse, the Web page 615 J shown in FIG. 85, which was opened while the crossword puzzle shown in FIG. 83 was being played, is displayed.

FIG. 86 shows a module configuration of the present embodiment.

Shown in FIG. 86 are a link page information managing section 640_1J to which a text click is notified and an accessed page managing section 650_1J, which receives link page information from the link page information managing section 640_1J. The link information managing section 640_1J corresponds to the Web accessing section 640J in the block diagram in FIG. 22 and the accessed page managing section 650_1J corresponds to the referenced link information recording section 650J in FIG. 22.

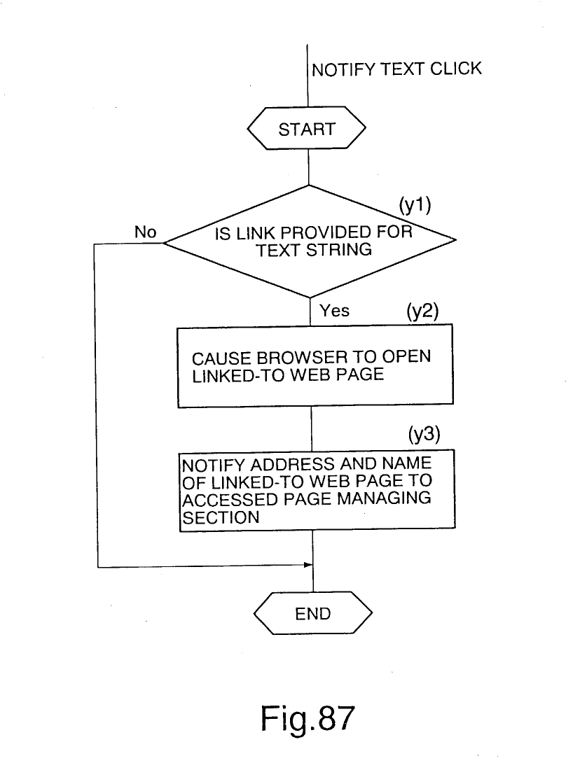

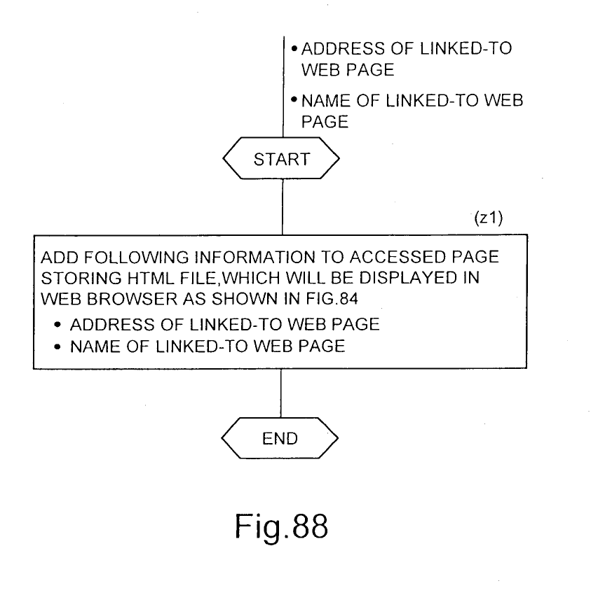

FIG. 87 shows a flowchart of a process performed by the link information managing section shown in FIG. 86.

In response to a text click notified, the link information managing section determines whether a character string including the clicked text is linked to a Web page (step y1). If the character string is not linked to any Web page, the link information managing section simply exits this routine. On the other hand, if the character string is linked to a Web page, the link information managing section causes a browser to display the Web page (step y2) and provides the address and name of the Web page to which a clue is linked to the accessed page managing section (step y3).

FIG. 88 shows a flowchart of a process performed by the accessed page managing section shown in FIG. 86.

When receiving the address and name of a Web page to which a clue is linked, the accessed page managing section adds the address and the name of the Web page to an accessed page storing HTML file (step z1), which will be displayed as shown in FIG. 84 when displayed by browser.

What is claimed is:

1. A crossword puzzle playing apparatus in which answers are to be entered in accordance with an operation performed by a player, comprising:
a display section displaying on a display screen an answer entry matrix in which the answerers are to be entered and a clue list area in which clues to the answers to be entered in said answer entry matrix are displayed;
a point specifying section specifying a point on said display screen according to an operation performed by the player; and
an answer entering section entering the answers in said answer entry matrix in accordance with an operation performed by the player,
wherein said display section, in response to specification of a clue from among the clues in said clue list area by said point specifying sections highlights an answer entry range corresponding to the clue specified by said point specifying section.

2. The crossword puzzle playing apparatus according to claim 1,
wherein said display section displays said answer entry matrix on said display screen in a scrollable manner and, if an answer entry range corresponding to a clue specified by said point specifying section from among the clues in said clue list area is not displayed in said answer entry matrix on said display screen, scrolls said answer entry matrix to display and highlight said answer entry range on said display screen in response to specification of said clue.

3. A crossword puzzle playing apparatus in which answers are to be entered in accordance with an operation by a player, comprising:
a display section displaying on a display screen an answer entry matrix in which the answers are to be entered and a clue list area in which clues to the answers to be entered in said answer matrix are displayed, said clue list area being scrollable; and
an answer entering section entering the answers in said answer entry matrix in accordance with an operation performed by a player,
wherein said display section highlights in said answer entry matrix an answer entry range corresponding to a clue displayed at a predetermined position in said clue list area.

4. The crossword puzzle playing apparatus according to claim 3,
wherein said display section displays on said display screen said clue list area and said answer entry matrix in a scrollable manner and, if an answer entry range corresponding to a clue which is brought to said predetermined position in said clue list area in response to scrolling of said clue list is not displayed on said display screen, scrolls said answer entry matrix to display and highlight said answer entry range.

5. A crossword puzzle playing apparatus in which answers are to be entered in accordance with an operation performed by a player, comprising:
a display section displaying an answer entry matrix in which the answers are to be entered and a clue list area in which clues to the answers to be entered said answer entry matrix are displayed, said answer entry matrix being scrollable;
a clue specifying section specifying a clue from among the clues in said clue list area in accordance with an operation performed by the player; and
an answer entering section entering an answer in said answer entry matrix in accordance with an operation performed by the player,
wherein said display section, in response to specification of a clue in said clue list area by said clue specifying section, scrolls said answer entry matrix to display an answer entry range corresponding to the clue specified by said clue specifying section if said answer entry range is not displayed in said answer entry matrix on said display screen.

6. A crossword puzzle playing apparatus in which answers are to be entered in accordance with an operation performed by a player, comprising:
a display section displaying an answer entry matrix in which the answers are to be entered and a clue list area in which clues to the answers to be entered in said answer entry matrix are displayed;
a point specifying section specifying a point on said display screen in accordance to an operation performed by the player; and
an answer entering section entering an answer in said answer entry matrix in accordance with an operation performed by the player,
wherein said display section, in response to specification of an answer entry range in said answer entry matrix by said point specifying section, highlights a clue among the clues displayed in said clue list area that corresponds to the answer entry range specified by said point specifying section.

7. The crossword puzzle playing apparatus according to claim 6,
wherein said display section displays said clue list area on said display screen in a scrollable manner and, if a clue corresponding to an answer entry range specified by said point specifying section from among the answer entry ranges in said answer entry matrix is not displayed in said clue list area on said display screen, scrolls said clue list area to display and highlight said clue on said display screen in response to specification of said answer entry range.

8. A crossword puzzle playing apparatus in which answers are to be entered in accordance with an operation performed by a player, comprising:
a display section displaying an answer entry matrix in which the answers are to be entered, a clue list area in which clues to the answers to be entered in said answer entry matrix are displayed, and a keyword display field in which a keyword is displayed, said keyword being formed by arranging in a certain order the same characters as those that are entered in some certain entry cells of the cells making up said answer entry matrix; and
an answer entering section entering an answer in said answer entry matrix in accordance with an operation performed by the player,
wherein said display section, in response to entry of a character in any of said certain entry cells in said answer entry matrix, displays the same character as said character at a place in said keyword display field, said place corresponding to the entry cell in which said character is entered.

9. The crossword puzzle playing apparatus according to claim 8,
wherein said display section displays said answer entry matrix and said clue list area prior to displaying said keyword display field and displays said keyword display field the first time a character is entered in any of said certain entry cells in said answer entry matrix.

10. A crossword puzzle playing apparatus in which answers are to be entered in accordance with an operation performed by a player, comprising:
a display section displaying an answer entry matrix in which the answers are to be entered and a clue list area in which clues to the answers to be entered in said answer entry matrix are displayed; and
an answer entering section entering an answer in said answer entry matrix in accordance with an operation performed by the player,
wherein said display section, in response to entry of an answer in an answer entry range in said answer entry matrix, displays a notification that a clue in said clue list area that corresponds to the answer entry range in which the answer is entered is answered.

11. A crossword puzzle playing apparatus in which answers are to be entered in accordance with an operation performed by a player, comprising:
a display section displaying on an display screen an answer entry matrix in which the answers are entered, a clue list area in which clues to the answers to be entered in said answer entry matrix are displayed, and a predetermined uncompleted answer entry range indication button;
a button specifying section specifying said uncompleted answer entry range indication button in accordance with an operation performed by the player; and
an answer entering section entering an answer in said answer entry matrix in accordance with an operation performed by the player,
wherein said display section, in response to specification of said uncompleted answer entry range indication button by said button specifying section, highlights an unanswered entry range in said answer entry matrix.

12. A crossword puzzle playing apparatus in which answers are to be entered in accordance with an operation performed by a player, comprising:
a display section displaying on a display screen an answer entry matrix in which the answers are to be entered and a clue list area in which clues to the answers to be entered in said answer entry matrix are displayed, the order in which said clues are listed in said clue list area being changeable; and
an answer entering section entering an answer in said answer entry matrix in accordance with an operation performed by the player,
wherein said display section, in response to entry of an answer in any answer entry range in said answer entry matrix, changes a display mode of said clue list area to a mode in which a clue corresponding to the answer entry range in which the answer is entered is moved to a predetermined position.

13. A crossword puzzle playing apparatus in which answers are entered in accordance with an operation performed by a player, comprising:
a display section displaying on a display screen an answer entry matrix in which the answers are to be entered and a clue list area in which clues to the answers to be entered in said answer entry matrix are displayed, said clue list area being scrollable; and
an answer entering section entering an answer in said answer entry matrix in accordance with an operation performed by the player,
wherein said display section, in response to entry of an answer in any answer entry range in said answer entry matrix, scrolls said clue list area to display at a predetermined position a clue corresponding to an unentered answer if a clue corresponding to the answer entry range in which the answer is entered is displayed at said predetermined position.

14. A crossword puzzle playing apparatus connected to a network in which answers are entered in accordance with an operation performed by a player, comprising:
a display section displaying on a display screen an answer entry matrix in which the answers are to be entered and a clue list area in which clues to the answers to be entered in said answer entry matrix are displayed, said clues including a clue being linked to Web pages;
a point specifying section specifying a point on said display screen in accordance with an operation performed by the player;
an answer entering section entering an answer in said answer entry matrix in accordance with an operation performed by the player; and
a Web accessing section responsive to specification by said point specifying section of a clue in said clue list area that is linked to a Web page for accessing the Web page to which said clue is linked,
wherein said display section displays on said display screen the Web page accessed by said Web accessing section in addition to said answer entry matrix and said clue list area; and
said crossword puzzle playing apparatus further comprises a reference link information recording section associating and recording information about the link to the Web page accessed by said Web accessing section with the clue linked to the Web page and/or an answer corresponding to said clue.

15. The crossword puzzle playing apparatus according to claim 14,
wherein said reference link information recording section associates and records said information about the link with said clue and/or said answer in a certain Web page.

16. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answerers are to be entered and a clue list area in which clues to the answers to be entered in said answer entry matrix are displayed; and
an answer entering section entering the answers in said answer entry matrix in accordance with an operation performed by the player,
wherein said display section, in response to specification of a clue from among the clues in said clue list area, highlights an answer entry range corresponding to the specified clue.

17. The crossword puzzle playing program storage medium according to claim 16,
wherein said display section displays said answer entry matrix on said display screen in a scrollable manner and, if an answer entry range corresponding to a clue specified from among the clues in said clue list area is not displayed in said answer entry matrix on said display screen, scrolls said answer entry matrix to display and highlight said answer entry range on said display screen in response to specification of said clue.

18. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are to be entered and a clue list area in which clues to the answers to be entered in said answer matrix are displayed, said clue list area being scrollable; and
an answer entering section entering the answers in said answer entry matrix in accordance with an operation performed by a player;
wherein said display section highlights in said answer entry matrix an answer entry range corresponding to a clue displayed at a predetermined position in said clue list area.

19. The crossword puzzle playing program storage medium according to claim 18,
wherein said display section displays on said display screen said clue list area and said answer entry matrix in a scrollable manner and, if an answer entry range corresponding to a clue which is brought to said predetermined position in said clue list area in response to scrolling of said clue list area is not displayed on said display screen, scrolls said answer entry matrix to display and highlight said answer entry range.

20. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are to be entered and a clue list area in which clues to the answers to be entered in said answer matrix are displayed, said clue list area being scrollable; and
a clue specifying section specifying a clue from among the clues in said clue list area in accordance with an operation performed by the player; and
an answer entering section entering an answer in said answer entry matrix in accordance with an operation performed by the player,
wherein said display section, in response to specification of a clue in said clue list area by said clue specifying section, scrolls said answer entry matrix to display an answer entry range corresponding to the clue specified by said clue specifying section if said answer entry range is not displayed in said answer entry matrix on said display screen.

21. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying an answer entry matrix in which the answers are to be entered and a clue list area in which clues to the answers to be entered in said answer entry matrix are displayed; and
an answer entering section entering an answer in said answer entry matrix in accordance with an operation performed by the player,
wherein said display section, in response to specification of any answer entry range in said answer entry matrix, highlights a clue among the clues displayed in said clue list area that corresponds to the specified answer entry range.

22. The crossword puzzle playing program storage medium storing a crossword puzzle playing program according to claim 21, wherein said display section displays said clue list area on said display screen in a scrollable manner and, if a clue corresponding to an answer entry range specified from among the answer entry ranges in said answer entry matrix is not displayed in said clue list area on said display screen, scrolls said clue list area to display and highlight said clue on said display screen in response to specification of said answer entry range.

23. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying an answer entry matrix in which the answers are to be entered, a clue list area in which clues to the answers to be entered in said answer entry matrix are displayed, and a keyword display field in which a keyword is displayed, said keyword being formed by arranging in a certain order the same characters as those that are entered in some certain entry cells of the cells making up said answer entry matrix; and
an answer entering section entering an answer in said answer entry matrix in accordance with an operation performed by the player,
wherein said display section, in response to entry of a character in any of said certain entry cells in said answer entry matrix, displays the same character at a place in said keyword display field, said place corresponding to the entry cell in which said character is entered.

24. The crossword puzzle playing program storage medium storing a crossword puzzle playing program according to claim 23, wherein said display section displays said answer entry matrix and said clue list area prior to displaying said keyword display field and displays said keyword display field the first time a character is entered in any of said certain entry cells in said answer entry matrix.

25. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying an answer entry matrix in which the answers are to be entered and a clue list area in which clues to the answers to be entered in said answer entry matrix are displayed; and
an answer entering section entering an answer in said answer entry matrix in accordance with an operation performed by the player,
wherein said display section, in response to entry of an answer in any answer entry range in said answer entry matrix, displays an indication that a clue in said clue list area that corresponds to the answer entry range in which the answer is entered is answered.

26. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are entered, a clue list area in which clues to the answers to be entered in said answer entry matrix are displayed, and a predetermined uncompleted answer entry range indication button;
a button specifying section specifying said uncompleted answer entry range indication button in accordance with an operation performed by the player; and
an answer entering section entering an answer in accordance with an operation performed by the player,
wherein said display section, in response to specification of said uncompleted answer entry range indication button by said button specifying section, highlights an unanswered entry range in said answer entry matrix.

27. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are to be entered and a clue list area in which clues to the answers to be entered in said answer entry matrix are displayed, the order in which said clues are listed in said clue list area being changeable; and
an answer entering section entering an answer in said answer entry matrix in accordance with an operation performed by the player,
wherein said display section, in response to entry of an answer in an answer entry range in said answer entry matrix, changes a display mode of said clue list area to a mode in which a clue corresponding to the answer entry range in which the answer is entered is moved to a predetermined position.

28. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are to be entered and a clue list area in which clues to the answers to be entered in said answer entry matrix are displayed, said clue list area being scrollable; and
an answer entering section entering an answer in said answer entry matrix in accordance with an operation performed by the player,
wherein said display section, in response to entry of an answer in any answer entry range in said answer entry matrix, scrolls said clue list area to display at a predetermined position a clue corresponding to an unentered answer if a clue corresponding to the answer entry range in which the answer is entered is displayed at said predetermined position.

29. A crossword puzzle playing program storage medium storing a crossword puzzle playing program executed in a computer to cause the computer to operate as a crossword puzzle playing apparatus in which answers are entered in accordance with an operation performed by the player, said program causing said computer to operate as the crossword puzzle playing apparatus comprising:
a display section displaying on a display screen an answer entry matrix in which the answers are to be entered and a clue list area in which clues to the answers to be entered in said answer entry matrix are displayed, said clues being linked to Web pages;
an answer entering section entering an answer in said answer entry matrix in accordance with an operation performed by the player; and
a Web accessing section responsive to specification of a clue in said clue list area that is linked to a Web page for accessing the Web page to which said clue is linked,
wherein said display section displays on said display screen the Web page accessed by said Web accessing section in addition to said answer entry matrix and said clue list area; and
said crossword puzzle playing apparatus further comprises a reference link information recording section associating and recording information about the link to the Web page accessed by said Web accessing section with the clue linked to the Web page and/or an answer corresponding to said clue.

30. The crossword puzzle playing programs storage medium storing a crossword puzzle playing program according to claim 29,
wherein said reference link information recording section associates and records said information about the link with said clue and/or said answer in a certain Web page.
